(19) United States
(12) Patent Application Publication
(10) Pub. No.: US 2015/0112702 A1
(43) Pub. Date: Apr. 23, 2015

(54) APPARATUS AND METHOD FOR PROCESSING AND/OR FOR PROVIDING HEALTHCARE INFORMATION AND/OR HEALTHCARE-RELATED INFORMATION WITH OR USING AN ELECTRONIC HEALTHCARE RECORD AND GENETIC INFORMATION AND/OR GENETIC-RELATED INFORMATION

(71) Applicants: RAYMOND ANTHONY JOAO, YONKERS, NY (US); MARY ANTONETTE SPANO a/k/a CALVI, YONKERS, NY (US); GREGORY THOMAS JOAO, YONKERS, NY (US)

(72) Inventors: RAYMOND ANTHONY JOAO, YONKERS, NY (US); MARY ANTONETTE SPANO a/k/a CALVI, YONKERS, NY (US); GREGORY THOMAS JOAO, YONKERS, NY (US)

(21) Appl. No.: 14/510,473

(22) Filed: Oct. 9, 2014

Related U.S. Application Data
(60) Provisional application No. 61/892,298, filed on Oct. 17, 2013.

(51) Int. Cl. G06F 19/00

(52) U.S. Cl. CPC G06F 19/3431; G06F 19/3487; G06F 19/3418; G06F 19/322
USPC 705/2

(57) ABSTRACT

A computer-implemented method, including processing genetic information or genetic-related information regarding an individual, determining or ascertaining information regarding the genetic information or genetic-related information regarding an individual, generating a genetic profile report containing information regarding the information regarding the genetic information or genetic-related information of the individual, generating a diagnostic report containing information regarding a diagnosis or a possible diagnosis using the information contained in the genetic profile report or data file, generating a treatment report using information contained in the diagnostic report, generating a treatment plan for the individual, wherein the treatment plan contains information regarding a treatment for or corresponding to the diagnosis or the possible diagnosis, and transmitting the genetic profile report, the diagnostic report, the treatment report, or the treatment plan, to a communication device of or associated with a healthcare provider of the individual.

### RELATED APPLICATIONS

This application claims the benefit of the priority of U.S. Provisional Patent Application Ser. No. 61/892,298, filed Oct. 17, 2013, and entitled “APPARATUS AND METHOD FOR PROCESSING AND/OR FOR PROVIDING HEALTHCARE INFORMATION AND/OR HEALTHCARE-RELATED INFORMATION WITH OR USING AN ELECTRONIC HEALTHCARE RECORD AND GENETIC INFORMATION AND/OR GENETIC-RELATED INFORMATION”, the subject matter and teachings of which are hereby incorporated by reference herein in their entirety.

### FIELD OF THE INVENTION

The present invention pertains to an apparatus and a method for processing and/or for providing healthcare information and/or healthcare-related information with or using an electronic healthcare record and genetic information and/or genetic-related information and, in particular, to an apparatus and a method for processing and/or for providing healthcare information and/or healthcare-related information with or utilizing an electronic healthcare record and genetic information and/or genetic-related information and/or data and/or information contained therein for and/or in a number and/or a wide variety of applications.

### BACKGROUND OF THE INVENTION

Healthcare is an area of major concern in the United States. Each year, tens of millions of individuals seek or need the assistance of healthcare professionals. In order to perform proper diagnoses and to prescribe appropriate treatments, healthcare professionals or providers typically rely on information which is obtained from patients, relatives of patients, previous providers, and/or healthcare facilities and/or hospital staff members. The need to have accurate and/or up-to-date data and/or information, in providing healthcare services and/or healthcare-related services, cannot be emphasized enough.

Stories constantly emerge about patients receiving the wrong treatments, having the wrong surgical procedures performed on themselves, receiving a drug or drugs which fatally and/or otherwise adversely interact with another drug or drugs, etc., with stories going on and on. A 1999 study estimated that between 44,000 and 98,000 individuals die annually in hospitals, in the United States alone, as the result of errors or mistakes made by doctors, healthcare providers, and/or healthcare facility workers. Various other reports also estimate 225,000 deaths annually from medical errors and 180,000 deaths annually from medication errors and adverse reactions. There is no doubt that many of these deaths result from inaccurate and/or erroneous information and/or the lack of the availability of correct and/or up-to-date information.

Another problem lies with the fact that the main source of patient information, medical histories, family histories, etc., upon which doctors or providers may base their diagnoses and/or treatments, are patients who usually supply this information on questionnaires or forms just prior to seeing the healthcare provider and/or during a preliminary interview with the provider. In this regard, information obtained from these questionnaires or forms, as well as from these preliminary interviews with the providers, may not necessarily result in sufficient, comprehensive, and/or accurate, information being obtained regarding the patient. Further, there is no guarantee that the same information will be provided, in a uniform manner, to a next or different provider. As a result, patient information may not be uniformly distributed and/or be available to providers at the point of treatment and/or otherwise.

Another problem which exists in the current healthcare system is that doctors or other providers do not always have the latest information and/or research material available to them prior to, and/or during, the diagnosis and/or treatment process.

It is also no secret that healthcare costs are rising at ever-increasing rates and that insurance companies and other healthcare payers expend great resources in processing and reconciling treatment claims and/or claims for healthcare services and/or benefits. Typically, these insurance and/or benefits claims take place in a paper-based environment and, as a result, are slow and inefficient. Fraudulent claims and/or claims which cannot be verified pose another major problem for healthcare payers and insurance companies. These problems only serve to add to the growing costs of healthcare, delayed treatments, and a general dissatisfaction with the current healthcare system.

The tab for healthcare in the U.S. is also expected to hit $4.6 trillion dollars in 2020 which will account for approximately $1 out of every $5, or 20%, of spending in the U.S. economy.

Although genetic information and/or genetic-related information regarding an individual or a patient can be obtained, analyzed, and/or used, in a variety of ways in order to provide valuable information regarding the individual or patient, and which can be used in diagnosing an individual or patient, in treating or in administering treatments to an individual or patient, and/or in performing treatment planning, treatment evaluation, and/or wellness planning, and/or in evaluating and/or monitoring diagnoses, treatments, and/or treatment planning, for an individual or patient, such information is not typically readily available to a doctor or a provider in performing diagnoses, in administering treatments, in performing treatment planning or wellness planning, and/or in evaluating, diagnoses, treatment, treatment planning and/or wellness planning. It is submitted that, while genetic information and/or genetic-related information could be most valuable in providing a wide range of healthcare, healthcare-related, or wellness or wellness-related, information, such information has been under utilized.

The list of problems with the current healthcare system can go on and on. In view of the above, there is a need for an apparatus and a method for providing healthcare information and/or healthcare-related information to the various providers, payers, patients, third party individuals, and/or insurance brokers, agents and/or other intermediaries, which utilizes genetic information and/or genetic-related information which overcomes the shortcomings of the prior art.

### SUMMARY OF THE INVENTION

The present invention provides an apparatus and methods for providing healthcare information and/or healthcare-related information with or using an electronic healthcare record and genetic information and/or genetic-related information which overcomes the shortcomings of the prior art. The present invention is directed to an apparatus and methods for processing and/or for providing healthcare information and/or healthcare-related information with or using an electronic healthcare record and genetic information and/or genetic-related information and, in particular, to an apparatus and a method for processing and/or for providing healthcare information and/or healthcare-related information with or utilizing an electronic healthcare record and genetic information and/or genetic-related information, and/or data and/or information contained therein, for and/or in a number and/or a wide variety of applications.

The present invention provides an apparatus and a method for processing diagnostic information, treatment information, or treatment planning information, and/or any other related data and/or information with or using an electronic healthcare record and genetic information and/or genetic-related information. The present invention can also be utilized in order to process diagnostic information, treatment information, or treatment planning information, and/or any other related data and/or information, with or using genetic information and/or genetic-related information in order to perform a diagnosis of, and/or to prescribe a treatment for, or to design or develop, a treatment plan for, a sickness, an illness, and/or a condition.

The present invention also provides an apparatus and a method which can be utilized to process genetic information or genetic-related information, which can be obtained from an individual or patient at anytime during the lifetime of the individual or patient, whether it be at or shortly after birth, at any age or point during or in the individual's or the patient's lifetime, or prior to the birth of the individual or the patient, which can be obtained from his or her fetus, either while in utero or at any time prior thereto, such as, but not limited to, prior to implantation of his or her embryo, and can generate or provide an initial genetic diagnostic report or plan or a baseline genetic diagnostic report or plan and/or an initial genetic treatment report or plan or a baseline genetic treatment report or plan for the individual or patient. The initial genetic diagnostic report or plan or the baseline genetic diagnostic report or plan and/or the initial genetic treatment report or plan or the baseline genetic treatment report or plan can be utilized for, among other things, managing and/or monitoring the individual's or the patients healthcare, scheduling examinations, tests, procedures, or surgeries, devising treatment plans, performing treatment administration and/or treatment evaluation, in structuring fitness, exercise, and/or wellness, routines, or can be used for comparison against diagnostic reports, treatment reports, or treatment plans, and/or genetic information or genetic-related information, obtained at a later point in time.

The present invention also provides an apparatus and a method for allowing a genetic testing provider, laboratory, or service, to transmit genetic information test results or generic-related information test results to a computer or a computer system for inclusion in an electronic healthcare record of an individual or patient. The present invention can also be utilized to provide an apparatus and a method for providing estimated cost of treatment information and/or treatment cost optimization information for or regarding, or pertaining to, a diagnosis, a treatment, or a treatment plan. The present invention also provides an apparatus and a method which can be utilized to provide information regarding diagnostic evaluation, a treatment evaluation, or a treatment plan evaluation, for a respective diagnosis, treatment, or treatment plan, for an individual or a patient.

The present invention also provides an apparatus and a method which can be utilized to schedule appointments with providers and/or to provide information contained in or at, or regarding, electronic healthcare records, insurance exchanges, social networks, and media sources.

The present invention also provide a central database for storing genetic information and/or genetic-related information for or regarding any number of individuals or patients which can be utilized for a wide variety of purposes including, but not limited to, locating or identifying individuals of any age, locating lost or abducted children, ascertaining family histories of individuals, ascertaining the family histories of adopted children, or for any other purpose.

The apparatus of the present invention includes a central processing computer or a central processing computer system which can be a network or server computer or which can consist of any number of network or server computers. The apparatus also includes a healthcare provider communication device or computer which is associated with a healthcare provider such as a healthcare professional, a hospital, a clinic, or laboratory, a genetic testing laboratory, and/or any other provider of healthcare or other goods, products, or services.

The healthcare provider communication device or computer can be associated with, or can be used by, any genetic testing or analysis laboratory, service, or provider, or any entity which performs testing or analysis of any genetic material, such as, but not limited to, deoxyribonucleic acid (“DNA”), ribonucleic acid (“RNA”), chromosomes, genes, or plasmids, or any other material containing genetic information or genetic matter or material. The healthcare provider communication device(s) or computer(s) can communicate with, and can operate in conjunction with, the central processing computer and/or any of the other computers and/or computer systems or communication devices described herein.

The apparatus can also include a healthcare payer communication device or computer which is associated with a healthcare payer such as a healthcare insurer, healthcare insurance company, health maintenance organization, clinic, and/or any other payer of healthcare services and products described herein. The healthcare payer computer(s) can communicate with, and operate in conjunction with, the central processing computer and/or any of the other computers and/or computer systems or communication devices described herein.

The apparatus can also include a user or patient communication device or computer which is associated with an individual or patient, or a caregiver of the individual or patient, who seeks or who can be provided with healthcare and/or related services, products and/or related information. The user or patient communication device(s) can communicate with, and operate in conjunction with, the central processing computer and/or any of the other computers and/or computer systems described herein.

The apparatus can also include an intermediary communication device or computer which is associated with an intermediary, a broker, an agent, and/or any other individual and/or entity, or any third party, that can utilize the present invention in order to act for and/or on behalf of any other individual, patient, party, or entity, described herein. The intermediary computer(s) can communicate with, and operate in conjunction with, the central processing computer and any of the other computers and/or computer systems described herein.

The apparatus can also include a healthcare records computer which can be or can include a computer or computer system, or any number of computers or computer systems, or a cloud computer system or cloud system. The healthcare records computer can serve to store and house an electronic healthcare record or file or any number of electronic healthcare records or files. The healthcare records computer can be associated with any provider, insurer, payer, intermediary, insurance exchange, or any user, individual, patient, organization, or entity, who or which utilizes the present invention. Each healthcare records computer can be utilized to store an electronic healthcare record or file or any number of electronic healthcare records or files which can be accessed by the central processing computer, by any provider communication device, by any insurer or payer communication device, by any user or patient communication device, by any intermediary communication device, or by any other computer, communication device, or other device, described herein as being utilized in connection with the present invention. The healthcare records computer can also be utilized to facilitate cloud storage of any electronic healthcare record(s) or file(s).

The apparatus can also include an insurance exchange computer, or any number of insurance exchange computers which can be utilized to process and store information regarding the selling of healthcare insurance, disability insurance, and life insurance, policies, products, and/or services, to any of the herein-described users, individuals, patients, or entities, who or which utilize the apparatus and method of the present invention. The insurance exchange computer can be utilized to advertise, provide information regarding, sell, and/or maintain records regarding, and process any other information regarding, group insurance as well as individual or family insurance policies, products, or services. The insurance exchange computer can also be utilized to sell automobile, homeowners, business, and/or liability insurance policies, products, or services.

The apparatus can also include a social networking computer. The social networking computer can be linked with, and can be utilized in connection with, the apparatus so as to allow and/or facilitate integrating the apparatus of the present invention with social networks, social networking groups, and social media. The social networking computer can be associated with a social networking company, a social networking website, or a social networking entity, website, group, organization, or association. The social networking computer can also be associated with any one or any number of social networking companies, social networking websites, or social networking entities, websites, groups, organizations, or associations. The social networking computer can also provide links to any computers associated with any one or any number of social networking companies, social networking websites, or social networking entities, websites, groups, organizations, or associations. The social networking computer can perform any and/or all of the functions performed by any social networking company, a social networking website, or social networking entity, website, group, organization, or association. Any number of social networking computers can be utilized in connection with the present invention.

The apparatus can also include a media computer. The media computer can provide, and can be a source of, news information, current events information, healthcare information, healthcare or healthcare-related news, current events, advertisements, and/or marketing information or materials, which can be disseminated via the present invention. Any number of media computers, with each being dedicated to providing any number, types, or kinds of, news information, current events information, healthcare information, healthcare or healthcare-related news, current events, advertisements, and/or marketing information or materials, can be utilized in connection with the present invention.

Each of the central processing computer(s), the provider communication devices, the payer communication devices, the user or patient communication devices, the intermediary communication devices, the healthcare records computers, the insurance exchange computers, the social networking computers, and the media computers, can communication in a bi-directional manner with, and/or can send and/or receive signals, messages, reports, notification messages, alerts, or any other communications or electronic communication transmissions, to, from and/or between, any other, or any number of, other central processing computer(s), if utilized, provider communication devices, payer communication devices, user or patient communication devices, intermediary communication devices, healthcare records computers, insurance exchange computers, social networking computers, and/or the media computers.

Each of the central processing computer(s), the provider communication devices, the payer communication devices, the user or patient communication devices, the intermediary communication devices, the healthcare records computers, the insurance exchange computers, the social networking computers, and the media computers, can be linked to or with any other central processing computer(s), if utilized, provider communication devices, payer communication devices, user or patient communication devices, intermediary communication devices, healthcare records computers, insurance exchange computers, social networking computers, and/or the media computers, via a wired link or line or a wireless link.

Each of the provider communication devices, payer communication devices, user or patient communication devices, intermediary communication devices, healthcare records computers, insurance exchange computers, social networking computers, and/or the media computers, can be connected with or linked with the central processing computer.

Any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and/or can be transmitted via or using any appropriate or necessary computer(s) or device(s).

The present invention can be utilized on, and/or over, the Internet and/or the World Wide Web and/or via any other communication network, telecommunication network, telephone network, a line-connected network, or a wireless communication network, or any combination of same. The present invention can also utilize wireless Internet and/or World Wide Web services, equipment and/or devices. The central processing computer(s) and/or any of the herein-described computers or communication devices can also have a web site or web sites associated with same.

The present invention can be utilized on, or over, the Internet and/or the World Wide Web, and/or on, or over, any other communication network or system, including, but not limited to, a communication network or system, a telecommunication network or system, a telephone communication network or system, a cellular communication network or system, a wireless communication network or system, a wireless Internet network or system, a wireless World Wide Web network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

The apparatus and method of the present invention can also utilize electronic commerce technologies and security methods, techniques and technologies, in any and/or all of the instances of data and/or information processing, and/or data and/or information transmission described herein.

Each of the central processing computer(s), as well as each of the herein-described computers or communication devices can include a central processing unit or CPU, a random access memory device(s) (RAM), a read only memory device(s) (ROM), and a user input device. Each of the central processing computer(s), as well as each of the herein-described computers or communication devices can also include a display device, a transmitter(s), a receiver, a database(s), and an output device. The database(s) can contain any and/or all of the data and or information which is needed to perform the various processing methods, services, functions, and/or operations, described herein.

The present invention can be utilized in numerous preferred embodiments in order to provide a vast array of healthcare and healthcare-related services for any one or more of the various individuals, patients, providers, insurers, intermediaries, or any other parties described herein.

The present invention can be utilized in order to process diagnostic information, treatment information, or treatment planning information, and/or any other related data and/or information, with or using genetic information and/or genetic-related information in order to perform a diagnosis of, and/or to prescribe a treatment or a treatment plan for, a sickness, illness, and/or any condition. The present invention can also provide for automatic insurance claim form generation and submission or automatic request for payment form generation and submission via the central processing computer once a final diagnosis and/or a treatment or treatment plan has been prescribed by a provider and/or upon the occurrence of an examination, an administration of a treatment, or the performance of a procedure or any other activity by a provider.

The present invention can also be utilized to process genetic information or genetic-related information, which can be obtained from an individual or patient at anytime during the lifetime of the individual or patient, whether it be at or shortly after birth, at any age or point during or in the individual's or patient's lifetime, or prior to the birth of the individual or patient, or from his or her fetus and/or while in utero, or from an embryo prior to implantation. The genetic information or genetic-related information obtained can be analyzed and utilized in order to generate or provide an initial genetic diagnostic report or plan or a baseline genetic diagnostic report or plan and/or an initial genetic treatment report or plan or a baseline genetic treatment report or plan for the individual or patient. The initial genetic diagnostic report or plan or the baseline genetic diagnostic report or plan and/or the initial genetic treatment report or plan or the baseline genetic treatment report or plan can be utilized for, among other things, managing and/or monitoring the individual's or the patient's healthcare, scheduling healthcare and/or healthcare-related examinations, tests, procedures, or surgeries, designing and/or implementing treatment plans and/or wellness plans, administering treatments, evaluating treatments, and/or for designing or implementing dietary, fitness, exercise, and/or wellness, routines, and/or for evaluating and/or comparing diagnostic reports, treatment reports, or treatment plans, and/or genetic information or genetic-related information, which can be obtained in or during the individual's or the patient's lifetime.

The present invention can also be utilized for allowing a genetic testing provider, laboratory, or service, to provide or to transmit genetic information test results or generic-related information test results either directly or indirectly to a computer or a computer system for inclusion in and/or for storage in an electronic healthcare record of an individual or a patient. The present invention can then process the genetic information or the genetic-related information and can generate or provide a genetic diagnostic report or plan and/or a genetic treatment report or plan corresponding thereto for the individual or the patient.

The present invention can also be utilized in any number of other ways in order to provide healthcare information and/or healthcare-related information with or using an electronic healthcare record and genetic information and/or genetic-related information regarding an individual or a patient.

### BRIEF DESCRIPTION OF THE DRAWINGS

In the Drawings:

FIG. 1 illustrates a preferred embodiment of the present invention, in block diagram form;

FIG. 2 illustrates the central processing computer of FIG. 1, in block diagram form;

FIG. 3 illustrates the provider communication device of FIG. 1, in block diagram form;

FIG. 4 illustrates the insurer or payer communication device of FIG. 1, in block diagram form;

FIG. 5 illustrates the user or patient communication device of FIG. 1, in block diagram form;

FIG. 6 illustrates the intermediary communication device of FIG. 1, in block diagram form;

FIG. 7 illustrates an exemplary healthcare records system computer of FIG. 1, in block diagram form;

FIG. 8 illustrates an exemplary insurance exchange computer of FIG. 1, in block diagram form;

FIG. 9 illustrates an exemplary social networking computer of FIG. 1, in block diagram form;

FIG. 10 illustrates an exemplary media computer of FIG. 1, in block diagram form;

FIGS. 11A and 11B illustrate a preferred embodiment method of using the present invention, in flow diagram form;

FIG. 12 illustrates another preferred embodiment method of using the present invention, in flow diagram form; and

FIG. 13 illustrates still another preferred embodiment method of using the present invention, in flow diagram form.

### DESCRIPTION OF THE PREFERRED EMBODIMENTS

The present invention is directed to an apparatus and a method for processing and/or for providing healthcare information and/or healthcare-related information with or using an electronic healthcare record and genetic information and/or genetic-related information, and, in particular, to an apparatus and a method for processing and/or for providing healthcare information and/or healthcare-related information with or utilizing an electronic healthcare record and genetic information and/or genetic-related information, and/or data and/or information contained therein, for and/or in a number and a wide variety of applications which can provide for enhancements and improvements in healthcare.

The present invention provides an apparatus and a method for processing diagnostic information, treatment information, or treatment planning information, and/or any other related data and/or information with or using genetic information and/or genetic-related information. In a preferred embodiment, the apparatus and method of the present invention can be utilized in order to process diagnostic information, treatment information, or treatment planning information, and/or any other related data and/or information, with or using genetic information and/or genetic-related information in order to perform a diagnosis of, and/or to prescribe a treatment for, or to design or develop, a treatment plan for, a sickness, an illness, and/or a condition.

The apparatus and method of the present invention can also be utilized in order to process genetic information or genetic-related information, which can be obtained from an individual or a patient at anytime during the lifetime of the individual or the patient, whether it be at or shortly after birth, at any age or point during or in the individual's or the patient's lifetime, or prior to the birth of the individual or the patient, or from his or her fetus while in utero, or from an embryo prior to implantation. The genetic information or genetic-related information obtained can be analyzed and utilized in order to generate or to provide an initial genetic diagnostic report or plan or a baseline genetic diagnostic report or plan and/or an initial genetic treatment report or plan or a baseline genetic treatment report or plan for the individual or patient. The initial genetic diagnostic report or plan or the baseline genetic diagnostic report or plan and/or the initial genetic treatment report or plan or the baseline genetic treatment report or plan can be utilized for, among other things, managing and/or monitoring the individual's or the patient's healthcare, scheduling healthcare and/or healthcare-related examinations, tests, procedures, or surgeries, designing and/or implementing treatment plans and/or wellness plans, administering treatments, evaluating treatments, and/or for designing or implementing dietary, fitness, exercise, and/or wellness, routines, and/or evaluating and/or comparing diagnostic reports, treatment reports, or treatment plans, and/or genetic information or genetic-related information, which can be obtained in or during the individual's or the patient's lifetime.

The apparatus and method of the present invention can also be utilized in order to allow a genetic testing provider, laboratory, or service, to provide or to transmit genetic information test results or generic-related information test results either directly or indirectly to a computer or to a computer system for inclusion in and/or for storage in an electronic healthcare record of an individual or a patient. The apparatus can then process the genetic information or the genetic-related information and can generate or provide a genetic diagnostic report or plan and/or a genetic treatment report or plan corresponding thereto for the individual or the patient.

The present invention can also be utilized to determine and/or to provide projected or estimated cost of treatment information for any treatment plan or for any treatment plans generated by or provided by the apparatus and method of the present invention. An projections or estimations of the cost of treatment for any given treatment plan can include the projected or estimated costs of treatment for treatments plans for each of any number of domestic or foreign cities, locales, regions, or other geographical subdivisions, and can be utilized for treatment cost comparison and/or for treatment cost optimization analysis and/or planning.

The present invention also provides an apparatus and a method which can be utilized to schedule appointments with providers. The present invention can also provide an apparatus and a method which can be utilized in connection with, and/or to provide information contained in or at, or provided by, electronic healthcare records, insurance exchanges, social networks, and/or media sources.

The present invention also provides an apparatus and a method for providing a centralized database for storing genetic information and/or genetic-related information for or regarding any number of individuals or patients which can be utilized for a wide variety of applications including, but not limited to, locating or identifying individuals of any age, locating lost or abducted children, ascertaining family histories of individuals, ascertaining the family histories of adopted children, and/or for any other application or purpose where genetic information or genetic-related information can be used.

As used herein, the term “electronic healthcare record” or “EHR” means any electronic healthcare record, electronic medical record, electronic dental record, electronic pharmacy record, electronic behavioral health record, and/or any other record or record keeping system, software, hardware, or device, or any combination of same or group of same, which can contain healthcare information or healthcare-related information.

As used herein, the term “genetic information” means any information contained in, coded in, encoded in, obtained from, or included in, the DNA, RNA, chromosomes, genes, plasmids, or any other genetic material, or any proteins or enzymes which are or which may be produced, created, formed, synthesized, or generated, by the DNA, RNA, or any other genetic material, of an individual, or the DNA, RNA, chromosomes, genes, plasmids, or any other genetic material, or any proteins or enzymes which are or which may be produced, created, formed, synthesized, or generated, by the DNA, RNA, or any other genetic material, of an individual, individual's family member(s), parent(s), sibling(s), child or children, or any person(s) having a blood relationship or bloodline relationship with the individual. As used herein, the term “genetic information” also means any information obtained from or by, or identified by or from an analysis or a testing of, or ascertained from any analysis or testing of, or obtained from or identified from a genetic test or a genetic analysis of, the DNA, RNA, chromosomes, genes, plasmids, or any other genetic material, or any proteins or enzymes which are or which may be produced, created, formed, synthesized, or generated, by the DNA, RNA, or any other genetic material, of an individual, or the DNA, RNA, chromosomes, genes, plasmids, or any other genetic material, or any proteins or enzymes which are or which may be produced, created, formed, synthesized, or generated, by the DNA, RNA, or any other genetic material, of an individual's family member(s), parent(s), sibling(s), child or children, or any person(s) having a blood relationship or bloodline relationship with the individual.

As used herein, the term “genetic information” also means any information contained in, coded in, encoded in, obtained from or by, or identified from or by an analysis or a testing of, or ascertained from or by any analysis or any testing of, the DNA, RNA, chromosomes, genes, plasmids, or any other genetic material, of an individual, or an individual's family member(s), parent(s), sibling(s), child or children, or any person(s) having a blood relationship or bloodline relationship with the individual, or any genetic material, including, but not limited to, any information contained in, included in, or found to be present in, any heritable biological information found in or coded in any nucleotide sequences of the DNA, RNA, chromosomes, genes, plasmids, or any other genetic material, of an individual, or an individual's family member(s), parent(s), sibling(s), child or children, or any person(s) having a blood relationship or bloodline relationship with the individual.

As used herein, the term “genetic information” also means the DNA, RNA, chromosomes, genes, plasmids, or any other genetic material, and any information obtained from same, or obtained or identified from an analysis or testing of same, and/or any information contained in, coded in, encoded in, or included in, same, of an individual, or an individual's family member(s), parent(s), sibling(s), child or children, or any person(s) having a blood relationship or bloodline relationship with the individual, of or regarding an individual, or an individual's family member(s), parent(s), sibling(s), child or children, or any person(s) having a blood relationship or bloodline relationship with the individual.

As used herein, the term “genetic information” also means information about or regarding, or information obtained or derived from, or information contained in, an individual's genetic tests or genetic test results, and/or information about or regarding, or information obtained or derived from, or information contained in, the genetic tests or genetic test results, of an individual's family member(s), parent(s), sibling(s), child or children, or any person(s) having a blood relationship or bloodline relationship with the individual.

As used herein, the term “genetic information” also means information about or regarding an individual's genetic tests and the genetic tests of the individual's family member(s), parent(s), sibling(s), child or children, or any person(s) having a blood relationship or bloodline relationship with the individual, information regarding an individual's family history, or information regarding a disease, a disorder, a condition, a sickness, a syndrome, or a cancer, or any other information regarding a potential or a likelihood of same, in or regarding an individual or the individual's family member(s), parent(s), sibling(s), child or children, or any person(s) having a blood relationship or bloodline relationship with the individual, or information regarding a manifestation of a disease, a disorder, a condition, a sickness, a syndrome, or a cancer, or any other information regarding a potential or a likelihood of same, in or regarding an individual or the individual's family member(s), parent(s), sibling(s), child or children, or any person(s) having a blood relationship or bloodline relationship with the individual, or any information regarding any risk that the individual, or the individual's family member(s), parent(s), sibling(s), child or children, or any person(s) having a blood relationship or bloodline relationship with the individual, has a risk or an increased risk of getting, acquiring, or having, a disease, a disorder, a condition, a sickness, a syndrome, or a cancer, in the future or at any other time in his or her lifetime.

As used herein, the term “genetic information” also means any information regarding any request for, prescription for, or requirement for, or any receipt of, or any results obtained by or from, any genetic services, genetic testing services, or any genetic analysis services, for or regarding an individual, or the individual's family member(s), parent(s), sibling(s), child or children, or any person(s) having a blood relationship or bloodline relationship with the individual, or any fetus carried by an individual, or the individual's family member(s), parent(s), sibling(s), child or children, or any person(s) having a blood relationship or bloodline relationship with the individual, or any embryo legally held by an individual, or by the individual's family member(s), parent(s), sibling(s), child or children, or any person(s) having a blood relationship or bloodline relationship with the individual.

As used herein, the term “genetic information” also means any written, recorded, or digital information, or any digital representation, which can be identified with or associated with an individual, or with the individual's family member(s), parent(s), sibling(s), child or children, or any person(s) having a blood relationship or bloodline relationship with the individual, which can or may be any health-related information which can result from or be obtained by or from any genetic testing, healthcare evaluation, or medical evaluation, which can be conducted or which can be utilized in order to determine or ascertain the presence or absence of a variation(s) or mutation(s), or any carrier status, in or regarding, any genetic material, DNA, RNA, chromosomes, genes, plasmids, genetic markers, or any other genetic material, of an individual, or of the individual's family member(s), parent(s), sibling(s), child or children, or any person(s) having a blood relationship or bloodline relationship with the individual, or any presence or absence of a gene or genes, or a genetic marker(s), which has been or which may be medically or scientifically believed to cause, to be the cause of, or to be associated with, a disease, a disorder, a condition, a sickness, a syndrome, or a cancer, the presence or absence of a gene or genes, or a genetic marker(s), which can, has been, or may, be associated with a statistical or a statically increased risk of developing or getting a disease, a disorder, a condition, a sickness, a syndrome, or a cancer, and/or which may be, or which may not be, asymptomatic at the time of any genetic testing or genetic analysis. As used herein, the term “genetic information” also means any findings or results of or regarding any genetic test or genetic analysis, or any documentation of or regarding any communication(s) of any of the herein-defined genetic information or genetic-related information to a provider, or to an individual, or to the individual's family member(s), parent(s), sibling(s), child or children, or any person(s) having a blood relationship or bloodline relationship with the individual.

As used herein, the term “genetic information” means genomic information.

As used herein, the term “genetic information” also means any digital representation of, any picture(s), photograph(s), or video information of, any audio information of, or any other written, visual, or oral, data and/or information of, or notes or comments of or regarding, any of the genetic information described herein or defined herein or any genetic-related information described herein or defined herein.

As used herein, the term “genetic-related information” means any data and/or information, or any digital representation of same, which can be, or which can be associated with, derived from, or related to or pertain to, any genetic information as that term is defined herein.

In a preferred embodiment, any genetic information or any genetic-related information described herein can be stored in digital form and/or stored as a digital representation of same. Further, in a preferred embodiment, any picture(s), photograph(s), or video information of, any audio information of, or any other written, visual, or oral, data and/or information of, or any notes or comments of or regarding, any of the genetic information or genetic-related information described herein can also be stored in digital form and/or can be stored as a digital representation of same.

The term “genetic material”, as used herein, means or includes, but is not limited to, DNA, RNA, chromosomes, genes, or plasmids, or any proteins or enzymes which are or which may be produced, created, formed, synthesized, or generated, by the DNA, RNA, or any other genetic material, or any other material containing genetic information or genetic-related information or genetic matter, or any material containing heritable biological information. The term “genetic material”, as used herein, also means or includes genomic material or matter or any material or matter containing genomic information.

The apparatus and method of the present invention facilitates the creation and management of a comprehensive electronic healthcare record system and a healthcare processing system which can process and/or store genetic information or genetic-related information and which can manage individual or patient healthcare records or files, doctor and other provider records, healthcare insurance and/or payer records, and which can also thereby provide an apparatus, system, and methods for providing a variety and a multitude of healthcare information processing applications, processes and services.

The apparatus and method of the present invention also provides for the integration of healthcare information and healthcare-related information which can be stored in or obtained from and among any number of different and separate electronic healthcare records and electronic healthcare records systems, which can be provided by any number of vendors or suppliers, and can facilitate a comprehensive electronic healthcare record or electronic healthcare record system which can process and/or store genetic information and/or genetic-related information.

The apparatus and method of the present invention can also provide for the integration of insurance exchanges and/or employee benefits exchanges and/or the respective computers or computer systems associated therewith with a healthcare information system, a healthcare-related information system, and/or an electronic healthcare record or electronic healthcare records.

The apparatus and method of the present invention can also provide for the integration of social networking computers and social networking web sites and their information and functionality with a healthcare information system, a healthcare-related information system, and/or an electronic healthcare record or electronic healthcare records.

The apparatus and method of the present invention can also provide for the integration of news, information, advertisements, and marketing information and/or materials, with or in connection with a healthcare information system, a healthcare-related information system, and/or an electronic medical record or electronic medical records.

The present invention facilitates improved healthcare quality, efficient information collection, processing and dissemination, efficient diagnosis and treatment, cost efficiency, cost containment, automated billing, notification and alert messaging, as well as many other benefits and advantages as will be described herein.

The apparatus and method of the present invention also facilitates the distribution and management of healthcare insurance, life insurance, disability insurance, as well as facilitates claim generation and submission and any processing related thereto.

As used herein, the terms “individual”, “patient”, “client”, “user” or the like, or their plural forms, refers to any person, individual, patient, entity, and/or client, who or which uses the present invention, and/or who seeks and/or who receives healthcare services, healthcare-related services, healthcare-related information, and/or any of the other services and/or products provided by the present invention.

As used herein, the term “caregiver” or the plural of same, refers to any parent, child, agent, attorney, representative, guardian, legal guardian, or any other person or entity who or which is responsible for caring for, looking after, or otherwise taking care of any healthcare needs of any individual or patient.

As used herein, the terms “doctor”, “healthcare provider”, “provider”, “therapist”, “healthcare information specialist”, or their plural forms, refers to any medical doctor, internist, orthopedist, ophthalmologist, cardiologist, hematologist, endocrinologist, oncologist, ear, nose and throat specialist, neurologist, urologist, gastroenterologist, dermatologist, pediatricians, medical specialist, surgeon, surgical specialist, physician, dentist, psychiatrist, psychologist, optometrist, podiatrist, osteopath, chiropractor, pharmacist, therapist, physical therapist, respiratory therapist, nurse, healthcare aid, nutritionist, acupuncturist, occupational therapist, and/or any other person, individual and/or professional, who can provide healthcare, healthcare-related, wellness, and/or wellness-related, services and/or products.

As used herein, the term “healthcare provider” also means a hospital, a healthcare facility, a clinic, a pharmacy, a laboratory, a therapy center, a testing center, and/or any other organization or entity which provides any healthcare or healthcare-related services, goods, or products.

As used herein, the term “healthcare provider” also means a laboratory, a testing service, a genetic testing service, a genetic material testing service, or a DNA, RNA, chromosome, gene or genetic, plasmid, or any other genetic material, testing or analysis service, laboratory, or entity.

As used herein, the terms “insurer”, “payer”, “insurance provider”, “heath insurance provider”, “life insurance provider”, “disability insurance provider”, or their plural forms, refers to any insurance companies, healthcare insurance companies, disability insurance companies, property or casualty insurance companies, health maintenance organizations, healthcare providers, and any other payer and/or provider of healthcare services and/or products, who which provide and/or pay for healthcare and/or healthcare-related benefits, services, and/or products, and/or who or which provide respective health insurance, life insurance and/or disability insurance benefits, services and/or products.

As used herein, the terms “broker”, “agent”, “billing service”, “collection agent”, “manager”, intermediary”, “assistant”, etc., or their plural forms, refer to any broker, insurance broker, agent, insurance agent, intermediary, third party, billing service provider, collection agent, claim processing agent, and/or any other person, individual, and/or entity, which acts on behalf of, or for, any of the individuals, patients, doctors, healthcare providers, insurers, payers, etc., described herein.

Applicant hereby incorporates by reference herein the subject matter and teachings of U.S. Provisional Patent Application Ser. No. 61/892,298, filed Oct. 17, 2013, and entitled “APPARATUS AND METHOD FOR PROCESSING AND/OR FOR PROVIDING HEALTHCARE INFORMATION AND/OR HEALTHCARE-RELATED INFORMATION WITH OR USING AN ELECTRONIC HEALTHCARE RECORD AND GENETIC INFORMATION AND/OR GENETIC-RELATED INFORMATION”, the subject matter and teachings of which are hereby incorporated by reference herein in their entirety.

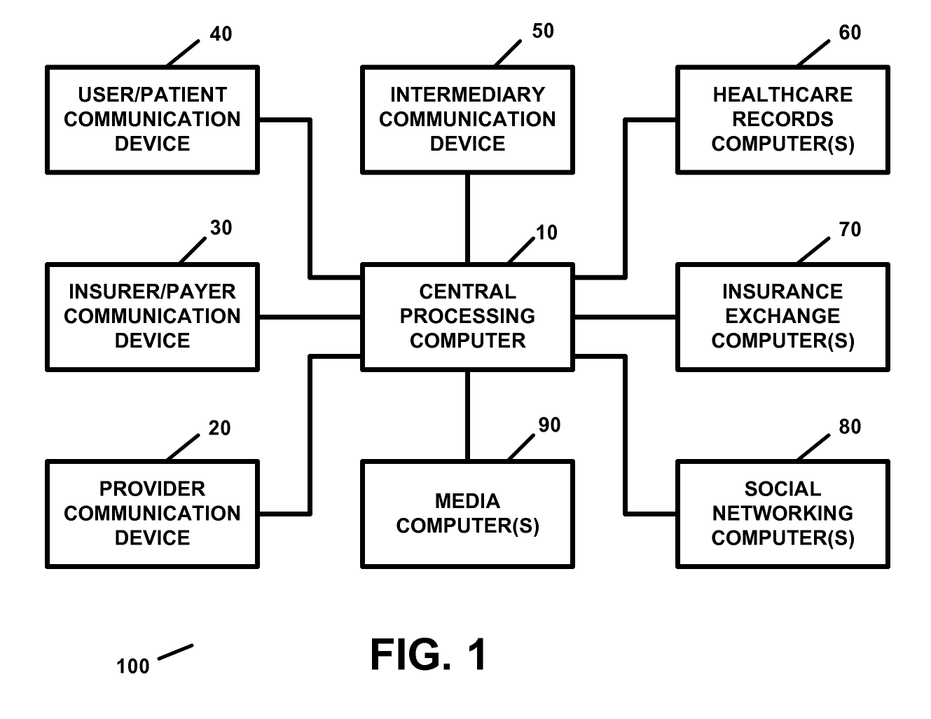

FIG. 1 illustrates the apparatus of the present invention, in block diagram form. The apparatus of the present invention is denoted generally by the reference numeral 100. In the preferred embodiment, the apparatus 100 of the present invention includes a central processing computer or central processing computer system 10 (hereinafter referred to as the “central processing computer 10”). In the preferred embodiment, the central processing computer 10 can be a network or a server computer.

In the preferred embodiment, the central processing computer 10 can provide control over the apparatus 100 and can perform any of the various processing services and/or functions described herein. The central processing computer 10 may be a single computer or system of computers and/or may be or include a plurality of computers or computer systems which are utilized in conjunction with one another. The central processing computer 10, in the preferred embodiment, can provide services for any of the other computers and/or computer systems or communication devices described herein as being associated with any of the individuals, patients, healthcare providers, insurers, payers, brokers, agents, and/or intermediaries, described herein.

The apparatus 100 also includes a healthcare provider communication device or computer 20 (hereinafter referred to as “provider communication device 20” or “provider computer 20”) which is associated with a healthcare provider such as a healthcare professional, a hospital, a clinic, and/or any other provider of services or healthcare providers described herein. A provider computer 20 can also be associated with, or can be used by, any genetic testing or analysis laboratory, service, or provider, or any entity which performs testing or analysis of any genetic material, such as, but not limited to, DNA, RNA, chromosomes, genes, or plasmids, or any other genetic information or genetic material described herein, or any other material containing genetic information or genetic matter. The provider computer 20 can communicate with, and can operate in conjunction with, the central processing computer 10 and/or any of the other computers and/or computer systems or communication devices described herein.

A provider computer 20 can also be associated with, or can be used by, any research institution, research facility, teaching institution, teaching hospital, college, university, school, or other institution or entity which may perform research, or provide research information or any related information regarding studies, findings, or developments, in the healthcare field or in healthcare-related fields. A provider computer 20 can also be associated with, or can be used by, any public health department, public health agency, public health facility, or other public health entity, on any one or more of a national level, a country level, a state level, a provincial level, a county level, a city level, a municipal level, or any other level, which is entrusted to provide for the public health and/or to perform services or oversight regarding public health. A provider computer 20 can also be associated with, or can be used by, any immunization registry or immunization registries.

A provider computer 20 can also be associated with, or can be used by, any source or provider of educational or instructional information, or information regarding instructions or procedures, or links or hyperlinks to same. A provider computer 20 can also be associated with, or can be used by, any laboratory, testing service, analysis service, genetic material testing or analyzing service or laboratory, or any DNA, RNA, chromosome, gene or genetic, plasmid, or any other genetic information or other genetic material, testing or analyzing service, laboratory, or entity.

Any number or amount of healthcare provider computers 20 can be utilized in conjunction with a healthcare provider and/or group of providers. The healthcare provider communication device(s) 20 can communicate with, and operate in conjunction with, the central processing computer 10 and/or any of the other computers and/or computer systems associated with any of the other individuals and/or entities which utilize and/or operate in conjunction with the present invention.

The apparatus 100 can also include a healthcare insurer or payer communication device or computer 30 (hereinafter referred to as “payer communication device 30” or “payer computer 30”) which is associated with a healthcare payer such as a healthcare insurer, insurance company, health maintenance organization, a clinic, and/or any other payer of healthcare services and/or products described herein. Any number or amount of healthcare payer communication device(s) 30 or healthcare payer computers 30 can be utilized in conjunction with a healthcare payer and/or group of payers. The healthcare payer communication device(s) 30 can communicate with, and operate in conjunction with, the central processing computer 10 and/or any of the other computers and/or computer systems associated with any of the other individuals and/or entities which utilize and/or operate in conjunction with the present invention.

The apparatus 100 can also include a user, patient, or individual, communication device or computer 40 (which may hereinafter be referred to either as “user communication device 40”, “user or patient communication device 40”, “user computer 40”, “patient computer 40”, or “user/user or patient communication device 40”) which is associated with any user of the apparatus 100 or any individual or healthcare patient or client who seeks or who is provided with healthcare and/or related services, products and/or related information. The user communication device 40 can also be utilized by any individual, party, or entity, or by a caregiver of same, who or which may merely utilize the present invention in order to obtain information of interest.

A user communication device 40 may also be located at public places or locations, such as at kiosks or other publicly available computers or communication devices. Any number or amount of user communication devices 40 can be utilized in conjunction with a user, patient, a group of users, and/or a group of patients. The user communication device 40 can communicate with, and operate in conjunction with, the central processing computer 10 and/or any of the other computers and/or computer systems associated with any of the other individuals and/or entities which utilize, and/or operate in conjunction with, the present invention. The user communication device 40 can also be utilized by any other individual or entity desiring to utilize, and/or to obtain information from, the apparatus 100 and/or from any other the computer(s) or communication device(s).

The apparatus 100 can also include an intermediary communication device or computer 50 (hereinafter referred to as “intermediary communication device 50” or “intermediary computer 50”) which is associated with an intermediary, a broker, an agent, and/or any other individual and/or entity, that can utilize the present invention in order to act for and/or on behalf of any other individual, party, or entity, described herein. Any number or amount of intermediary computers 50 can be utilized in conjunction with an intermediary and/or group of intermediaries. The intermediary computer(s) 50 can communicate with, and operate in conjunction with, the central processing computer 10 and any of the other computers and/or computer systems associated with any of the other individuals and/or entities which utilize, and/or operate in conjunction with, the present invention.

In the preferred embodiment, any of the provider communication device(s) 20, the payer computer(s) 30, the user communication device(s) 40, and/or the intermediary computer(s) 50, can be any computer or communication device, including, but not limited to, a personal computer, a home computer, a server computer, a network computer, a computer system, a hand-held computer, a palmtop computer, a laptop computer, a tablet, a tablet computer, a personal communication device, a cellular telephone, a wireless telephone, a mobile telephone, a digital television, an interactive television, a digital television, an Internet-enabled television, a personal digital assistant, a telephone, a digital telephone, a television, an interactive television, a beeper, a pager, a smart phone, or a watch, an Internet-enabled watch or an Internet-enabled time piece, Internet-enabled eyewear or glasses, Internet-enabled clothing or apparel or an Internet-enabled article of clothing or footwear, or an Internet-enabled accessory, or Internet-enabled jewelry.

Each of the central processing computer(s) 10, the provider communication device(s) 20, the payer communication device(s) 30, the user communication device(s) 40, and/or the intermediary computer(s) 50, can transmit information to, as well as receive information from, any of the computers or communication devices 10, 20, 30, 40, and 50, described herein. In this regard, each of the computers or communication devices 10, 20, 30, 40, and 50, can communicate with, process information from, and/or share data and/or information with, each other and/or any other computers or communication devices 10, 20, 30, 40, and 50, described herein and/or utilized in conjunction with the present invention. In this manner, data and/or information transfer between any of the computers or communication devices 10, 20, 30, 40, and 50, can communicate with any other computers or communication devices 10, 20, 30, 40, and 50, in a bi-directional manner.

The central processing computer(s) 10, the provider communication device(s) 20, the payer computers(s) 30, the user communication device(s) 40, and the intermediary computer(s) 50, can communicate with one another, and/or be linked to one another, over a communication network, a telecommunication network, a telephone network, a line-connected network, and/or a wireless communication network. Each of the computers or communication devices 10, 20, 30, 40, and 50, can be linked with any other computers or communication devices directly or indirectly with one another so as to facilitate a direct or indirect bi-directional communication with and between said respective computers or communication devices. Communications between each of the computers or communication devices 10, 20, 30, 40, or 50 can also involve an e-mail server or e-mail servers in those instances when e-mails are described as being used to transmit or to send any of the information, signals, messages, reports, notification messages, or any other communications, described herein, by or between any of the computers or communication devices 10, 20, 30, 40, or 50, or when any of the information, signals, messages, reports, notification messages, or any other communications, described herein, are transmitted by and/or between any of the parties described herein and/or by or between any of the computers or communication devices 10, 20, 30, 40, or 50, or any other computers or communication devices, computer systems, communication network equipment, server computers, etc., or any other devices used or needed in order to facilitate communications or the transmission of any of the herein-described information, signals, messages, reports, notification messages, or any other communications.

The apparatus 100 can also include a healthcare records computer 60 or computers (hereinafter referred to as “healthcare records computer 60” or “healthcare records computer(s) 60”) which can be or can include a computer or computer system, or any number of computers or computer systems, or a cloud computer system or cloud system. The healthcare records computer 60 can serve to store and house an electronic healthcare record or file or any number of electronic healthcare records or files. In the preferred embodiment, the healthcare records computer 60 can be associated with any provider, insurer, payer, intermediary, insurance exchange, or any user, individual, patient, organization, or entity, who or which utilizes the apparatus 100 and method of the present invention.

Each healthcare records computer 60 can be utilized to store an electronic healthcare record or file or any number of electronic healthcare records or files which can be accessed by the central processing computer 10, by any provider communication device 20, by any insurer or payer communication device 30, by any user communication device 40, by any intermediary communication device 50, or by any other computer, communication device or other device described herein as being utilized in connection with the apparatus 100 and method of the present invention. The healthcare records computer 60 can also be utilized to facilitate cloud storage of any electronic healthcare record(s) or file(s).

The apparatus 100 can also include an insurance exchange computer 70, or any number of insurance exchange computers 70 which can be utilized to process and store information regarding the selling of healthcare insurance, disability insurance, and life insurance, policies, products, and/or services, to any of the herein-described users, individuals, patients, or entities, who or which utilize the apparatus 100 and method of the present invention. The insurance exchange computer 70 can also be utilized to advertise, provide information regarding, sell, and/or maintain records regarding, and process any other information regarding, group insurance as well as individual or family insurance policies, products, or services. The insurance exchange computer 70 can also be utilized to sell automobile, homeowners, business, and/or liability insurance policies, products, or services.

The apparatus 100 can also include a social networking computer 80. The social networking computer 80 can be linked with, and utilized in connection with, the apparatus 100 so as to allow and/or facilitate integrating the apparatus 100 of the present invention with social networks, social networking, and social media. In a preferred embodiment, for example, the social networking computer 80 can be associated with a social networking company, a social networking website, or social networking entity, website, group, organization, or association. The social networking computer 80 can be associated with any one or any number of social networking companies, social networking websites, or social networking entities, websites, groups, organizations, or associations. The social networking computer 80 can also provide links to any computers associated with any one or any number of social networking companies, social networking websites, or social networking entities, websites, groups, organizations, or associations. In the preferred embodiment, the social networking computer 80 can perform any and all of the functions performed by any social networking company, a social networking website, or social networking entity, website, group, organization, or association. In a preferred embodiment, any number of social networking computers 80 can be utilized in connection with the apparatus 100 of the present invention.

The apparatus 100 can also include a media computer 90. In the preferred embodiment, the media computer 90 can provide, and can be a source of, news information, current events information, healthcare information, healthcare or healthcare-related news, current events, advertisements, and/or marketing information or materials, which can be disseminated via the apparatus 100 of the present invention, In a preferred embodiment, any number of media computers 90, with each being dedicated to providing any number, types, or kinds of, news information, current events information, healthcare information, healthcare or healthcare-related news, current events, advertisements, and/or marketing information or materials, can be utilized in connection with the apparatus 100.

In a preferred embodiment, each of the central processing computer(s) 10, the provider communication devices 20, the payer communication devices 30, the user communication devices 40, the intermediary communication devices 50, the healthcare records computers 60, the insurance exchange computers 70, the social networking computers 80, and/or the media computers 90, can communication in a bi-directional manner with, and/or can send and/or receive signals, messages, reports, notification messages, alerts, or any other communications or electronic communication transmissions, to, from and/or between, any other, or any number of, other central processing computer(s) 10, if utilized, provider communication devices 20, payer communication devices 30, user or patient communication devices 40, intermediary communication devices 50, healthcare records computers 60, insurance exchange computers 70, social networking computers 80, and/or media computers 90.

In a preferred embodiment, each of the central processing computer(s) 10, the provider communication devices 20, the payer communication devices 30, the user communication devices 40, the intermediary communication devices 50, the healthcare records computers 60, the insurance exchange computers 70, the social networking computers 80, and/or the media computers 90, can be linked to or with any other central processing computer(s) 10, if utilized, provider communication devices 20, payer communication devices 30, user communication devices 40, intermediary communication devices 50, healthcare records computers 60, insurance exchange computers 70, social networking computers 80, and/or the media computers 90, via a wired link or line or via a wireless link.

In a preferred embodiment, each of the provider communication devices 20, payer communication devices 30, user communication devices 40, intermediary communication devices 50, healthcare records computers 60, insurance exchange computers 70, social networking computers 80, and/or the media computers 90, can be connected with or linked with the central processing computer 10.

In a preferred embodiment, any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s).

In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, in the preferred embodiment, has a web site or web sites associated therewith. Each of the other computers or communication devices described herein can also have a web site or web sites associated with same.

Although the Internet and/or the World Wide Web is a preferred communication system and/or medium utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

In the preferred embodiment, each of the central processing computer(s) 10, the provider communication device(s) 20, the payer communication device(s) 30, the user communication device(s) 40, the intermediary computer(s) 50, the healthcare records computer(s) 60, the insurance exchange computer(s) 70, the social networking computer(s) 80, and/or the media computer(s) 90, can transmit data and/or information using TCP/IP, as well as any other Internet and/or World Wide Web, and/or communication, protocols.

The apparatus 100 of the present invention can also utilize electronic commerce technologies and security methods, techniques and technologies, in any and/or all of the instances of data and/or information processing, and/or data and/or information transmission described herein.

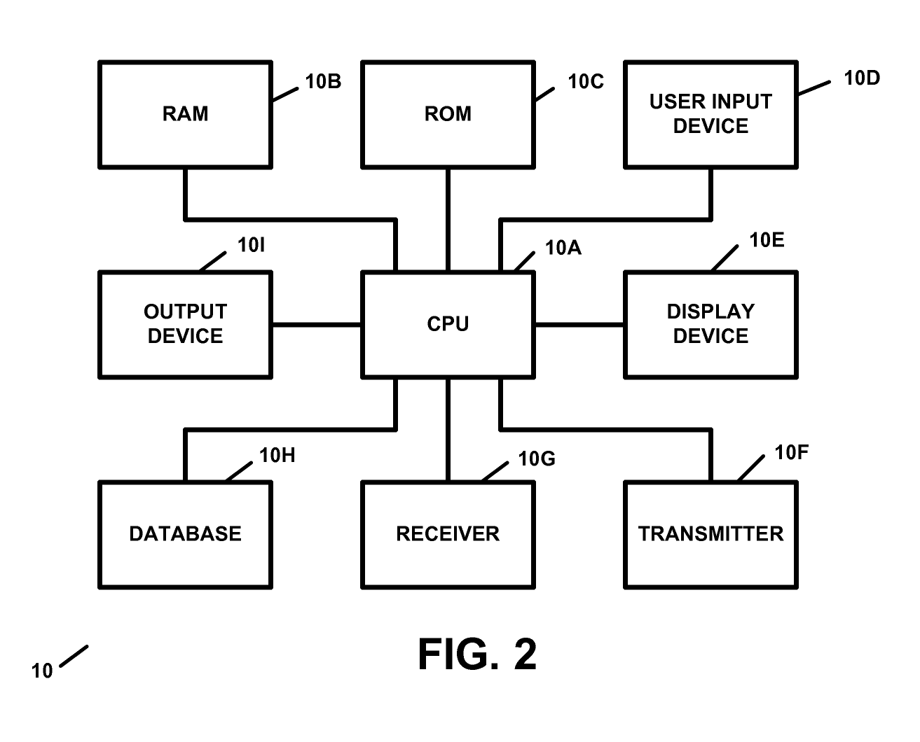

FIG. 2 illustrates the central processing computer 10, in block diagram form. The central processing computer 10, in the preferred embodiment, is a network computer or computer system, or any other communication device which can provide the functionality of, and which can be utilized as a central processing computer 10 such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering healthcare data and/or information, for example pulse rate monitors, blood pressure monitors, electrocardiograms, blood-sugars monitors, etc., if desired, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computer(s) 10, the provider communication device(s) 20, the payer computers(s) 30, the user communication device(s) 40, and the intermediary computer(s) 50, the healthcare records computer(s) 60, the insurance exchange computer(s) 70, the social networking computer(s) 80, and the media computer(s) 90, or any other individual computer(s), which may be utilized in conjunction with the present invention. The central processing computer 10 also includes a receiver 10G, for receiving signals and/or data and/or information from any one or more of the central processing computer(s) 10, the provider communication device(s) 20, the payer computers(s) 30, the user communication device (s) 40, and the intermediary computer(s) 50, the healthcare records computer(s) 60, the insurance exchange computer(s) 70, the social networking computer(s) 80, and the media computer(s) 90, which may be utilized in conjunction with the present invention.

The central processing computer 10 also includes a database(s) 10H which contains data and/or information pertaining to the individuals, patients, providers, payers, and intermediaries, who or which are serviced by the apparatus 100 of the present invention and/or who or which utilize the apparatus 100 of the present invention.

The database 10H can contain any one or any number of electronic healthcare records (EHRs), which electronic healthcare records definition includes electronic healthcare records or files, electronic medical records or files (EMRs), electronic dental records or files (EDRs), electronic pharmacy records or files (EPRs), electronic behavioral health records or files (EBHRs), as well as any personal health records or files (PHRs). The database 10H can also contain any links or hyperlinks to any of the above electronic healthcare records or files, electronic medical records or files, electronic dental records or files, electronic pharmacy records or files, electronic behavioral health records or files, and/or personal health records or files, which may be located or stored on any computer or computers external from the central processing computer 10, for any number of users, individuals, or patients.

Each of the herein-described electronic healthcare records, electronic medical records, electronic dental records, electronic pharmacy records, and/or electronic behavioral health records can also contain a personal health record portion. The apparatus 100 and method of the present invention can store a personal health record for each individual or patient. The personal health record can be stored in each individual's or patient's respective electronic healthcare record(s), electronic medical record(s), electronic dental record(s), electronic pharmacy record(s), and/or electronic behavioral health record(s), as well as in any user communication device 40. The personal healthcare record can be updated as described herein or in any other appropriate manner.

The database 10H can also contain a look-up table or look-up tables and/or data and/or information relating thereto, for identifying and locating a respective electronic healthcare record(s), an electronic medical record, an electronic dental records, an electronic pharmacy record, an electronic behavioral health record, or a personal health records, for or associated with any user, individual, patient, or person who may utilize the apparatus 100 of the present invention. In this regard, the database 10H can store any healthcare data and/or information or healthcare-related data and/or information for any user, individual, patient, or person who may utilize the apparatus 100 of the present invention, whether that information is stored in the central processing computer 10, the database 10H, or any provider communication device(s) 20, payer communication device(s) 30, user communication device(s) 40, intermediary communication device(s) 50, healthcare records computer(s) 60, insurance exchange computer(s) 70, social networking computer(s) 80, and/or media computer(s) 90, regardless of where these computers or communication devices are located and regardless of what data and/or information is stored on same.

In the preferred embodiment, the database 10H contain data and/or information for locating, retrieving, storing, or providing a comprehensive healthcare record of healthcare file for any individual, user, patient, or person. The database 10H can also contain any necessary data or information for locating, identifying, retrieving, storing, any information from any of the various types of kinds of electronic healthcare records or files regarding of the type, kind, and/or vendor or supplier of same, regardless of where these electronic healthcare records or files are located or stored. In a preferred embodiment, the database 10H can also contain an index or other information for identifying data fields in the respective databases of the various respective electronic healthcare records for enabling the central processing computer 10 to identify data and/or information in each of the respective electronic healthcare records or files.

The database 10H can also contain any data and/or information for allowing any herein-described user, individual, patient, person, provider, payer, intermediary, or entity, to access or obtain any of the herein-described data and/or information, wherever such data and/or information is located or stored, as well as to perform any function described herein as being capable of being performed by the apparatus 100 of the present invention.

The database 10H can also contain any data and/or information for integrating, linking to or with, and/or accessing data and/or information stored or located in, any number, type, or kind, of any of the herein-described electronic healthcare records or files, electronic medical records or files, electronic dental records or files, electronic pharmacy records or files, electronic behavioral health records or files, as well as any personal health records or files.

The database 10H can contain any of the herein-described data and/or information for any number of individuals, users, patients, or persons. The database 10H can also contain data and/or information regarding a name, relationship, and authorization for any parent, relative, legal guardian, caregiver, healthcare proxy holder, or any person, individual, or entity, who or which may be responsible for caring for, accessing, updating, or maintaining healthcare records or files for, making decisions for, or making healthcare-related decisions for, taking actions for, providing care for, or performing any task or activity for, any other individual(s), user(s), patient(s), or person(s). For example, the database 10H can, for a child, contain information regarding the child's parent or legal guardian, and/or the database 10H, for an elderly person or any other person, can contain information regarding the person's child, caregiver, healthcare proxy holder, or any other authorized person or entity, or for individuals who belong to a school or club's athletic program, or a sports team, a club, a social or other organization, the database 10H can contain information regarding a coach, team doctor, trainer or other authorized individual.

The database 10H can contain any and/or all of the information needed and/or required in order to perform any and/or all of the functions, services and/or operations described herein as being performed by the central processing computer 10 or the apparatus 100 of the present invention. In this regard the database 10H can contain data and/or information regarding individual or patient name, individual or patient identification information, individual or patient social security number or other identification information, date of birth, sex, gender, race, nationality, ethnicity, spoken language, preferred language, other languages, religion or religious affiliation, next-of-kin, relatives, emergency contact person, doctors or providers, therapists, nutritionists, insurance or payer information, group insurance information, group health insurance information, life insurance information, disability insurance information, patient address, phone number, e-mail and/or other contact information, medical history, psychological history, dental history, family history, family medical, psychological, and/or dental history, past and/or current or active symptoms, past and/or current or active diagnoses, past and/or current or active treatments or treatment plans, care management plan or plans, allergies, active or current medications or prescription drugs, active or current medication allergies, past, active, or current allergies, smoking status, insurance coverage, insurance co-payment and/or deductible information, co-payment information regarding any payer or insurer insurance policy or payment plan, deductible information regarding any payer or insurer insurance policy or payment plan, benefit eligibility information, insurance information, insurance claim procedures, insurance claim forms, doctor or provider appointment schedules, past treatments, past diagnosis, symptoms, insurance claim forms, employer information, lifestyle information, treatment plans, treatment progress, broker/agent/intermediary information, education information, age, sex, marital status, employee benefits information, types or services and/or treatments needed, and any other data and/or information regarding the patient which would be needed and/or desired in order to perform any and/or all of the functions, services and/or operations described herein.

The database 10H can also include, for each individual or patient, any genetic information or genetic-related information obtained from, or obtained from any testing or analysis of, any DNA, RNA, chromosomes, genes, plasmids, or any other genetic material, or any proteins or enzymes which are or which may be produced, created, formed, synthesized, or generated, by the DNA, RNA, or any other genetic material, or any material containing heritable biological information, of the individual or the patient. The database 10H can also contain or include, for each item of genetic information or genetic-related information, the genetic material from which it was obtained, such as, for example, but not limited to, DNA, RNA, chromosomes, genes, plasmids, or any other genetic material, or any material containing heritable biological information, or any proteins or enzymes which are or which may be produced, created, formed, synthesized, or generated, by the DNA, RNA, or any other genetic material, or any material containing heritable biological information, the date and/or time same was obtained, the genetic material from which it was obtained, the place where same was obtained, or the provider who or which ordered the genetic information or genetic-related information testing or analysis, and/or the laboratory or service which performed any testing or analysis related to or regarding the genetic information or the genetic-related information or the laboratory or service which performed any testing or analysis of the genetic material from which the genetic information or the genetic-related information was obtained, and/or the time and/or date same was entered into the database 10H.

The database 10H can also include, for each individual or patient, any genetic information or genetic-related information obtained from, or obtained from any testing or analysis of, any DNA, RNA, chromosomes, genes, plasmids, or any other genetic material, or any proteins or enzymes which are or which may be produced, created, formed, synthesized, or generated, by the DNA, RNA, or any other genetic material, or any material containing heritable biological information, of the individual's or the patient's family member(s), parent(s), sibling(s), child or children, or any person(s) having a blood relationship or bloodline relationship with the individual, or of the individual or the patient. The database 10H can also contain or include, for each item of genetic information or genetic-related information of the individual's or the patient's family member(s), parent(s), sibling(s), child or children, or any person(s) having a blood relationship or bloodline relationship with the individual, the genetic material from which it was obtained, such as, for example, but not limited to, DNA, RNA, chromosomes, genes, plasmids, or any other genetic material, or any material containing heritable biological information, or any proteins or enzymes which are or which may be produced, created, formed, synthesized, or generated, by the DNA, RNA, or any other genetic material, or any material containing heritable biological information, the date and/or time same was obtained, the genetic material from which it was obtained, the place where same was obtained, or the provider who or which ordered the genetic information or genetic-related information testing or analysis, and/or the laboratory or service which performed any testing or analysis related to or regarding the genetic information or the genetic-related information or the laboratory or service which performed any testing or analysis of the genetic material from which the genetic information or the genetic-related information was obtained, and/or the time and/or date same was entered into the database 10H.

The database 10H can also contain or include, or each item or entity of genetic information or genetic-related information stored in same, a digital representation of same, a digital version of same, a digitized version of same, or digital data and/or information representing same, and any picture(s), photograph(s), or video information of, any audio information of, or any other written, visual, or oral, data and/or information of, or notes or comments of, or regarding same. In a preferred embodiment, any genetic information or genetic-related information can be stored in digital form and/or stored as a digital representation of same. Further, in a preferred embodiment, any picture(s), photograph(s), or video information of, any audio information of, or any other written, visual, or oral, data and/or information of, or any notes or comments of or regarding, any of the genetic information or genetic-related information described herein can also be stored in digital form and/or can be stored as a digital representation of same.

The database 10H can also contain any software, programs, applications, or algorithms, needed or desired for performing any of the herein-described genetic information or genetic-related information processing routines, or genetic information or genetic-related information analysis routines, or any diagnostic routines, diagnostic processing routines, diagnostic report generation routines, treatment planning routines, treatment report processing routines, treatment report generation routines, treatment plan processing routines, treatment plan generation routines, genetic profile report or plan processing routines, genetic profile report or plan generation routines, initial or baseline genetic profile diagnostic report processing routines and/or generation routines, initial or baseline genetic profile treatment report or plan processing routines and/or generation routines, genetic profile diagnostic reports processing routines and/or generation routines, or genetic profile treatment report or plan processing routines and/or generation routines, or any processing routines or generation routines for or regarding any final diagnosis or prescribed treatment plan, or any other reports, messages, or plans, described as being performed by the central processing computer 10, and/or by the apparatus 100 and method of the present invention.

The database 10H can also contain any software, programs, applications, or algorithms, needed or desired for performing any processing of information regarding the individual or the patient, including, but not limited to, the individual's or the patient's symptoms, examination findings, or observations, in conjunction with data and/or information contained in the individual's or the patient's genetic information or genetic-related information. The database 10H can also contain any software, programs, applications, or algorithms, needed or desired for performing any processing of information regarding the individual or the patient, including, but not limited to, the individual's or the patient's symptoms, examination findings, or observations, in conjunction with data and/or information contained in the individual's or the patient's genetic information or genetic-related information with or using any healthcare or medical information, theories, principles, criteria, and/or any other healthcare information or medical information needed to make a diagnosis.

The database 10H can also contain any software, programs, applications, or algorithms, needed or desired for performing any processing of information regarding the individual or the patient, including, but not limited to, the individual's or the patient's symptoms, examination findings, or observations, in conjunction with data and/or information contained in the individual's or the patient's genetic information or genetic-related information with or using any healthcare or medical information, theories, principles, criteria, and/or any other healthcare information or medical information needed to make a diagnosis and/or in conjunction with the genetic information or genetic-related information of or regarding the individual's or the patient's family member(s), parent(s), sibling(s), child or children, or any person(s) having a blood relationship or bloodline relationship with the individual.

The database 10H can also contain any software, programs, applications, or algorithms, needed or desired for performing any processing of any diagnostic evaluation of the individual or the patient, using the genetic information or genetic-related information obtained from the individual's or the patient's DNA or any other herein-identified or herein-described genetic information or genetic material of or obtained from the individual or the patient, in order to ascertain the presence or the absence of a variation(s) or mutation(s), or any carrier status, in, on, or regarding, the individual's or the patient's DNA or other herein-identified or herein-described genetic information or genetic material.

The database 10H can also contain any software, programs, applications, or algorithms, needed or desired for performing any processing of any diagnostic evaluation of the individual or the patient using the genetic information or the genetic-related information obtained from the DNA or any other herein-identified or herein-described genetic information or genetic material of or obtained from, the individual's or the patient's family member(s), parent(s), sibling(s), child or children, or any person(s) having a blood relationship or bloodline relationship with the individual or the patient, in order to also ascertain the presence or the absence of a variation(s) or mutation(s), or any carrier status, in, on, or regarding, the individual's or the patient's DNA or other herein-identified or herein-described genetic information or genetic material.

The database 10H can also contain any software, programs, applications, or algorithms, needed or desired, for performing any processing of any of the individual's or the patient's genetic information or genetic-related information obtained from the individual's or the patient's DNA or other herein-identified or herein-described genetic information or genetic material, in order to ascertain the presence or the absence of any gene, genes, or genetic marker(s) or indicator(s), or any variation(s) or mutation(s) of same, or any carrier status, in or regarding, the individual's or the patient's DNA or other herein-identified or herein-described genetic information or genetic material.

The database 10H can also contain any software, programs, applications, or algorithms, needed or desired, for performing any processing of any DNA, or any other herein-identified or herein-described genetic information or genetic material of or obtained from, the individual's or the patient's family member(s), parent(s), sibling(s), child or children, or any person(s) having a blood relationship or bloodline relationship with the individual or the patient, in order to ascertain the presence or the absence of any gene, genes, or genetic marker(s) or indicator(s), or any variation(s) or mutation(s) of same, or any carrier status, in or regarding, the individual's or the patient's DNA or other herein-identified or herein-described genetic information or genetic material.

The database 10H can also contain any software, programs, applications, or algorithms, needed or desired, for performing any processing of any of the individual's or the patient's genetic information or genetic-related information obtained from the individual's or the patient's DNA or other herein-identified or herein-described genetic information or genetic material, in order to ascertain the presence or the absence of a gene or genes, or genetic marker(s) or indicator(s), which presence or absence is or may be medically or scientifically believed to cause, to be the cause of, or to be associated with, a disease, a disorder, a condition, a sickness, a syndrome, or a cancer, and/or to ascertain the presence or the absence of a gene or genes, or genetic marker(s) or indicator(s), which can or may be associated with a statistical or a statistically increased probability or risk of developing or getting a disease, a disorder, a condition, a sickness, a syndrome, or a cancer.

The database 10H can also contain any software, programs, applications, or algorithms, needed or desired, for performing any processing of any DNA, or any other herein-identified or herein-described genetic information or genetic material of or obtained from, the individual's or the patient's family member(s), parent(s), sibling(s), child or children, or any person(s) having a blood relationship or bloodline relationship with the individual or the patient, in order to ascertain the presence or the absence of a gene or genes, or genetic marker(s) or indicator(s), which presence or absence is or may be medically or scientifically believed to cause, to be the cause of, or to be associated with, a disease, a disorder, a condition, a sickness, a syndrome, or a cancer, and/or to ascertain the presence or the absence of a gene or genes, or genetic marker(s) or indicators(s), which can or which may be associated with a statistical or a statistically increased probability or risk of developing or getting a disease, a disorder, a condition, a sickness, a syndrome, or a cancer.

The database 10H can also contain any software, programs, applications, or algorithms, needed or desired, for performing any processing information regarding and/or for ascertaining, for each occurrence of a detected presence or absence of the gene, genes, or genetic marker(s) or indicator(s), in the individual's or the patient's genetic information or genetic-related information, or the individual's or the patient's DNA or other herein-identified or herein-described genetic information or genetic material, any corresponding disease(s), disorder(s), condition(s), sickness(es), syndrome(s), or cancer(s), and any symptoms, conditions, or any other information, associated with same.

The database 10H can also contain any software, programs, applications, or algorithms, needed or desired, for performing any processing information regarding and/or for ascertaining, for each occurrence of a detected presence or absence of the gene, genes, or genetic marker(s) or indicator(s), in the genetic information or genetic-related information, or the DNA or other herein-identified or herein-described genetic information or genetic material, of the individual's or the patient's family member(s), parent(s), sibling(s), child or children, or any person(s) having a blood relationship or bloodline relationship with the individual or the patient, any corresponding disease(s), disorder(s), condition(s), sickness(es), syndrome(s), or cancer(s), and any symptoms, conditions, or any other information, associated with same.

The database 10H can also contain any software, programs, applications, or algorithms, needed or desired, for detecting, identifying, or ascertaining, any genetic abnormalities present in the individual's or the patient's genetic information or genetic-related information, DNA, or other herein-identified or herein-described genetic information or genetic material, and for processing information regarding same so as to compare any disease(s), disorder(s), condition(s), sickness(es), syndrome(s), or cancer(s), associated with same, and any symptoms, conditions, or any other information, associated with same, with or against any of the individual's or the patient's symptoms and/or examination findings and/or any observations.

The database 10H can also contain any software, programs, applications, or algorithms, needed or desired, for detecting, identifying, or ascertaining, any genetic abnormalities present in the genetic information or genetic-related information, DNA, or other herein-identified or herein-described genetic information or genetic material, of the individual's or the patient's family member(s), parent(s), sibling(s), child or children, or any person(s) having a blood relationship or bloodline relationship with the individual or the patient, and for processing information regarding same so as to compare any disease(s), disorder(s), condition(s), sickness(es), syndrome(s), or cancer(s), associated with same, and any symptoms, conditions, or any other information, associated with same, with or against any of the individual's or the patient's symptoms and/or examination findings and/or any observations.

The database 10H can also contain any software, programs, applications, or algorithms, needed or desired, for generating any of the herein-described genetic profile reports or data files and/or for processing any information contain in same in conjunction with an individual's or a patient's symptoms and/or examination findings or observations in order to ascertain if the symptoms and/or examination findings or observations match or coincide with, any of the symptoms, conditions, or any other information, associated with a detected disease, disorder, condition, sickness, syndrome, or cancer.

The database 10H can also contain any software, programs, applications, or algorithms, needed or desired, for generating any of the herein-described genetic profile reports or plans, diagnostic reports, treatment reports, treatment plans, final diagnoses, prescribed treatment plans, initial or baseline genetic profile diagnostic reports, initial or baseline genetic profile treatment reports or plans, genetic profile diagnostic reports, genetic profile treatment reports or plans, or any other reports, messages, or plans, described herein as being generated by the apparatus 100 or the central processing computer 10.

The database 10H can also contain, for each individual or patient serviced by the apparatus 100 of the present invention, any and/or all genetic profile reports or plans, diagnostic reports, treatment reports, treatment plans, final diagnoses, prescribed treatment plans, initial or baseline genetic profile diagnostic reports, initial or baseline genetic profile treatment reports or plans, genetic profile diagnostic reports, genetic profile treatment reports or plans, or any other reports, messages, or plans, of, associated with, regarding, or prepared for, the individual or the patient.

The database 10H can also contain any and/or all data and/or information, and/or any software, programs, applications, or algorithms, for designing a treatment plan and/or for determining and estimated cost of implementing a treatment plan. The database 10 can also include information regarding and/or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for a treatment plan along with the costs or prices of each and the total cost or price of the treatment or treatment plan.

The database 10H can also contain, for each of the herein-described healthcare providers or providers who or which utilize the apparatus 100 and method of the present invention, for each city or locale of each and every country where a healthcare provider or provider is located, the respective costs or prices of each healthcare provider's or provider's respective services, products, goods, drugs or medications, and/or the costs or prices of the respective doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for a treatment plan.

The database 10H can also contain estimated costs for treatment or treatment plans for any number of cities, municipalities, political sub-divisions, or locales, for any number of countries.

The database 10H can also contain any and/or all data and/or information, and/or any software, programs, applications, or algorithms, for performing treatment cost planning, cost analysis, cost containment, and/or cost optimization.

The database 10H can also contain any and/or all data and/or information, and/or any software, programs, applications, or algorithms, for being programmed to automatically generate and/or transmit to a respective communication device of or associated with the individual, the patient, or a caregiver of same, and/or to any of the providers, insurers, or intermediaries, involved in a prescribed treatment plan, any and/or all applicable appointment scheduling and/or reminder messages, testing scheduling and/or reminder messages, procedure scheduling and/or reminder messages, surgical or other treatment administration scheduling and/or reminder messages, therapy scheduling and/or reminder messages, prescriptions for drugs or mediations and/or for testing and/or genetic testing, scheduling and/or reminder messages, prescription refill or reorder scheduling and/or reminder messages, messages reminding the individual or the patient to take a drug or medication at a scheduled time interval, and/or follow-up office visit or doctor visit reminder messages, and/or any other message(s), alert message(s), or reminder message(s), deemed needed or desired for ensuring that the prescribed treatment plan is followed.

The database 10H can also contain any and/or all data and/or information, and/or any software, programs, applications, or algorithms, for automatically generating an insurance claim or a claim for payment on behalf of an individual or patient and for automatically transmitting same or submitting same to a computer or communication device of, associated with, or used by, an insurer or payer of the individual or the patient.

The database 10H can also contain, for each individual or patient serviced by the apparatus 100 of the present invention, any and/or all wellness reports, exercise reports, fitness reports, nutritional reports, diets, diet reports, rehabilitation reports, therapy reports, and/or any other reports, which are generate or prepared for the individual or the patient.

The database 10H can also contain provider office visit summaries, hospital discharge summaries, hospital discharge instructions, and/or any examination, treatment, testing, or procedure, summary, and any instructions, treatment plan or instructions, care management plan or instructions, or any other information which can be provided to any individual, patient, provider, payer, insurer, third party or intermediary, or caregiver, described herein as using the apparatus 100 and method of the present invention, or described herein as being able to receive services, provide services, or otherwise use or be serviced by, the apparatus 100 and method of the present invention.

In the case of deceased patients or individuals, the database 10H can contain information regarding date of death, place of death, preliminary cause of death, and/or final determination of cause of death. The database 10H can also contain information regarding any other information regarding a deceased patient or individual and can also contain information regarding final resting place.

The database 10H can also contain, for each individual or patient, information regarding dates of appointments or services with or from healthcare providers or other providers, dates of laboratory tests, dates of treatments, dates of genetic information testing or analysis and/or laboratory or entity performing same, operations, or procedures, dates of doctor visits, therapy sessions, vital signs, healthcare chart changes, or information regarding height, weight, blood pressure, heart rate, pulse rate, body-mass index, growth charts, and/or any other related or pertinent data or information.

The database(s) 10H can also contain healthcare and/or medical video, image, and/or audio, and/or text, data and/or information, and/or surgical video, image, and/or audio, and/or text, data and/or information, and/or dental video, image, and/or audio, and/or text, data and/or information, such as, for example, x-rays, Magnetic Resonant Images (MRI), CAT scans, digital x-ray files, digital Magnetic Resonant Imaging (MRI) files, digital CAT scan files, and/or any other video, imaging, and/or audio, healthcare data and/or information which can be utilized by healthcare providers, payers, intermediaries, patients, and/or other users of the present invention. In this manner, the present invention can facilitate the availability of any of the above-described video, image, and/or audio, data and/or information in a network environment. For example, a medical specialist can have access to, and/or review, an MRI or a CAT scan for a patient, from any location and at any time.

The database 10H can also contain data and/or information regarding providers including provider name, provider social security number or identification number, type of professional or service provider, address, phone number, fax number, e-mail and/or other contact information, experience, specialties, insurances accepted, schedule of charges, financial account identification information, resume information, education, work experience, claim forms, appointment schedules, procedures performed, and/or any other data and/or information concerning the providers for providing any and/or all of the functions, services, and/or operations described herein as being performed by the present invention.

The database 10H can also contain data and/or information regarding all possible fields of medicine, surgery, psychiatry, psychology, dentistry, oral surgery, optometry, podiatry, physical therapy, respiratory therapy, hypnosis, osteopathy, nutrition, wellness, and/or any other possible healthcare fields and/or subject matter which can possibly by utilized in the processing and/or operation of the present invention.

The database 10H can also contain information on illnesses, symptoms, diseases and/or sicknesses, theories, scientific theories, research data and/or information, diagnosis information, treatment information, treatment plans, treatment processes, treatment progresses, treatment interactions, side effects, expected treatment results, treatment providers, treatment durations, treatment costs, pre-treatment information, post-treatment information, treatment monitoring information, statistical information regarding diagnoses, treatments, treatment success rates, treatment failure rates, treatment centers, therapy plans, therapy success rates, therapy failure rates, treatment procedures, medications treatments, non-medication treatments, healthcare institutions, treatment evaluating criteria, treatment mistakes and/or mishaps, indicators of mistakes and/or mishaps, corrective actions, links to providers, links to treatment centers or institutions, reimbursement rates, nutrition information, diet information, exercise information, exercise routines, treatment options, healthcare advise, wellness advice, preventive care, preventive procedure, health maintenance, drug and medication information, drug interaction information, video information, including video files or clips and other information, regarding illnesses, diseases, treatments and follow-up care, audio information, including audio files or clips and other information, regarding illnesses, diseases, treatments and follow-up care, treatment and/or procedure information and/or narratives, treatment analysis, diagnosis analysis, diagnosis monitoring, diagnosis confirmation and/or checking, and/or other information for providing the herein-described functions, services, and/or operations.

The database 10H can also contain information regarding the insurance companies and payers described herein, including, but not limited to, payer name, address, phone number, fax number, e-mail address, identification number(s), coverage types, policies and/or coverages provided, reimbursement rates, patients and/or providers serviced and/or covered by the payer, policy information, claim forms, claim procedures, claim status, claim processing information, claim submission procedures and policies, reasonable and customary charges, co-payment information, pre-approval information and/or procedures, claim form information, electronic form claim forms, insurance and/or coverage requirements, guidelines, and/or triggering events, covered procedures and/or treatments, uncovered procedures and/or treatments, claim approval information, claim approval history, claim approval statistics, claim rejection or denial information, claim rejection or denial history, claim rejection or denial statistics, financial account information, network provider information, network patient information, claim statistics, preventative care and/or benefits information, benefits information, benefits request information and/or claim forms, claim submission information, claim processing information, claim status information, payment information and statistics, and/or any other data and/or information regarding and/or related to payers which are needed and/or desired for providing any and/or all of the functions, services, and/or operations described herein.

The database 10H can also contain data and/or information regarding the brokers, agents and/or intermediaries described herein, including, but not limited to, intermediary name, address, phone number, fax number, e-mail address, clients, client's or patient's services, insurance policies, policy information, policy quote information, policy proposal information, any and/or all of the above information described herein regarding patients, providers, payers, etc. which may be of interest to the intermediaries described herein which may be useful and/or beneficial to the intermediaries in providing any of the functions, services, and/or operation described herein.

The database 10H can also contain contact information such as phone numbers, fax numbers, pager numbers, beeper numbers, e-mail addresses, hyperlinks to, and/or any other information which can facilitate contact between any of the parties described herein. The database 10H also includes electronic signature data and/or information for any of the parties, patients, providers, payers, and/or intermediaries, described herein for facilitating transactions, claim submissions, financial transactions, etc., by and/or between any of the above patients, providers, payers, and/or intermediaries.

The database 10H can also contain and notes, comments, or messages, which can be provided by any user, individual, patient, caregiver, provider, insurer, payer, third party, intermediary, or any other person or entity who or which utilizes the apparatus 100 and method of the present invention.

The database 10H can also contain any number of electronic healthcare records, electronic medical records, electronic dental records, electronic pharmacy records, electronic behavioral health records, and/or links to other electronic healthcare records, electronic medical records, electronic dental records, electronic pharmacy records, electronic behavioral health records which might be located in healthcare records computers 60 or other computers or computer systems located remote from the central processing computer 10. Any and/or all of these electronic healthcare records, electronic medical records, electronic dental records, electronic pharmacy records, electronic behavioral health records can contain data and/or information and/or link or hyperlinks to data and/or information regarding any individuals, patients, his or her caregivers, children, parent, relatives, friends, social networking friends, connections, of followers, providers, insurers or payers. The databases 10H can also contain any and/or all information regarding the data and/or information fields in each electronic healthcare record, electronic medical record, electronic dental record, electronic pharmacy record, and/or electronic behavioral health record, information for mapping common or like data fields for each and information or links or hyperlinks for accessing like data or like information fields in each of the different electronic healthcare records, electronic medical records, electronic dental records, electronic pharmacy records, electronic behavioral health records.

The data and/or information in the database 10H can also include links to any other information, information sources, news sources, and/or other information and/or data which can or may be utilized by the present invention and/or by any of the patients, providers, payers, intermediaries and/or any other users of the present invention.

The database 10H can also contain data and/or information regarding healthcare news, healthcare developments, healthcare discoveries, etc., for and including the medical field, surgical field, psychological field, dental field, nutrition field, fitness field, etc., and/or any other healthcare field or fields.

The database 10H, in the preferred embodiment, can also contain video and/or audio files which can be utilized for training of healthcare professionals as well as for providing general information to any user of the present invention. In this manner, and as will be described hereinbelow, the apparatus 100 can be utilized as a simulator for providing training in medical diagnosing, medical training, surgical training, psychiatric training, psychological training, dental training, oral surgery training, therapist training, and/or for training any of the healthcare providers described herein and/or envisioned.

For example, the present invention can be utilized to provide a medical doctor with a set of symptoms, evaluate the diagnosis and treatment prescribed and provide follow-up patient conditions which may or may not call for the medical doctor to re-evaluate his or her diagnosis and/or treatment. In a similar fashion, the present invention can be used for training and continuing education and training for any of the healthcare providers described herein and/or otherwise envisioned utilizing the present invention.

The database 10H can also contain data and/or information restricting access by any of the providers, payers, patients, intermediaries, and/or other users, to any of the data and/or information stored in the database 10H.

The database 10H can also contain information correlating symptoms and/or conditions with diagnoses, prognoses, and/or treatments, treatment methods, and/or procedures. The database 10H also contains any and/or all information needed and/or desired for facilitating the processing of symptoms, conditions, medical histories, family histories, and other information, in order to arrive at diagnoses and/or prognoses, treatments, prescriptions, procedures, and/or any other healthcare and/or healthcare-related information.

The database 10H can also contain information regarding medical records, medical charts, x-rays, MRIs, and/or any other information, described herein and/or otherwise, which can be associated with an individual's or patient's medical history, medical record, or medical file, for any individual or patient who utilizes the apparatus 100 and method of the present invention.

The database 10H can also contain information regarding surgical records, surgical charts, x-rays, MRIs, and/or any other information, described herein and/or otherwise, which can be associated with an individual's or patient's surgical history, surgical record, or surgical file, for any individual or patient who utilizes the apparatus 100 and method of the present invention.

The database 10H can also contain information regarding dental records, dental charts, x-rays, and/or any other information, described herein and/or otherwise, which can be associated with an individual's or patient's dental history, dental record, or dental file, for any individual or patient who utilizes the apparatus 100 and method of the present invention.

The database 10H can also contain information regarding a prescription drug record, file, or account, for an individual or patient for any individual or patient who utilizes the apparatus 100 and method of the present invention.

The database 10H can also contain information regarding a healthcare spending account or healthcare spending accounts for any individual or patient, or for any of the individuals or patients, described herein or otherwise, who utilize the apparatus 100 and method of the present invention. For example, the healthcare spending account is or can be an account which can be a deposit account, a credit account, a debit account, an electronic money or an electronic cash account, or any combination of same, which can be held by any individual, patient, employer, bank, credit union, financial institution, investment institution, healthcare insurer, healthcare payer, or any other third party, and which can be used as a source of funds for payment for any type of healthcare service or healthcare product which is provided to, or administered to, or sought by, any individual or patient who utilizes the apparatus 100 and method of the present invention. In a preferred embodiment, the healthcare spending account can be used by the individual or patient to pay for any healthcare service, treatment, procedure, or product, at any time a payment is desired to be made for same.

The database 10H can also contain, for each individual or patient who utilizes the apparatus 100 and method of the present invention, information regarding, or a record of, each and every instance of a provider office visit involving the individual or patient, a communication(s) with a provider or providers involving or regarding the individual or patient, a payment(s) made by or on behalf of the individual or patient, an insurance claim(s) made by a provider or providers on a healthcare insurance policy or account for or regarding the individual or patient, including information regarding date of claim, time of claim, or the provider making the claim, a co-payment(s) made by or on behalf of the individual or patient, a payment(s) made on an insurance claim, a denial(s) of an insurance claim or insurance claims, or a resolution(s) of an insurance claim or insurance claims. The database 10H can also contain information regarding a history or record of insurance claims made by a provider or providers, or made by an individual or patient, for each individual or patient who utilizes the apparatus 100 and method of the present invention.

The database 10H can also contain credit report data or information, a credit report, credit reports, or a credit history, for any individual or patient, or for any of the individuals or patients, described herein or otherwise, who utilize the apparatus 100 and method of the present invention. The credit report or credit reports, or credit history, can contain any of the information which is typically provided by, or which may be provided by, any commercial or other credit reporting company or agency, such as, for example, but not limited to, credit reporting companies such as TransUnion LLC, Experian Information Solutions, Inc., Equifax, Inc., or any other credit reporting company, agency, or bureau, or any credit card company or financial institution. The database 10H can also contain any data or information which is typically found in a credit report database or credit history database, and/or any data and/or information which is, or which can be, utilized in generating, and/or analyzing, a credit report or credit reports, or a credit history, for, or on behalf of, any individual or patient, or for any of the individuals or patients, described herein or otherwise, who utilize the apparatus 100 and method of the present invention. The database 10H can also contain e-mail contact information, telephone contact information, cellular telephone contact information, and/or any other suitable contact information, for an individual or patient which can be utilized to notify the individual or patient when information regarding his or her credit report or credit reports, or credit history, is accessed, obtained, changed, or when a new entry of information is made in same.

The database 10H can also include advertisements, advertisement materials and information, marketing materials or information, commercials, video clips, infomercials, and any other information, which can include text information. video information, audio information, or any combination of same, which can be used to provide an advertisement, or advertisement material or information, to or for any individual, patient, provider, healthcare provider, payer, healthcare payer, insurer, healthcare insurer, product provider, service provider, third party provider, or any other person or entity, who or which utilizes the apparatus 100 and method of the present invention. A respective advertisement, advertisement material and information, marketing material or information, commercial, video clips, infomercials, and/or any other information, can be used to advertise or market any product(s) or service(s) which can be used by, provided to, provided by, advertised to, advertised by, marketed to, or marketed by, any individual, patient, provider, healthcare provider, payer, healthcare payer, insurer, healthcare insurer, product provider, service provider, third party provider, or any other person or entity, who or which utilizes the apparatus 100 and method of the present invention.

The database 10H can also contain news information, news reports, published reports, theses, study reports, or any other data or information regarding health issues, healthcare issues, health conditions, diseases, treatments, drugs, medications, healthcare procedures, medical procedures, surgical procedures, dental procedures, prescription products or services, non-prescription products or services, over-the-counter products or services, health or wellness issues or recommendations, exercise issues or recommendations, alternate therapy or treatment types or recommendations, herbal therapies or recommendations, or any other data or information which can be used by or provided to any individual, patient, provider, healthcare provider, payer, healthcare payer, insurer, healthcare insurer, product provider, service provider, third party provider, or any other person or entity, who or which utilizes the apparatus 100 and method of the present invention. The news information, news reports, published reports, theses, study reports, or any other data or information can include text information, video information, audio information, or any combination of same.

The news information, news reports, published reports, theses, study reports, or any other data or information, stored in the database 10H, can be transmitted to, or fed to, the central processing computer 10, for storage in the database 10H, by or from any appropriate computer or communication device, which is associated with or used by any news source, news organization, research institution, research professional, healthcare facility, an author, researcher, academician, or any other individual, person, or entity. An intermediary communication device 50 can also be utilized to transmit the news information, news reports, published reports, theses, study reports, or any other data or information to the central processing computer 10.

The database 10H can also contain prescription drugs information, prescription medication information, over-the-counter drug or medication information, wellness information, exercise and fitness information, and/or any other information pertinent to an individual's or a patient's heath, well-being, or treatment.

The database 10H can also include language translation information or software so that any of the data or information described herein as being stored in the database 10H, or as being provided in any of the messages, reports, or other communications, described herein can be translated into any language.

The database 10H can also contain, for each individual, patient, provider, and/or insurer or payer who or which utilize the apparatus 100, data and/or information regarding charges made to an individual or patient, charges made by a provider, charges made by an insurer or payer, amounts paid to an individual or patient, amounts paid by an individual or patient to a provider, amounts paid by an insurer or payer to a provider, amounts paid by an insurer or patient to an individual or patient, amounts paid by an individual or patient to an insurer or payer, a charges-back(s) made regarding a payment to, for, or by, a provider, a charge-back(s) made regarding a payment to, for, or by, an individual or patient, and/or a charge-back(s) made regarding a payment to, for, or by, an insurer.

The database 10H can also contain any notes, comments, or messages, which can be provided in text, in audio recordings or audio clips, and/or in video recordings or video clips. The database 10H can also contain any data, information, and/or software programs for translating audio information to text information and for translating test information to audio information. The database 10H can also contain any data, information, and/or software programs for translating text information or audio information from one language to another so as to provide a multi-lingual healthcare information and records keeping system. The database 10H can also contain any notes, comments, or messages, which can be provided by any of the herein-described users, individuals, patients, providers, insurers, payers, third parties, intermediaries, and/or any other person or entity who or which utilizes the apparatus 100 and method of the present invention.

The database 10H can also contain any notes, comments, or messages, which can be stored in any and/or all of the electronic healthcare records or files, electronic medical records or files, electronic dental records or files, electronic pharmacy records or files, electronic behavioral health records or files, and/or personal health records or files, described herein as being utilized in connection with the apparatus 100 and method of the present invention. In this regard, it is important to note that, in a preferred embodiment of the present invention, any and/or all of the electronic healthcare records or files, electronic medical records or files, electronic dental records or files, electronic pharmacy records or files, electronic behavioral health records or files, and/or personal health records or files, described herein as being utilized in connection with the apparatus 100 are or can be designed to receive, store, and/or provide, any notes, comments, and/or messages, provided by any of the herein-described users, individuals, patients, providers, insurers, payers, third parties, intermediaries, and/or any other person or entity, as text information or in text form, as audio information or in audio form, or as video information or in video form. Any text or audio information can be translated to from text to audio or from audio to text, and any text or audio information can be translated from one language to any one of more of any other language.

The database 10H can also contain statistical and/or other probabilistic and/or mathematical information for assigning and/or correlating certain levels and/or estimates for any and/or all of the information, diagnoses, prognoses, treatments, procedures, and/or any other information processed and/or generated by the central processing computer 10 and/or the apparatus 100.

The database 10H, in the preferred embodiment, can be a database which may include individual databases or collections of databases, with each database being designated to store any and all of the data and/or information described herein. The database 10H, or collection of databases, may be updated by each of the respective patients, providers, payers, users, and/or intermediaries, and/or by any other third party, in real-time, and/or via dynamically linked database management techniques.

The data and/or information stored in the database 10H can also be updated by and/or dynamically linked to, various external sources, including but not limited to news services, research publications, research facilities, healthcare laboratories, providers of healthcare goods and/or services, pharmaceutical companies, research institutions, schools. The database 10H will contain any and all information deemed necessary and/or desirable for providing all of the processing and/or services and/or functions described herein.

The database 10H can also contain data and/or information regarding any and/or all International Classification of Diseases (ICD) codes, ICD-10 codes, ICD-9, or any other ICD codes, or other codes, billing codes, diagnostic codes, treatment codes, or symptom codes, as well as any other codes or coding information which pertains to healthcare, the administration of healthcare services, healthcare record keeping, healthcare billing, healthcare diagnostics, healthcare treatments, or any other healthcare or healthcare-related functions or services, or any information or function, described-herein as capable of being provided by the apparatus 100 and method of the present invention. The database 10H can also contain data and/or information regarding the foreign language translations or conversions of or for, or for the foreign language translation or converting, of any of the herein-described International Classification of Diseases (ICD) codes, ICD-10 codes, ICD-9, any other ICD codes, or other codes, billing codes, diagnostic codes, treatment codes, symptom codes, as well as any other codes or coding information which pertains to healthcare, the administration of healthcare services, healthcare record keeping, healthcare billing, healthcare diagnostics, healthcare treatments, or any of the healthcare or healthcare-related functions or services, or any information or function described-herein as capable of being provided by the apparatus 100 and method of the present invention, into any one or any number of foreign languages.

The database 10H can contain any look-up tables, or information for use in a look table, for translating or converting any of the data, information, or codes, described herein, into any one or any number of foreign languages. The database 10H can also contain any language translation software or language conversion software which can be used to perform any of the foreign language translation or foreign language conversion processing or functionality described as being performed by the apparatus 100 and method of the present invention.

The database 10H can also contain any information or software, or rules algorithms, which can be used in generating insurance claim forms which can be submitted error-free to any of the insurers or payers described herein.

The database 10H can also contain digital pictures, photographs, images, video, or video clips, of individuals or patients, as well as digital pictures, photographs, images, video, or video clips, of physical conditions of or regarding an individual or patient, which can be accessed or retrieved by any of the individuals, patients, providers, payers, or intermediaries, described herein as utilizing the apparatus 100 and method of the present invention. For example, in instances where photographs or images can be useful to see a state of a physical condition of a patient or individual, or to compare a state of a physical condition from one point in time to another, or to track the state of a physical condition, a photograph(s), picture(s), or image(s), or video clip, can be digitally recorded, with a camera or video recording device, and stored in the database 10H and/or in the patient's or individual's healthcare record or healthcare file for later retrieval, use, and/or review.

For example, a dermatologist seeking to determine if a skin condition has or is changing in size, shape, or color, can take and store, in the database 10H and/or in the patient's or individual's healthcare record or healthcare file, one or more photographs, pictures, or images, or a video clips, of the skin condition. In an analogous manner, a plastic surgeon can obtain and store, in the database 10H and/or in the patient's or individual's healthcare record or healthcare file, photographs, pictures, or images, or video clips, showing physical conditions of an individual or patient before, after, or during a procedure or procedures. A dentist or an oral health professional can obtain and store, in the database 10H and/or in the patient's or individual's healthcare record or healthcare file, in addition to x-rays, a photograph(s), picture(s), or image(s), or a video clip(s), showing physical conditions of an individual's or patient's mouth, teeth, gums, or other physical oral state, for later retrieval, use, or review. In an analogous manner, any healthcare provider can obtain and store, in the database 10H and/or in a patient's or individual's healthcare record or healthcare file, a photograph(s), picture(s), or image(s), or a video clip(s), obtained in or during an office visit, an examination, a procedure, an operation, a treatment, or during any other occasion, event, occurrence, or happening, for later retrieval and use as needed or desired by any provider, payer, patient, individual, or intermediary, described herein as being able to utilize the apparatus 100 and method of the present invention.

The database 10H can also contain video and/or audio clips or recordings of office visits, examinations, procedures, operations, or any other healthcare, healthcare-related, or any other event(s), occurrence(s), or happening(s), which may or which can be of interest to any provider, insurer, payer, patient, individual, or intermediary, described herein as being able to utilize the apparatus 100 and method of the present invention.

The database 10H can also contain transcripts of office visits, examinations, procedures, operations, or any other healthcare, healthcare-related, or any other event(s), occurrence(s), or happening(s), which may or which can be of interest to any provider, insurer, payer, patient, individual, or intermediary, described herein as being able to utilize the apparatus 100 and method of the present invention.

The database 10H can also contain data, information, links, or hyperlinks, which can allow a healthcare provider to create or generate and/or transmit prescriptions or electronic prescriptions, or prescription forms, to pharmacies or other providers, for a patient or individual, prescriptions or electronic prescriptions for genetic information tests, testing, or analysis, or prescriptions or electronic prescriptions for tests, analyses, analysis work-ups, procedures, therapy, physical therapy, or other healthcare or healthcare-related services, for a patient or individual, or which can allow a healthcare provider to transmit a referral or an electronic referral or referral form to other healthcare providers or other providers of goods or services for a patient or individual.

The database 10H can also contain data, information, links, or hyperlinks, which can allow a healthcare provider to perform remote control or monitoring of healthcare devices or equipment used in the treatment of, a care of, or a monitoring of, a patient or individual, while the patient or individual is at home, in a hospital, in a nursing home, in a care facility, or traveling in or on, respectively, a car, automobile, train, subway train, boat, helicopter, airplane, aircraft, or any other vehicle.

The database 10H can also contain data, information, or software, for performing healthcare audits, for performing meaningful use information processing routines, for identifying or selecting individuals for clinical trials, experimental procedures, experimental treatments, healthcare focus groups, healthcare surveys, or other activities or events, or for performing any other processing routines which can advantageously use any of the information stored in the database 10H, any information stored in any of the herein-described healthcare records, files, or histories, described herein, or any other information, stored by the apparatus 100 of the present invention or any of its computers, communication devices, component parts, or devices, or any other information stored in, provided by, generated by, or used by, the apparatus 100 of the present invention. For example, with regards to clinical trials, experimental procedures, experimental treatments, healthcare focus groups, healthcare surveys, or other activities or events, the database 10H can contain information regarding whether or not an individual or patient can or may be a candidate for, be eligible to participate in, has agreed to be candidate for, or has agreed to participate in, clinical trials, experimental procedures, experimental treatments, healthcare focus groups, healthcare surveys, or other activities or events, or has agreed to be candidate for, or has agreed to participate in, a particular clinical trial(s), experimental procedure(s), experimental treatment(s), healthcare focus group(s), healthcare survey(s), or other activities or events.

The database 10H can also contain any data and/or information needed or used to determine or measure the effectiveness of, or side effects experienced or associated with, any medication(s), medicine(s), drug(s), dietary supplement(s), supplement(s), vitamin(s), nutrient(s), over-the-counter product(s) or substance(s), or the effectiveness of a procedure(s), treatment(s), treatment plan(s), care management plan(s), or any other good(s) or service(s) which can be offered in the marketplace.

The database 10H can also contain data and/or information relating to information regarding health conditions, healthcare conditions, illnesses, diagnoses, symptoms, treatments, treatment plans, care management plans, care management practices, insurance information, information regarding type of insurance, wellness information, healthcare practices, healthcare history patterns, healthcare trends, treatment trends, care management trends, statistics, statistical analyses, studies, study trends, or any other healthcare or healthcare-related information, for or regarding any number or type of groups of individuals or patients, and any data or information for determining same. The database 10H can also contain data or information regarding, or for determining, any of the above-described information for any number of groups of individuals or patients based on sex, gender, age, occupation, education, ethnicity, nationality, country of origin, religion, or any demographic or demographics, or any other criteria. The database 10H can also contain data or information regarding, or for determining statistical information or probability information regarding, any of the herein-described information.

The database 10H can also contain data or information for implementing and for performing drug formulary checks or analyses, as well as data or information for performing medication, medicine, or drug, reconciliation.

The database 10H can also contain immunization data or information.

The database 10H can also contain educational or instructional information, links or hyperlinks to same, information regarding instructions or procedures, or links or hyperlinks to same, in order to allow for the providing of patient-specific educational or instructional information or resources to patients or individuals, as well as to any of the herein-described healthcare providers, other providers, payers or insurers, or intermediaries or caregivers.

The database 10H can also contain data or information necessary or desired for administering employee benefits for any of the individuals or patients who utilize the apparatus 100 and method of the present invention.

The database 10H can also contain data or information necessary or desired for purchasing or enrolling in employee benefits for any of the individuals or patients who utilize the apparatus 100 and method of the present invention.

The database 10H can also contain data or information necessary or desired for allowing any individual or patient to make a request or a claim for, or pursuant to, or to file a request or a claim for, an employee benefit or employee benefits, for any of the individuals or patients who utilize the apparatus 100 and method of the present invention.

The database 10H can also contain data or information for facilitating, or for providing for, the portability of healthcare insurance or health insurance benefits, life insurance or life insurance benefits, or disability insurance or disability insurance benefits, or for providing for the portability of any other employee benefit or employee benefits.

The database 10H can also contain any of the messages or reports described herein as being generated by or provided by the apparatus 100 and method of the present invention, for later use by any provider, insurer, payer, patient, individual, or intermediary, or any other person or entity, described herein as being able to utilize the apparatus 100 and method of the present invention.

The database 10H can also contain any data, information, or software, for performing any of the processing routines or functionality described herein as being capable of being performed by, or provided by, the apparatus 100 of the present invention.

The data and/or information which is contained and/or stored in the database 10H as well as any of the other databases 20H, 30H, 40, and 50H, described herein can be obtained from the various patients, individuals, providers, payers, and/or intermediaries, who or which utilize and/or who or which are serviced by the present invention. For example, the respective patients, providers, payers, intermediaries, and/or other users, could fill out questionnaires, forms, narratives, claim forms, and/or any other information medium, in written form, electronically, and/or otherwise.

Data and/or information stored in the database 10H as well as any of the other databases described herein can be updated by multiple parties. For example, a patient may provide a medical history for his or her individual file, his or her medical doctor can update the medical history information for the patient upon examining and/or treating him or her. The payer may also update the file with any associated payment or payment-related information. Should the patient go to another doctor or different type of doctor, all previous information would be available for, and can be updateable by, the next doctor.

The database 10H can also contain information regarding alternate medicine techniques, herbal techniques, meditation techniques, exercise techniques, self-healing, faith healing, and/or other non-medicine treatments and/or techniques.

The database 10H can also include statistical data and/or information regarding diagnoses, and/or alternate diagnoses, treatment success, treatment failure, as well as statistical data and/or information regarding misdiagnoses. The database 10H also contains data and/or information regarding experimental treatments as well as statistical information regarding same, successes of same and failures of same.

The database 10H can also contain any other data and/or information, including software for performing any and all of the operations, routines, processing routines, and other functions and/or functionality described herein as being capable of being performed by the apparatus 100, the central processing computer(s) 10 and any of the herein-described provider communication device(s) 20, payer communication device(s) 30, user or patient communication device(s) 40, intermediary communication device(s) 50, healthcare records computer(s) 60, insurance exchange computer(s) 70, social networking computer(s) 80, and/or media computer(s) 90.

The database 10H can also contain any data and/or information, as well as any links or hyperlinks to any of the herein-described provider communication device(s) 20, payer communication device(s) 30, user or patient communication device(s) 40, intermediary communication device(s) 50, healthcare records computer(s) 60, insurance exchange computer(s) 70, social networking computer(s) 80, and/or media computer(s) 90 described herein as being used in connection with the present invention, and/or can contain data and/or information and/or links or hyperlinks to any data and/or information located or stored on, at, or in any of the provider communication device(s) 20, payer communication device(s) 30, user or patient communication device(s) 40, intermediary communication device(s) 50, healthcare records computer(s) 60, insurance exchange computer(s) 70, social networking computer(s) 80, and/or media computer(s) 90 described herein.

The database 10H can also contain information, links and/or hyperlinks, to any social networking web sites, web pages, support groups, on-line forums, on-link information services, as well as social networking web sites or social networking web pages to or for social networking members, support groups, information providers, healthcare providers, as well as any of the providers, insurers, payers, individuals, patient, third parties, intermediaries, or any other persons or entities described herein who are or who may be members of any social network.

In any and/or all of the embodiments described herein, any of the data and/or information which is or which may be stored in the database 10H, and/or any of the other databases described herein, can be utilized and/or can appear in any of the reports, genetic profile reports or plans, diagnostic reports, treatment reports, treatment plans, initial or baseline genetic profile diagnostic reports, initial or baseline genetic profile treatment reports or plans, genetic profile diagnostic reports, or genetic profile treatment reports or plans, or any other reports, messages, or plans, described herein as being generated by and/or provided by the central processing computer 10 and/or by the apparatus 100 and method of the present invention.

The central processing computer 10 also includes an output device 10I for outputting any data, information, report, etc., described herein. In the preferred embodiment, the output device 10I can be a printer, a display, a transmitter, a modem, and/or any other device which can be used to output data or information.

Any of the data and/or information for any of the individuals, patients, providers, insurers, payers, and/or intermediaries, can be updated by different parties, which such updated data and/or information being made available to other respective parties so as to provide and ensure comprehensive and up-to-date healthcare and healthcare-related information.

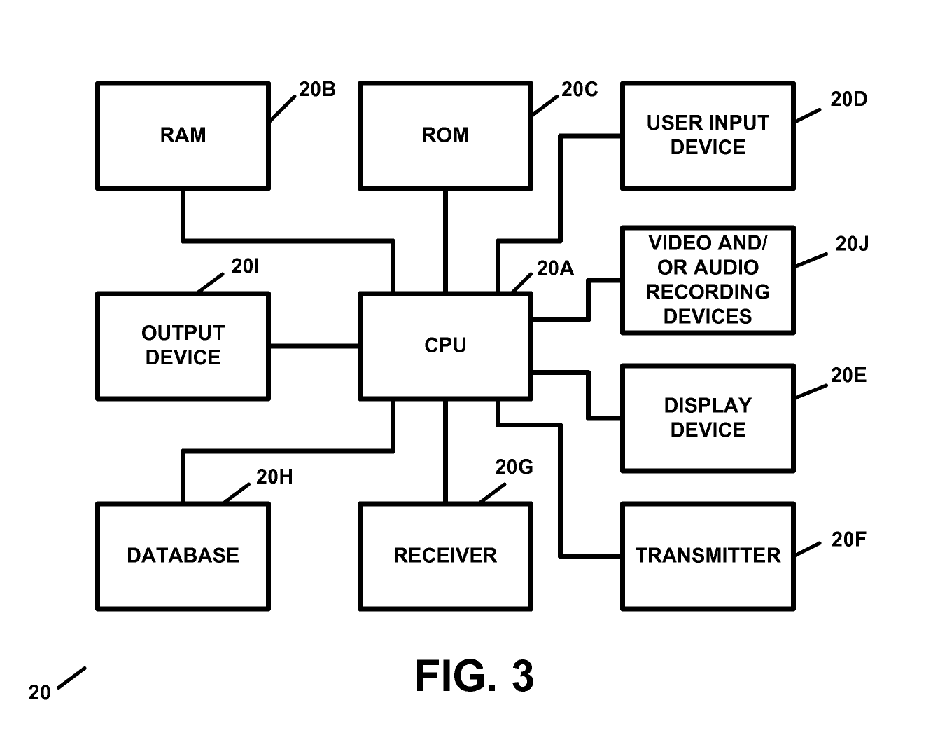

FIG. 3 illustrates the provider communication device 20, in block diagram form. The provider communication device 20, in the preferred embodiment, can be personal computer, a network computer or computer system, or any other computer or communication device, including, but not limited to, a personal computer, a home computer, a server computer, a network computer, a computer system, a hand-held computer, a palmtop computer, a laptop computer, a tablet, a tablet computer, a personal communication device, a cellular telephone, a wireless telephone, a mobile telephone, a digital television, an interactive television, a digital television, an Internet-enabled television, a personal digital assistant, a telephone, a digital telephone, a television, an interactive television, a beeper, a pager, a smart phone, or a watch, an Internet-enabled watch or an Internet-enabled time piece, Internet-enabled eyewear or glasses, Internet-enabled clothing or apparel or an Internet-enabled article of clothing or footwear, or an Internet-enabled accessory, or Internet-enabled jewelry, or any other device which can function as a provider communication device 20.

In the preferred embodiment, the provider communication device 20 includes a central processing unit or CPU 20A which, in the preferred embodiment, is a microprocessor. The CPU 20A may also be a microcomputer, a minicomputer, a macro-computer, and/or a mainframe computer, depending upon the application.

The provider communication device 20 also includes a random access memory device(s) 20B (RAM) and a read only memory device(s) 20C (ROM), each of which is connected to the CPU 20A, a user input device 20D, for entering data and/or commands into the provider communication device 20, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, such as, for example, pulse rate monitors, blood pressure monitors, electrocardiograms, blood-sugars monitors, etc., if desired, which input device(s) are also connected to the CPU 20A.

The user input device 20D can also acquire, receive, generate and/or provide, data which can be entered by a user or an individual and/or which can be a device which can acquire, receive, generate and/or provide, digital data such as medical, healthcare, bio-metric, physiological, and/or any other kind of healthcare data and/or healthcare-related data. For example, a user input device 20D can be a keyboard for allowing a user to input information into the provider communication device and/or a user input device 20D can, for example, be a heart rate monitor or EKG machine which can receive information from a patient or individual and which can generate a digital signal, digital data, analog data, and/or any other signal, data, and/or information, which is representative of the patient's or the individual's heart rate, pulse rate, and/or cardiac activity.

The user input device 20D can also be, or can include, any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, blood analysis device or machine, a respirator, a respiration monitoring or measurement device, a dialysis machine, a dialysis device, electrocardiograph (EKG) machine or device, electrocephalograph (EEG) machine or device, electromyograph (EMG) machine or device, a magnetic resonance imaging (MRI) machine or device, X-ray machine or device, medical imaging machine or device, thermal imaging machine or device, a heart sound monitor or measurement device, a lung sound monitoring or measurement device, respiration rate monitoring or measurement device, a laprascopic device, an arthroscopic device, a vascular testing device, a catheter device, a cardiac performance testing, monitoring, or measurement device, a pulmonary performance testing, monitoring, or measurement device, a vascular system performance monitoring or measurement device, a vascular system testing, monitoring, or measurement device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, a PET scan device, an optical metabolism measurement or monitoring device, a radiotelemetric device, a doppler medical device, a mammogram device, a carbon dioxide detection or measurement device, a carbon monoxide detection or measurement device, a transvascular impedence measurement or monitoring device, an ultrasonic imaging device, a bone conduction device, a brain function scan analyzer device, an external pulse cardiac monitoring or measurement device, a fetal heart rate measurement, monitoring, or probing, device, an endotrachial cardiac monitoring device, or a finger tip blood pressure monitoring device, a psychological monitoring device, a surgical instrument, a vital signs measurement device, an ear pressure regulating device, a phonocardiograph device, an acoustic aneurysm detector device, a blood oxygen detection device, an esophageal probing device, an ultrasonic probing device, ausculoscope, a vital signs monitoring system, a heart activity monitoring device, a pulmonary activity monitoring device, a sphygmomanometer, an esophageal stethoscope, a venous pressure measuring device, a differential doppler device, a physiological data measuring device, a body tissue movement device, a breathalyzer device, a camera probing device, a microscopic camera probing device, or any scope having a camera and/or a light, or a laparoscopic device, a laparoscopic camera device, or a camera used in or associated with equipment for performing visual probing of the body or any portions, parts, or organs, thereof, such as, but not limited to, a colonoscopy, an endoscopy, an esophagoscopy, a gastroscopy, or any devices used in laparoscopic surgery or other surgeries, an ingestible or implantable pill, capsule, or device, containing a camera and/or a light and equipment or circuitry for transmitting information as well as images to equipment inside or outside the body, and/or any other bio-metric or physiological data measuring device(s) and/or data acquisition device (hereinafter referred to generally or collectively as “healthcare equipment input device”, “healthcare measurement input device”, or “healthcare monitoring input device”).

The user input device 20D can also be, or can include, a pacemaker, a device for monitoring blood pressure or blood flow, or an ingestible or implantable pill, capsule, or device, containing a camera and/or a light and equipment or circuitry for transmitting information as well as images to equipment inside or outside the body. The user input device 20D can also be any device for inputting any genetic information or genetic information.

The provider communication device 20 also includes a display device 20E for displaying data and/or information to a user or operator.

The provider communication device 20 also includes a transmitter(s) 20F, for transmitting signals and/or data and/or information to any one or more of the central processing computer(s) 10, any other provider communication device(s) 20, the payer communication device(s) 30, the user communication device(s) 40, the intermediary computer(s) 50, the healthcare records computer(s) 60, the insurance exchange computer(s) 70, the social networking computer(s) 80, and/or the media computer(s) 90, described herein, which may be utilized in conjunction with the present invention. The provider communication device 20 also includes a receiver 20G, for receiving signals and/or data and/or information from any one or more of the central processing computer(s) 10, any other provider communication device(s) 20, the payer communication device(s) 30, the user communication device(s) 40, the intermediary computer(s) 50, the healthcare records computer(s) 60, the insurance exchange computer(s) 70, the social networking computer(s) 80, and/or the media computer(s) 90, described herein, which may be utilized in conjunction with the present invention.

The provider communication device 20 also includes a database(s) 20H. The database 20H can contain or include, and/or can be linked to, any and/or all of the data and/or information described herein as being stored in the database 10H.

The provider communication device 20 also includes an output device 20I for outputting any data, information, report, etc., described herein. In the preferred embodiment, the output device 20I can be a printer, a display, a transmitter, a modem, and/or any other device which can be used to output data.

The provider communication device 20 also includes a video and/or audio recording device(s) 20J which can include a camera and/or a video recording device for recording pictures or video and/or video clips and/or a microphone or an audio recording device for recording audio or audio clips which can be stored in any of the electronic healthcare, electronic medical, electronic dental, electronic pharmacy, and/or electronic behavioral healthcare, records or files described herein, and/or which can be otherwise used for communicating with other users, individuals, patients, providers, payers, or persons or entities, who or which utilize the apparatus 100 and method of the present invention.

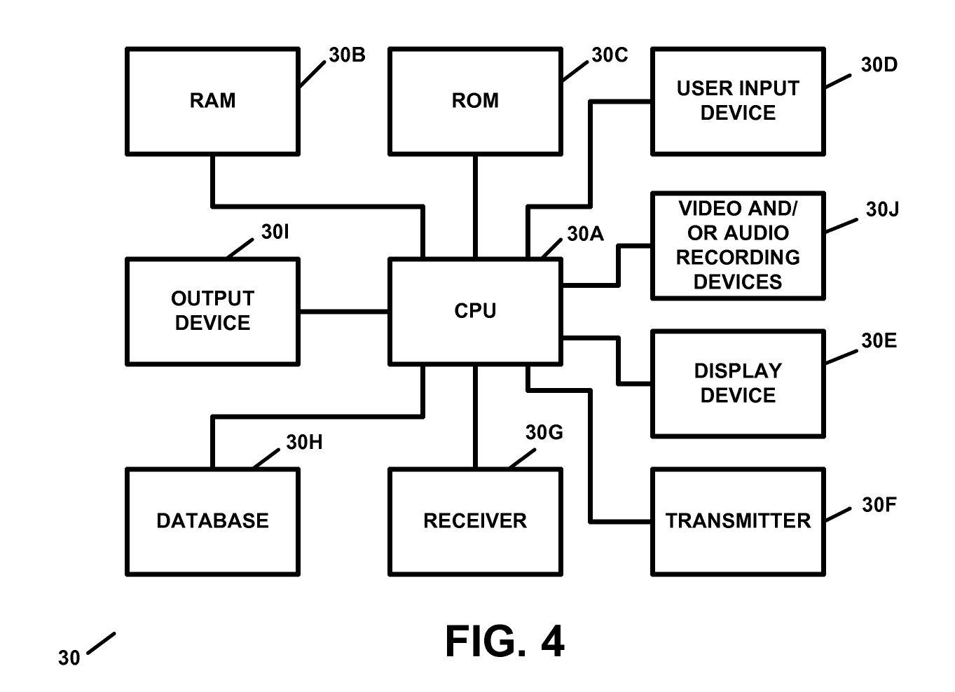

FIG. 4 illustrates the payer communication device 30, in block diagram form. The payer communication device 30, in the preferred embodiment, can be personal computer, a network computer or computer system, or any other computer or communication device which can function as a communication device 30. In the preferred embodiment, the payer communication device 30 includes a central processing unit or CPU 30A, which in the preferred embodiment, is a microprocessor. The CPU 30A may also be a microcomputer, a minicomputer, a macro-computer, and/or a mainframe computer, depending upon the application.

The payer communication device 30 also includes a random access memory device(s) 30B (RAM) and a read only memory device(s) 30C (ROM), each of which is connected to the CPU 30A, a user input device 30D, for entering data and/or commands into the payer communication device 30, which includes any one or more of a keyboard, a scanner, a user pointing device, such as, for example, a mouse, a touch pad, and/or an audio input device and/or a video input device, and/or any device, electronic and/or otherwise which can be utilized for inputting and/or for entering healthcare data and/or information, for example pulse rate monitors, blood pressure monitors, electro-cardiograms, blood-sugars monitors, etc., if desired, which input device(s) are also connected to the CPU 30A. The payer communication device 30 also includes a display device 30E for displaying data and/or information to a user or operator.

The payer communication device 30 also includes a transmitter(s) 30F, for transmitting signals and/or data and/or information to any one or more of the central processing computer(s) 10, the provider communication device(s) 20, any other payer communication device(s) 30, the user communication device(s) 40, the intermediary computer(s) 50, the healthcare records computer(s) 60, the insurance exchange computer(s) 70, the social networking computer(s) 80, and/or the media computer(s) 90, described herein, which may be utilized in conjunction with the present invention. The payer communication device 30 also includes a receiver 30G, for receiving signals and/or data and/or information from any one or more of the central processing computer(s) 10, the provider communication device(s) 20, any other payer communication device(s) 30, the user communication device(s) 40, the intermediary computer(s) 50, the healthcare records computer(s) 60, the insurance exchange computer(s) 70, the social networking computer(s) 80, and/or the media computer(s) 90, described herein, which may be utilized in conjunction with the present invention.

The payer communication device 30 also includes a database(s) 30H. The database 30H can contain or include, and/or can be linked to, any of the data and/or information described herein as being stored in the database 10H.

The payer communication device 30 also includes an output device 30I for outputting any data, information, report, etc., described herein. In the preferred embodiment, the output device 30I can be a printer, a display, a transmitter, a modem, and/or any other device which can be used to output data.

The payer communication device 30 also includes a video and/or audio recording device(s) 30J which can include a camera and/or a video recording device for recording pictures or video and/or video clips and/or a microphone or an audio recording device for recording audio or audio clips which can be stored in any of the electronic healthcare, electronic medical, electronic dental, electronic pharmacy, and/or electronic behavioral healthcare, records or files described herein, and/or which can be otherwise used for communicating with other users, individuals, patients, providers, payers, or persons or entities, who or which utilize the apparatus 100 and method of the present invention.

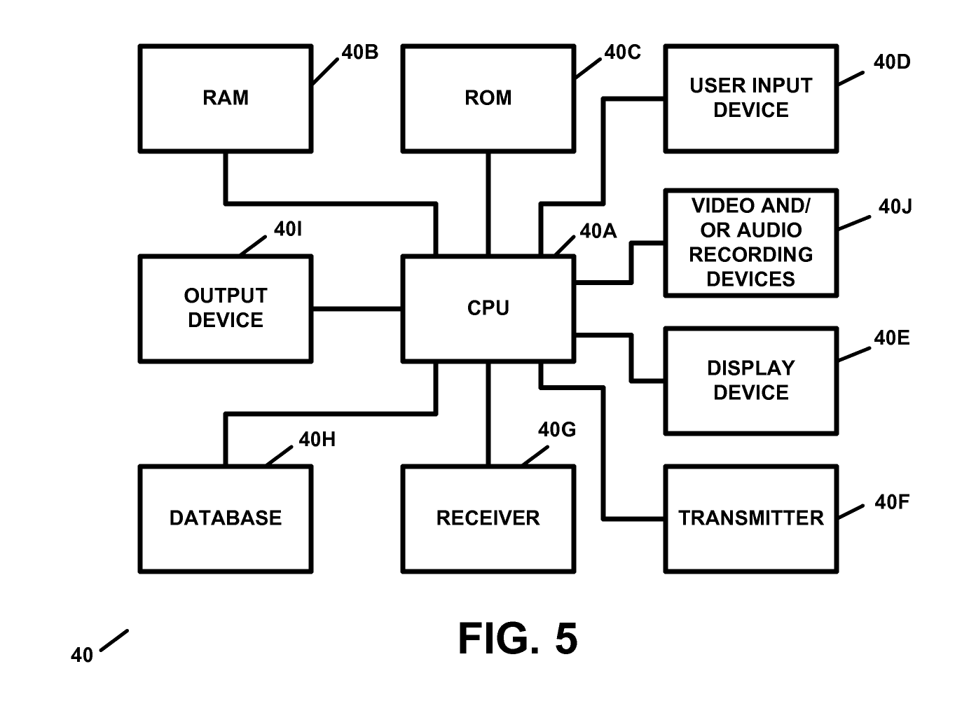

FIG. 5 illustrates the user communication device 40, in block diagram form. The user communication device 40, in the preferred embodiment, can be any computer or communication device, including, but not limited to, a personal computer, a home computer, a server computer, a network computer, a computer system, a hand-held computer, a palmtop computer, a laptop computer, a tablet, a tablet computer, a personal communication device, a cellular telephone, a wireless telephone, a mobile telephone, a digital television, an interactive television, a digital television, an Internet-enabled television, a personal digital assistant, a telephone, a digital telephone, a television, an interactive television, a beeper, a pager, a smart phone, or a watch, an Internet-enabled watch or an Internet-enabled time piece, Internet-enabled eyewear or glasses, Internet-enabled clothing or apparel or an Internet-enabled article of clothing or footwear, or an Internet-enabled accessory, or Internet-enabled jewelry, or any other device which can function as a user communication device 40.

In the preferred embodiment, the user communication device 40 includes a central processing unit or CPU 40A, which in the preferred embodiment, is a microprocessor. The CPU 40A may also be a microcomputer, a minicomputer, a macro-computer, and/or a mainframe computer, depending upon the application.

The user communication device 40 also includes a random access memory device(s) 40B (RAM) and a read only memory device(s) 40C (ROM), each of which is connected to the CPU 40A, a user input device 40D, for entering data and/or commands into the user communication device 40, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, such as, for example, pulse rate monitors, blood pressure monitors, electro-cardiograms, blood-sugars monitors, etc., if desired, which input device(s) are also connected to the CPU 40A.

The user input device 40D can also acquire, receive, generate, and/or provide, data which can be entered by a user or individual and/or which can be a device which can acquire, receive, generate, and/or provide, digital data such as medical, healthcare, bio-metric, physiological, and/or any other kind of healthcare data and/or healthcare-related data. For example, a user input device 40D can be a keyboard for allowing a user to input information into the user communication device 40 and/or a user input device 40D can, for example, be a heart rate monitor or EKG machine which can receive information from a patient or an individual and which can generate a digital signal, digital data, analog data, and/or any other signal, data, and/or information, which is representative of the patient's or the individual's heart rate, pulse rate, and/or cardiac activity.

The user input device 40D can also be, or can include, any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, a blood analysis device or machine, a respirator, a respiration monitoring or measurement device, a dialysis machine, a dialysis device, an electrocardiograph (EKG) machine or device, an electrocephalograph (EEG) machine or device, an electromyograph (EMG) machine or device, a magnetic resonance imaging (MRI) machine or device, an X-ray machine or device, a medical imaging machine or device, a thermal imaging machine or device, a heart sound monitor or measurement device, a lung sound monitoring or measurement device, a respiration rate monitoring or measurement device, a laprascopic device, an arthroscopic device, a vascular testing device, a catheter device, a cardiac performance testing, monitoring, or measurement device, a pulmonary performance testing, monitoring, or measurement device, a vascular system performance monitoring or measurement device, a vascular system testing, monitoring, or measurement device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, an optical metabolism measurement or monitoring device, a radiotelemetric device, a doppler medical device, a mammogram device, a carbon dioxide detection or measurement device, a carbon monoxide detection or measurement device, a transvascular impedence measurement or monitoring device, an ultrasonic imaging device, a bone conduction device, a brain function scan analyzer device, an external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, an ear pressure regulating device, a phonocardiograph device, an acoustic aneurysm detector device, a blood oxygen detection device, an esophageal probing device, an ultrasonic probing device, an ausculoscope, a vital signs monitoring system, a heart activity monitoring device, a pulmonary activity monitoring device, a sphygmomanometer, an esophageal stethoscope, a venous pressure measuring device, a differential doppler device, a physiological data measuring device, a body tissue movement device, a breathalyzer device, a camera probing device, or a microscopic camera probing device, and/or any other bio-metric or physiological data measuring device(s) and/or data acquisition device (hereinafter referred to generally or collectively as “healthcare equipment input device”, “healthcare measurement input device”, or “healthcare monitoring input device”).

The user communication device 40 also includes a display device 40E for displaying data and/or information to a user or operator.

The user communication device 40 also includes a transmitter(s) 40F, for transmitting signals and/or data and/or information to any one or more of the central processing computer(s) 10, the provider communication device(s) 20, the payer communication device(s) 30, any other user communication device(s) 40, the intermediary computer(s) 50, the healthcare records computer(s) 60, the insurance exchange computer(s) 70, the social networking computer(s) 80, and/or the media computer(s) 90, described herein, which may be utilized in conjunction with the present invention. The user communication device 40 also includes a receiver 40G, for receiving signals and/or data and/or information from any one or more of the central processing computer(s) 10, the provider communication device(s) 20, the payer communication device(s) 30, any other user communication device(s) 40, the intermediary computer(s) 50, the healthcare records computer(s) 60, the insurance exchange computer(s) 70, the social networking computer(s) 80, and/or the media computer(s) 90, described herein, which may be utilized in conjunction with the present invention.

The user or patient communication device 40 also includes a database(s) 40H. The database 40H can contain or include, and/or can be linked to, any of the data and/or information described herein as being stored in the database 10H.

The user communication device 40 also includes an output device 40I for outputting any data, information, report, etc., described herein. In the preferred embodiment, the output device 40I can be a printer, a display, a transmitter, a modem, and/or any other device which can be used to output data.

The user communication device 40 also includes a video and/or audio recording device(s) 40J which can include a camera and/or a video recording device for recording pictures or video and/or video clips and/or a microphone or an audio recording device for recording audio or audio clips which can be stored in any of the electronic healthcare, electronic medical, electronic dental, electronic pharmacy, and/or electronic behavioral healthcare, records or files described herein, and/or which can be otherwise used for communicating with other users, individuals, patients, providers, payers, or persons or entities, who or which utilize the apparatus 100 and method of the present invention.

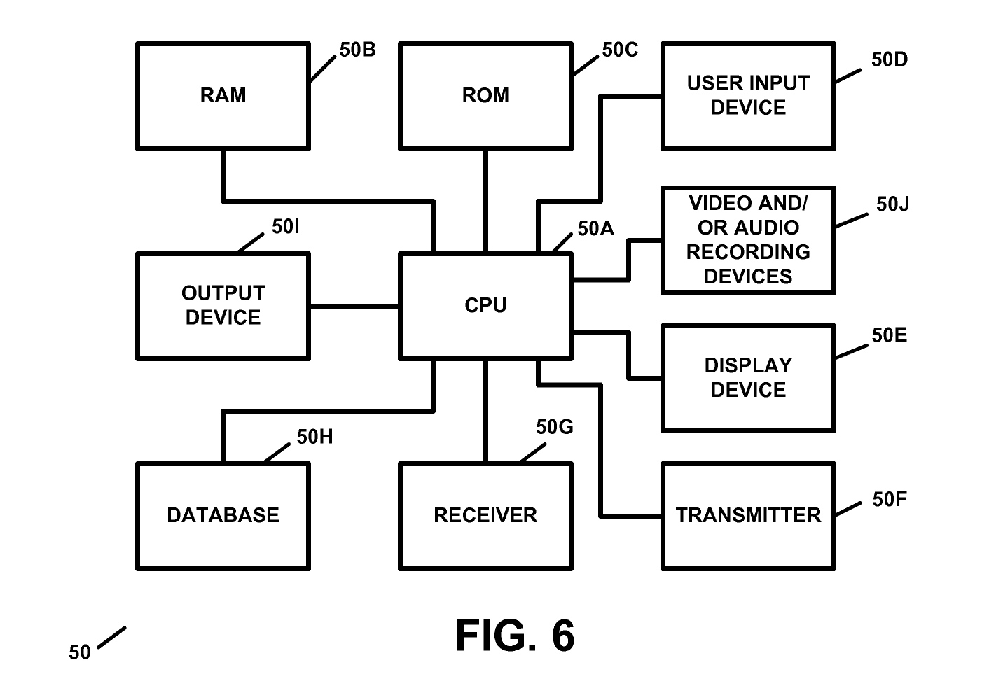

FIG. 6 illustrates the intermediary computer 50, in block diagram form. The intermediary computer 50, in the preferred embodiment, can be any computer or communication device, including, but not limited to, a personal computer, a home computer, a server computer, a network computer, a computer system, a hand-held computer, a palmtop computer, a laptop computer, a tablet, a tablet computer, a personal communication device, a cellular telephone, a wireless telephone, a mobile telephone, a digital television, an interactive television, a digital television, an Internet-enabled television, a personal digital assistant, a telephone, a digital telephone, a television, an interactive television, a beeper, a pager, a smart phone, or a watch, an Internet-enabled watch or an Internet-enabled time piece, Internet-enabled eyewear or glasses, Internet-enabled clothing or apparel or an Internet-enabled article of clothing or footwear, or an Internet-enabled accessory, or Internet-enabled jewelry, or any other device which can function as an intermediary communication device 50.

In the preferred embodiment, the intermediary computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The intermediary computer 50 also includes a random access memory device(s) 50B (RAM) and a read only memory device(s) 50C (ROM), each of which is connected to the CPU 50A, a user input device 50D, for entering data and/or commands into the intermediary computer 50, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electrocardiograms, blood-sugars monitors, etc., if desired, which input device(s) are also connected to the CPU 50A. The intermediary computer 50 also includes a display device 50E for displaying data and/or information to a user or operator.

The intermediary computer 50 also includes a transmitter(s) 50F, for transmitting signals and/or data and/or information to any one or more of the central processing computer(s) 10, the provider communication device(s) 20, the payer communication device(s) 30, the user communication device(s) 40, any other intermediary computer(s) 50, the healthcare records computer(s) 60, the insurance exchange computer(s) 70, the social networking computer(s) 80, and/or the media computer(s) 90, described herein, which may be utilized in conjunction with the present invention. The intermediary computer 50 also includes a receiver 50G, for receiving signals and/or data and/or information from any one or more of the central processing computer(s) 10, the provider communication device(s) 20, the payer communication device(s) 30, the user communication device(s) 40, any other intermediary computer(s) 50, the healthcare records computer(s) 60, the insurance exchange computer(s) 70, the social networking computer(s) 80, and/or the media computer(s) 90, described herein, which may be utilized in conjunction with the present invention.

The intermediary computer 50 also includes a database(s) 50H. The database 50H can contain or include, and/or can be linked to, any of the data and/or information described herein as being stored in the database 10H.

The intermediary communication device 50 also includes an output device 50I for outputting any data, information, report, etc., described herein. In the preferred embodiment, the output device 50I can be a printer, a display, a transmitter, a modem, and/or any other device which can be used to output data.

The intermediary communication device 50 also includes a video and/or audio recording device(s) 50J which can include a camera and/or a video recording device for recording pictures or video and/or video clips and/or a microphone or an audio recording device for recording audio or audio clips which can be stored in any of the electronic healthcare, electronic medical, electronic dental, electronic pharmacy, and/or electronic behavioral healthcare, records or files described herein, and/or which can be otherwise used for communicating with other users, individuals, patients, providers, payers, or persons or entities, who or which utilize the apparatus 100 and method of the present invention.

In any and/or all of the embodiments described herein, any one of the central processing computers 10, the provider communication devices 20, the payer communication devices 30, the patient communication devices 40, and/or the intermediary communication devices 50, can include input devices (not shown) for facilitating the data entry of a patients vital signs and or other medical data such as, but not limited to, pulse rate, blood pressure, blood-sugar level, etc., and any other data and or information which can be input into the respective computer and/or communication device and can be entered into or transmitted to the central processing computer 10 consistent with the utilization of the present invention as described herein. In any and/or all of the embodiments described herein, any one of the central processing computers 10, the provider communication devices 20, the payer communication devices 30, the patient communication devices 40, and/or the intermediary communication devices 50, can also include input devices for inputting or entering genetic information or genetic-related information into the respective computer and/or communication device and which can be entered into or transmitted to the central processing computer 10 consistent with the utilization of the present invention as described herein.

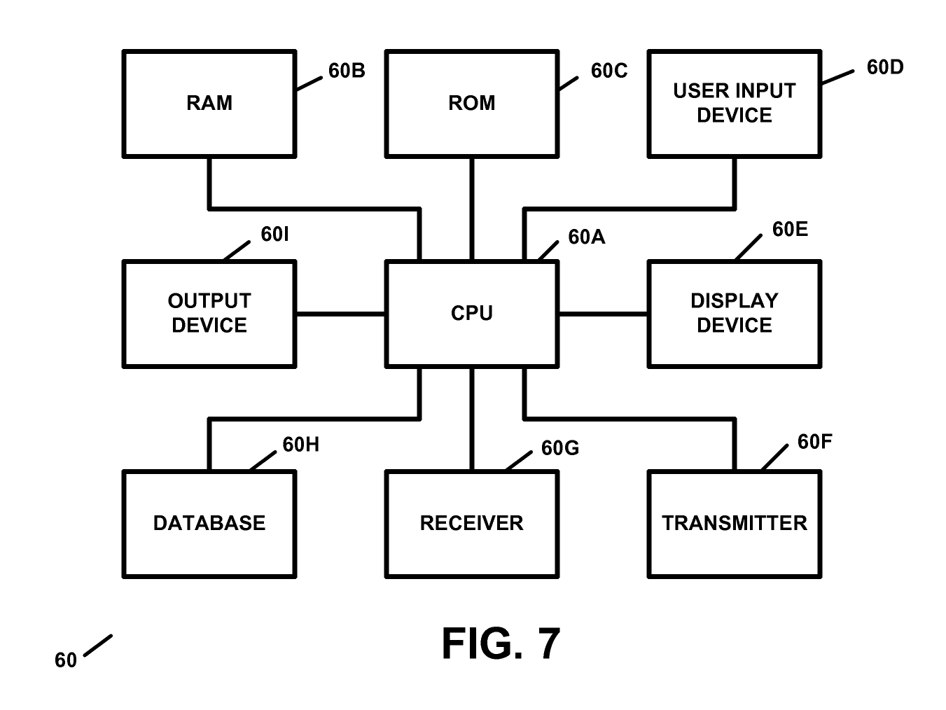

FIG. 7 illustrates the healthcare records computer 60, in block diagram form. The healthcare records computer 60, in the preferred embodiment, can be server computer or server computer system, a cloud computer or cloud computer system, a network computer or computer system, a personal computer, or any other computer or communication device, or any cellular telephone, tablet, tablet computer, personal digital assistant, wireless communication device or wireless computer, or any other communication device, which is utilized to store an electronic healthcare record, an electronic medical record, an electronic dental record, an electronic pharmacy record, or an electronic behavioral healthcare record or any one or any number of electronic healthcare records, electronic medical records, electronic dental records, electronic pharmacy records, and/or electronic behavioral healthcare records. In a preferred embodiment, the healthcare records computer 60 can be any computer or computer system for storing any an electronic healthcare record, an electronic medical record, an electronic dental record, an electronic pharmacy record, or an electronic behavioral healthcare record which is stored somewhere else other than the central processing computer 10. The healthcare records computer 60 can be used by, maintained by, or associated with, any individual, provider, user, patient, payer, intermediary, or any other entity or third party.

In the preferred embodiment, the healthcare records computer 60 includes a central processing unit or CPU 60A, which in the preferred embodiment, is a microprocessor. The CPU 60A may also be a microcomputer, a minicomputer, a macro-computer, and/or a mainframe computer, depending upon the application.

The healthcare records computer 60 also includes a random access memory device(s) 60B (RAM) and a read only memory device(s) 60C (ROM), each of which is connected to the CPU 60A, a user input device 60D, for entering data and/or commands into the healthcare records computer 60, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information which input device(s) are also connected to the CPU 60A. The healthcare records computer 60 also includes a display device 60E for displaying data and/or information to a user or operator.

The healthcare records computer 60 also includes a transmitter(s) 60F, for transmitting signals and/or data and/or information to any one or more of the central processing computer(s) 10, the provider communication device(s) 20, the payer computers(s) 30, the user communication device(s) 40, the intermediary computer(s) 50, any other healthcare records computer(s) 60, the insurance exchange computer(s) 70, the social networking computer(s) 80, and/or the media computer(s) 90, described herein, which may be utilized in conjunction with the present invention. The healthcare records computer 60 also includes a receiver 60G, for receiving signals and/or data and/or information from any one or more of the central processing computer(s) 10, the provider communication device(s) 20, the payer computers(s) 30, the user communication device(s) 40, the intermediary computer(s) 50, any other healthcare records computer(s) 60, the insurance exchange computer(s) 70, the social networking computer(s) 80, and/or the media computer(s) 90, described herein, which may be utilized in conjunction with the present invention.

The healthcare records computer 60 also includes a database(s) 60H. The database 60H can contain or include, and/or can be linked to, any of the data and/or information described herein as being stored in the database 10H and can also contain or include any data and/or information regarding and/or including any of the of electronic healthcare records, electronic medical records, electronic dental records, electronic pharmacy records, and/or electronic behavioral healthcare records, which are stored in the healthcare records computer 60.

The healthcare records computer 60 also includes an output device 60I for outputting any data, information, report, etc., described herein. In the preferred embodiment, the output device 60I can be a printer, a display, a transmitter, a modem, and/or any other device which can be used to output data.

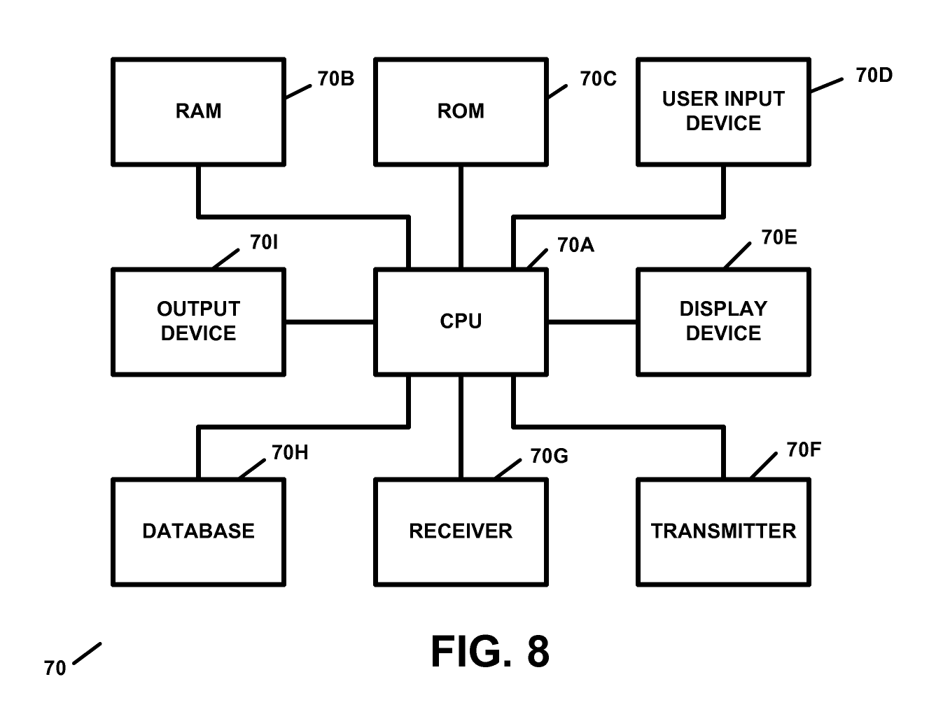

FIG. 8 illustrates the insurance exchange computer 70, in block diagram form. The insurance exchange computer 70, in the preferred embodiment, can be server computer or server computer system, a cloud computer or cloud computer system, a network computer or computer system, a personal computer, or any other computer or communication device, or any cellular telephone, tablet, personal digital assistant, wireless communication device or wireless computer, or any other communication device, which is utilized to function as an insurance exchange computer 70. In a preferred embodiment, the insurance exchange computer 70 can be any computer or computer system for providing the functionality described herein as being provided by the insurance exchange computer 70.

The insurance exchange computer 70 can be used by, maintained by, or associated with, any provider of any of the herein-described insurance policies, products, or services, described herein as being provided, offered for sale, or sold, or serviced, by or via the apparatus 100 and method of the present invention.

In the preferred embodiment, the insurance exchange computer 70 includes a central processing unit or CPU 70A, which in the preferred embodiment, is a microprocessor. The CPU 70A may also be a microcomputer, a minicomputer, a macro-computer, and/or a mainframe computer, depending upon the application.

The insurance exchange computer 70 also includes a random access memory device(s) 70B (RAM) and a read only memory device(s) 70C (ROM), each of which is connected to the CPU 70A, a user input device 70D, for entering data and/or commands into the insurance exchange computer 70, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information which input device(s) are also connected to the CPU 70A. The insurance exchange computer 70 also includes a display device 70E for displaying data and/or information to a user or operator.

The insurance exchange computer 70 also includes a transmitter(s) 70F, for transmitting signals and/or data and/or information to any one or more of the central processing computer(s) 10, the provider communication device(s) 20, the payer communication device(s) 30, the user communication device(s) 40, the intermediary computer(s) 50, the healthcare records computer(s) 60, any other insurance exchange computer(s) 70, the social networking computer(s) 80, and/or the media computer(s) 90, described herein, which may be utilized in conjunction with the present invention. The insurance exchange computer 70 also includes a receiver 70G, for receiving signals and/or data and/or information from any one or more of the central processing computer(s) 10, the provider communication device(s) 20, the payer communication device(s) 30, the user communication device(s) 40, the intermediary computer(s) 50, the healthcare records computer(s) 60, any other insurance exchange computer(s) 70, the social networking computer(s) 80, and/or the media computer(s) 90, described herein, which may be utilized in conjunction with the present invention.

The insurance exchange computer 70 also includes a database(s) 70H. The database 70H can contain or include, and/or can be linked to, any of the data and/or information described herein as being stored in the database 10H, and can also contain or include any data and/or information regarding and/or including any of the various insurance policies, products, or services, which can be offered for sale by the insurance exchange computer 70 or which can be services by the insurance exchange computer 70, as well as any data and/or information regarding insured individuals or entities, their insurance policies, products, and/or services, claims made, claims paid, and any other records typically stored or maintained by an insurance company computer, an insurance exchange computer, an electronic commerce computer, or any other data and/or information for providing any of the functions or functionality described herein as being performed by the insurance exchange computer 70.

The insurance exchange computer 70 also includes an output device 70I for outputting any data, information, report, etc., described herein. In the preferred embodiment, the output device 70I can be a printer, a display, a transmitter, a modem, and/or any other device which can be used to output data.

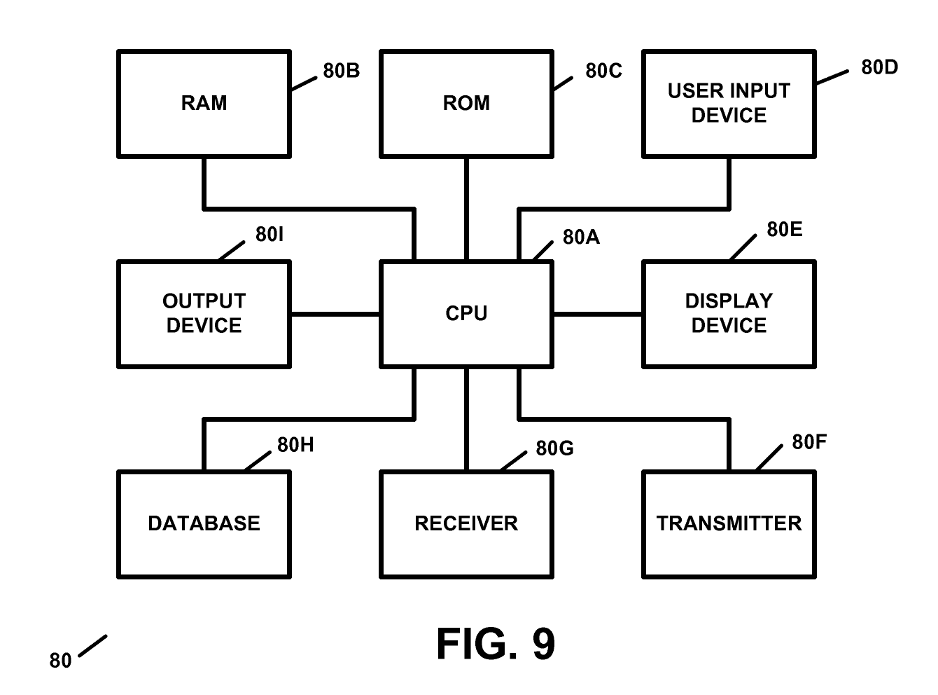

FIG. 9 illustrates the social networking computer 80, in block diagram form. The social networking computer 80, in the preferred embodiment, can be any social networking computer or computer system or any computer or computer system used by or associated with any social networking company or social networking website, or can be any suitable server computer or server computer system, a cloud computer or cloud computer system, a network computer or computer system, a personal computer, or any other computer or communication device, or any cellular telephone, tablet, personal digital assistant, wireless communication device or wireless computer, or any other communication device, which is utilized to function as a social networking computer 80. In a preferred embodiment, the social networking computer 80 can be any computer of computer system for providing the functionality described herein as being provided by the social networking computer 80 or any social networking computer or website.

The social networking computer 80 can be used by, maintained by, or associated with, a social networking company, website, or other entity, and/or can provide any of the herein-described social networking information, activities, and/or functionality, described herein as being provided via the apparatus 100 and method of the present invention and which can be provided by any social networking company, website, or other entity.

In the preferred embodiment, the social networking computer 80 includes a central processing unit or CPU 80A, which in the preferred embodiment, is a microprocessor. The CPU 80A may also be a microcomputer, a minicomputer, a macro-computer, and/or a mainframe computer, depending upon the application.

The social networking computer 80 also includes a random access memory device(s) 80B (RAM) and a read only memory device(s) 80C (ROM), each of which is connected to the CPU 80A, a user input device 80D, for entering data and/or commands into the social networking computer 80, which includes any one or more of a keyboard, a scanner, a user pointing device, such as, for example, a mouse, a touch pad, and/or an audio input device and/or a video input device, and/or any device, electronic and/or otherwise, which can be utilized for inputting and/or for entering data and/or information, which input device(s) is also connected to the CPU 80A. The social networking computer 80 also includes a display device 80E for displaying data and/or information to a user or operator.

The social networking computer 80 also includes a transmitter(s) 80F, for transmitting signals and/or data and/or information to any one or more of the central processing computer(s) 10, the provider communication device(s) 20, the payer communication device(s) 30, the user communication device(s) 40, the intermediary computer(s) 50, the healthcare records computer(s) 60, the insurance exchange computer(s) 70, any other social networking computer(s) 80, and/or the media computer(s) 90, described herein, which may be utilized in conjunction with the present invention. The social networking computer 80 also includes a receiver 80G, for receiving signals and/or data and/or information from any one or more of the central processing computer(s) 10, the provider communication device(s) 20, the payer communication device(s) 30, the user communication device(s) 40, the intermediary computer(s) 50, the healthcare records computer(s) 60, the insurance exchange computer(s) 70, any other social networking computer(s) 80, and/or the media computer(s) 90, described herein, which may be utilized in conjunction with the present invention.

The social networking computer 80 also includes a database(s) 80H. The database 80H can contain or include, and/or can be linked to, any of the data and/or information described herein as being stored in the database 10H, and/or can also contain any data and/or information typically found in, or utilized by, a social networking computer or any members of the social network serviced thereby, as well as any data and/or information typically utilized in providing or performing the functionality and/or services provided or offered by any social network associated with the social networking computer 80.

The social networking computer 80 also includes an output device 80I for outputting any data, information, report, etc., described herein. In the preferred embodiment, the output device 80I can be a printer, a display, a transmitter, a modem, and/or any other device which can be used to output data.

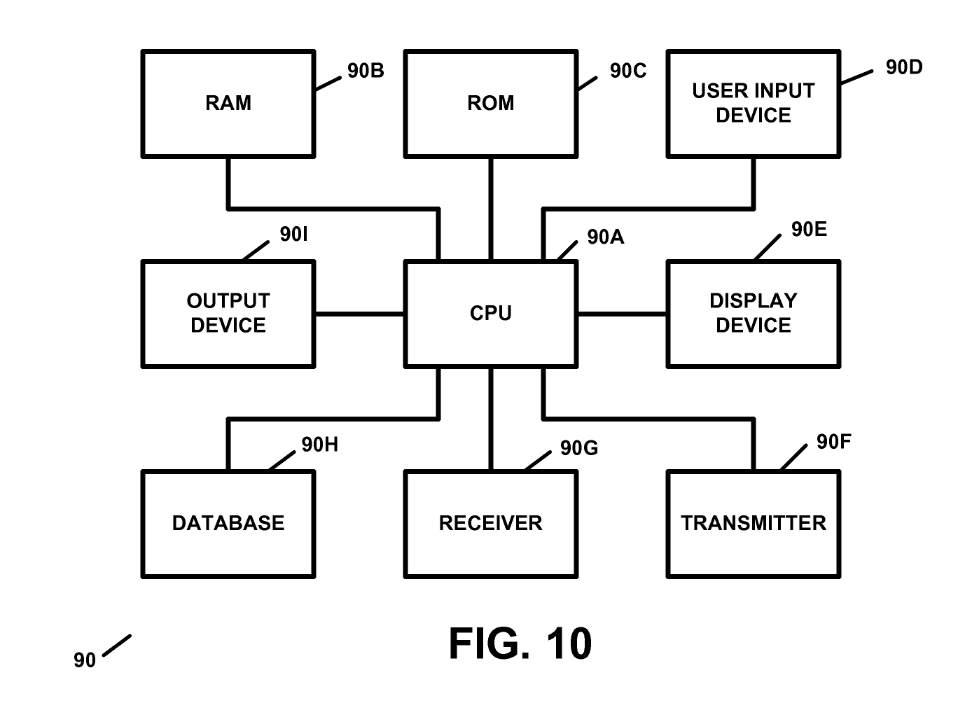

FIG. 10 illustrates the media computer 90, in block diagram form. The media computer 90, in the preferred embodiment, can be any computer or computer system used by or associated with any news information source, individual, company, or entity, or used by or associated with any external information source, media source, individual, company, or entity, or used by or associated with any advertiser or advertisement source, individual, company, or entity, or used by or associated with any marketing materials source, individual, company, or entity.

The media computer 90 can be any computer or computer system which can provide, to any of the herein-described users, individuals, patients, providers, payers, intermediaries, third parties, and/or entities who or which utilized the apparatus 100 and method of the present invention, any news, information, advertisements, or marketing materials, of any kind, nature, or type, which can include, but which is not limited to, any healthcare or healthcare-related news, information, advertisements, or marketing materials, any fitness or fitness-related news, information, advertisements, or marketing materials, any wellness or wellness-related news, information, advertisements, or marketing materials, as well as any non-healthcare or non-healthcare-related news, information, advertisements, or marketing materials. The media computer 90 can provide news, information, advertisements, or marketing materials, via the apparatus 100 and method of the present invention. In a preferred embodiment, the media computer 90 can be any computer or computer system for providing the functionality described herein as being provided by the media computer 90.

The media computer 90 can be used by, can be maintained by, or can be associated with, a media company or entity, a news service or organization, an information source or service, an advertiser, an advertisement company, agency, or entity, a marketer, a marketing company or entity, or any individual or entity which provides media, news, information, advertisements, or marketing materials, of, for, or on behalf of, themselves or another, The media computer 90 can provide any of the herein-described media, news, information, advertisements, or marketing materials, and/or any other information, and/or can provide any of the functionality described herein as being provided via the apparatus 100 and method of the present invention.

In the preferred embodiment, the media computer 90 includes a central processing unit or CPU 90A, which in the preferred embodiment, is a microprocessor. The CPU 90A may also be a microcomputer, a minicomputer, a macro-computer, and/or a mainframe computer, depending upon the application.

The media computer 90 also includes a random access memory device(s) 90B (RAM) and a read only memory device(s) 90C (ROM), each of which is connected to the CPU 90A, a user input device 90D, for entering data and/or commands into the media computer 90, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information which input device(s) are also connected to the CPU 90A. The media computer 90 also includes a display device 90E for displaying data and/or information to a user or operator.

The media computer 90 also includes a transmitter(s) 90F, for transmitting signals and/or data and/or information to any one or more of the central processing computer(s) 10, the provider communication device(s) 20, the payer communication device(s) 30, the user communication device(s) 40, the intermediary computer(s) 50, the healthcare records computer(s) 60, the insurance exchange computer(s) 70, the social networking computer(s) 80, and/or any other media computer(s) 90, described herein, which may be utilized in conjunction with the present invention. The media computer 90 also includes a receiver 90G, for receiving signals and/or data and/or information from any one or more of the central processing computer(s) 10, the provider communication device(s) 20, the payer communication device(s) 30, the user communication device(s) 40, the intermediary computer(s) 50, the healthcare records computer(s) 60, the insurance exchange computer(s) 70, the social networking computer(s) 80, and/or any other media computer(s) 90, described herein, which may be utilized in conjunction with the present invention.

The media computer 90 also includes a database(s) 90H. The database 90H can contain or include, and/or can be linked to, any of the data and/or information described herein as being stored in the database 10H, and/or can also contain or include any data and/or information typically found in or utilized by a media computer as well as any of the respective media, news, information, advertisements, or marketing materials, and/or any data and/or information typically utilized in providing or performing the functionality and/or services provided or offered by the media computer 90.

The media computer 90 also includes an output device 90I for outputting any data, information, report, etc., described herein. In the preferred embodiment, the output device 90I can be a printer, a display, a transmitter, a modem, and/or any other device which can be used to output data.

The apparatus and method of the present invention can be utilized in numerous preferred embodiments in order to provide a vast array of healthcare and healthcare-related services for any one or more of the various parties described herein. While certain of the preferred embodiments may be described with regards to utilization by a particular party, it is important to note that any individual, patient, user, provider, payer, and/or intermediary or third party, may utilize the present invention in the same, similar and/or analogous manner. For example, a preferred embodiment for determining and/or ascertaining a medical diagnosis can be described as being utilized by a treating physician as well as be utilized by a provider to verify and/or check a diagnosis as well as by an individual or patient, or any other user or individual in order to perform a self-diagnosis or double check a doctor's diagnosis. In the same manner, any of the preferred embodiments of the apparatus 100 and method of the present invention can be utilized by, or performed by, any of the providers, healthcare providers, insurers, payers, individuals, patients, caregivers, or intermediaries or third parties, described herein, or by any other parties described herein.

In a preferred embodiment, the apparatus 100 of the present invention can be utilized to create and maintain a comprehensive and/or a centralized electronic healthcare record system which can store and/or process genetic information or genetic-related information. It is understood that different providers and insurers or payers might utilize or employ any number or types or kinds of electronic healthcare records, electronic medical records, electronic dental records, electronic pharmacy records, and/or electronic behavioral healthcare records, each of which may be located in or on different computers or located at different physical locations, and that any individual, patient, or user, may have a healthcare or healthcare-related record, a healthcare or healthcare-related file, or a healthcare or healthcare-related history, on any one or more of these separate electronic healthcare records, electronic medical records, electronic dental records, electronic pharmacy records, and/or electronic behavioral healthcare records. It is also understood that each individual or patient may also have a personal health record stored or located on his or her user communication device 40.

In a preferred embodiment, any one or more of the healthcare records computers 60 can be associated with a different electronic healthcare record, electronic medical record, electronic dental record, electronic pharmacy record, and/or electronic behavioral healthcare record, or any number or combination of electronic healthcare records, electronic medical records, electronic dental records, electronic pharmacy records, and/or electronic behavioral healthcare records.

In a preferred embodiment, the database 10H can, for each individual or patient who utilizes the apparatus 100 and method of the present invention, contain any number of electronic healthcare records, electronic medical records, electronic dental records, electronic pharmacy records, and/or electronic behavioral healthcare records, containing data and/or information regarding the individual or patient, and/or the database 10H can contain any number of links or hyperlinks to any number of electronic healthcare records, electronic medical records, electronic dental records, electronic pharmacy records, and/or electronic behavioral healthcare records, which are located on healthcare records computers 60, or on any other computers, or computer systems, which are or may be separate and apart from the central processing computer 10 and which can also contain data and/or information for or regarding the individual or patient.

In a preferred embodiment, and in instances where an individual's or patient's healthcare-related records, healthcare or healthcare-related files, or healthcare or healthcare-related histories, are stored and/or located in different or separate electronic healthcare records, electronic medical records, electronic dental records, electronic pharmacy records, and/or electronic behavioral healthcare records, or stored or located on different or separate computers or computer systems, including, but not limited to, the central processing computer 10, healthcare records computers 60, or any other computers or computer systems, the apparatus 100, and in particular, the database 10H or the central processing computer can also contain an master individual or patient index containing, for each individual or patient, the individual's or patient's name, address, social security number or other uniquely assigned identification number or identifying data or information, mother's maiden name, name of spouse or partner, name(s) of child, children or others for who the individual or patient is responsible for providing care legally or otherwise, each electronic healthcare records, electronic medical records, electronic dental records, electronic pharmacy records, and/or electronic behavioral healthcare records, containing data and/or information regarding the individual or patient, or in or on which the individual or patient has a record, file, history, or entry, and/or a link(s) or hyperlink(s) to each electronic healthcare records, electronic medical records, electronic dental records, electronic pharmacy records, and/or electronic behavioral healthcare records, containing data and/or information regarding the individual or patient, or in or on which the individual or patient has a record, file, history, or entry.

In a preferred embodiment, the apparatus 100 and method of the present invention can be utilized in order to process diagnostic information, treatment information, or treatment planning information, and/or any other related data and/or information, with or using genetic information and/or genetic-related information in order to perform a diagnosis of, and/or to prescribe a treatment for, or to design or develop, a treatment plan for, a sickness, an illness, and/or a condition. In another preferred embodiment, the apparatus 100 of the present invention can also provide for automatic claim form generation and submission or request for payment form generation and submission via the central processing computer 10 once a final diagnosis and/or a treatment has been prescribed by a healthcare provider, and/or upon the occurrence of an examination and/or the administration of a treatment, or the performance of a procedure.

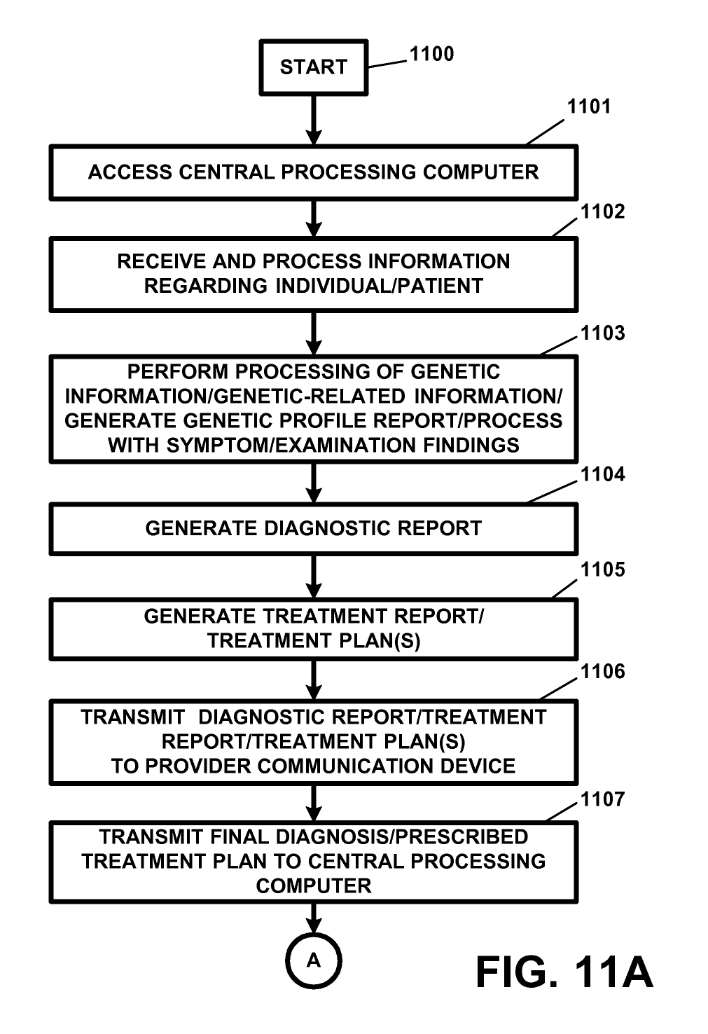

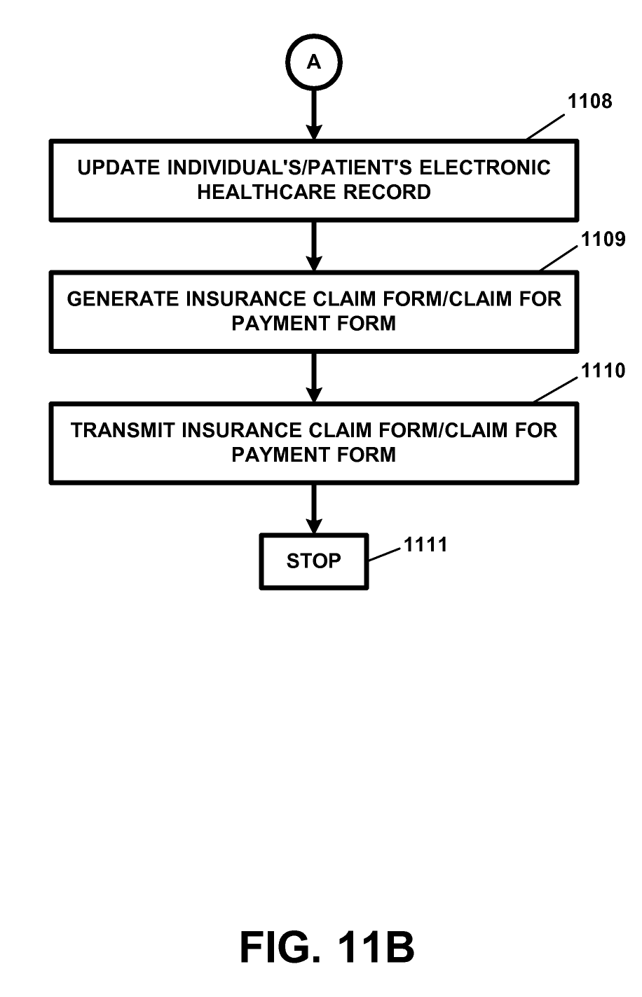

FIGS. 11A and 11B illustrate a preferred embodiment method of utilizing the apparatus 100 of the present invention, in flow diagram form. While the method of FIGS. 11A and 11B is described in the context of a medical doctor performing a diagnosis of, and/or prescribing a treatment or a treatment plan for, a medical condition, the method of FIGS. 11A and 11B can be utilized in a same, a similar, and/or an analogous, manner by any healthcare providers or providers described herein, including, but not limited to, physicians, medical doctors having any specialty, surgeons, dentists, orthodontists, periodontists, endodontists, oral surgeons, osteopaths, psychologists, optometrists, podiatrists, osteopaths, chiropractors, pharmacists, therapists, physical therapists, respiratory therapists, nurses, healthcare aids, nurse practitioners, physician's assistants, nutritionists, and/or any other person, individual, and/or professional, who can provide healthcare, healthcare-related, and/or wellness and/or wellness-related, services and/or products, or insurance companies, healthcare insurance companies, disability insurance companies, property or casualty insurance companies, health maintenance organizations, healthcare providers, and/or any other payer and/or provider of healthcare services and/or products, healthcare claims processing centers, healthcare insurance brokers and/or agents, and/or any other third party and/or intermediary who or which acts on behalf of another and/or who or which assists in the providing of healthcare and/or related services, and/or any other healthcare provider or healthcare professional described herein (hereinafter also referred to in this preferred embodiment as a “provider” or “user”).

The method of FIGS. 11A and 11B may also be utilized by any user, individual, patient, caregiver, provider, insurer, payer, and/or intermediary, in order to ascertain a diagnosis, a treatment, or a treatment plan and/or in order to check on, verify, and/or ascertain, the correctness of a diagnosis and/or to formulate, plan, check on, verify, and/or ascertain, the correctness of a diagnosis, a treatment, or a treatment plan. With reference to FIGS. 11A and 11B, the operation of the apparatus 100 commences at step 1100. At step 1101, the provider or other user can access the central processing computer via the provider communication device 20. At step 1101, information regarding the individual or the patient, which can include, but which is not limited to, the individual's or patient's symptoms, if any, and/or any examination findings or observations are or can be obtained from the individual or the patient, can be entered into the provider communication device 20, and can be transmitted from the provider communication device 20 to the central processing computer 10.

The central processing computer 10, or the CPU 10A, can, at step 1102, receive and/or process the information regarding the individual or the patient which can include the individual's or the patient's symptoms, if any, and/or the examination findings or observations, and can process same using or in conjunction with data and/or information contained in the individual's or the patient's genetic information and/or genetic-related information, which, in a preferred embodiment, can be stored in the individual's or the patient's electronic healthcare record or electronic healthcare file which is stored in the database 10H of the central processing computer 10, and/or with or using any healthcare or medical information, theories, principles, criteria, and/or any other healthcare information or medical information needed to make a diagnosis. In another preferred embodiment, the individual's or the patient's symptoms, if any, and/or the examination findings or observations, can be processed using or in conjunction with the genetic information or genetic-related information of or regarding the individual's or the patient's family member(s), parent(s), sibling(s), child or children, or any person(s) having a blood relationship or bloodline relationship with the individual, which, in a preferred embodiment can also be stored in, contained in, or linked to, the individual's or the patient's electronic healthcare record or electronic healthcare file, and/or with or using any healthcare or medical information, theories, principles, criteria, and/or using any other healthcare information or medical information needed to make a diagnosis.

In the preferred embodiment of FIGS. 11A and 11B, the individual's or the patient's genetic information or genetic-related information can be obtained from a testing or an analysis of the DNA of the individual or the patient. In the preferred embodiment of FIGS. 11A and 11B, the genetic information or genetic-related information of the individual's or the patient's family member(s), parent(s), sibling(s), child or children, or any person(s) having a blood relationship or bloodline relationship with the individual, if available, can also be obtained from a testing or an analysis of the DNA of the individual's or the patient's family member(s), parent(s), sibling(s), child or children, or any person(s) having a blood relationship or bloodline relationship with the individual. In this regard, in the preferred embodiment of FIGS. 11A and 11B, the genetic material from which the genetic information or the genetic-related information was obtained is DNA. Although the genetic information or the genetic-related information utilized in the preferred embodiment of FIGS. 11A and 11B is obtained from DNA, it is important to note that the genetic information or the genetic-related information can also be obtained from any other genetic material, such as, but not limited to, RNA, chromosomes, genes, or plasmids, or any other material containing genetic information or genetic matter or heritable biological information.

At step 1103, the central processing computer 10, or the CPU 10A, can perform a diagnostic evaluation of the individual or the patient. In a preferred embodiment, at step 1103, the central processing computer 10, or the CPU 10A, can perform a diagnostic evaluation of the individual or the patient by using the genetic information or genetic-related information obtained from the individual's or the patient's DNA or DNA information. At step 1103, the central processing computer 10, or the CPU 10A, can process the individual's or the patient's genetic information or genetic-related information obtained from the individual's or the patient's DNA, or DNA information, in order to ascertain the presence or the absence of a variation(s) or mutation(s), or any carrier status, in, on, or regarding, the individual's or the patient's DNA. At step 1103, the central processing computer 10, or the CPU 10A, can also process the genetic information or the genetic-related information obtained from DNA, of the individual's or the patient's family member(s), parent(s), sibling(s), child or children, or any person(s) having a blood relationship or bloodline relationship with the individual or the patient, if same is available, in order to also ascertain the presence or the absence of a variation(s) or mutation(s), or any carrier status, in, on, or regarding, the individual's or the patient's DNA.

At step 1103, the central processing computer 10, or the CPU 10A, can also process the individual's or the patient's genetic information or genetic-related information obtained from the individual's or the patient's DNA, or DNA information, in order to ascertain the presence or the absence of any gene, genes, or genetic marker(s) or indicator(s), or any variation(s) or mutation(s) of same, or any carrier status, in or regarding, the individual's or the patient's DNA. At step 1103, the central processing computer 10, or the CPU 10A, can also process the genetic information or genetic-related information obtained from DNA of the individual's or the patient's family member(s), parent(s), sibling(s), child or children, or any person(s) having a blood relationship or bloodline relationship with the individual or the patient, in order to ascertain the presence or the absence of any gene, genes, or genetic marker(s) or indicator(s), or any variation(s) or mutation(s) of same, or any carrier status, in or regarding, the DNA of the individual's or the patient's family member(s), parent(s), sibling(s), child or children, or any person(s) having a blood relationship or bloodline relationship with the individual or the patient.

At step 1103, the central processing computer 10, or the CPU 10A, can also process the individual's or the patient's genetic information or genetic-related information obtained from the individual's or the patient's DNA, or DNA information, in order to ascertain the presence or the absence of a gene or genes, or genetic marker(s) or indicator(s), which presence or absence is or may be medically or scientifically believed to cause, to be the cause of, or to be associated with, a disease, a disorder, a condition, a sickness, a syndrome, or a cancer, and/or to ascertain the presence or the absence of a gene or genes, or genetic marker(s) or indicator(s), which can or may be associated with a statistical or a statistically increased probability or risk of developing or getting a disease, a disorder, a condition, a sickness, a syndrome, or a cancer.

At step 1103, the central processing computer 10, or the CPU 10A, can also process the genetic information or genetic-related information obtained from DNA, or DNA information, of the individual's or the patient's family member(s), parent(s), sibling(s), child or children, or any person(s) having a blood relationship or bloodline relationship with the individual or the patient, in order to ascertain the presence or the absence of a gene or genes, or genetic marker(s) or indicator(s), which presence or absence is or may be medically or scientifically believed to cause, to be the cause of, or to be associated with, a disease, a disorder, a condition, a sickness, a syndrome, or a cancer, and/or to ascertain the presence or the absence of a gene or genes, or genetic marker(s) or indicators(s), which can or which may be associated with a statistical or a statistically increased probability or risk of developing or getting a disease, a disorder, a condition, a sickness, a syndrome, or a cancer.

At step 1103, the central processing computer 10, or the CPU 10A, can also ascertain, for each occurrence of a detected presence or absence of the gene, genes, or genetic marker(s) or indicator(s), in the individual's or the patient's genetic information or genetic-related information, or DNA information, and/or, if available and if utilized, in the genetic information or genetic-related information, or DNA information, of the individual's or the patient's family member(s), parent(s), sibling(s), child or children, or any person(s) having a blood relationship or bloodline relationship with the individual or the patient, any corresponding disease(s), disorder(s), condition(s), sickness(es), syndrome(s), or cancer(s), and any symptoms, conditions, or any other information, associated with same.

At step 1103, the central processing computer 10, or the CPU 10A, can also detect, identify, or ascertain, any genetic abnormalities present in the individual's or the patient's genetic information or genetic-related information, or DNA information, and/or, if available and if utilized, in the genetic information or genetic-related information, or DNA information, of the individual's or the patient's family member(s), parent(s), sibling(s), child or children, or any person(s) having a blood relationship or bloodline relationship with the individual or the patient, and the central processing computer 10, and/or the central processing computer 10, or the CPU 10A, can process information regarding same so as to compare any disease(s), disorder(s), condition(s), sickness(es), syndrome(s), or cancer(s), associated with same, and any symptoms, conditions, or any other information, associated with same, with or against any of the individual's or the patient's symptoms and/or examination findings and/or any observations.

At step 1103, the central processing computer 10 can also generate a genetic profile report or data file containing any data and/or information obtained or gathered at steps 1101, 1102, and/or 1103, and/or previously, and/or any data and/or information regarding any and/or each detected presence or absence of any gene, genes, or genetic marker(s) or indicator(s), and any data and/or information regarding any corresponding disease(s), disorder(s), condition(s), sickness(es), syndrome(s), or cancer(s), and any symptoms, conditions, or any other information, related or associated with same, which was detected in the individual's or the patient's genetic information or genetic-related information, or DNA information, and/or, if utilized, any data and/or information regarding any and/or each detected presence or absence of any gene, genes, or genetic marker(s) or indicator(s), and any data and/or information regarding any corresponding disease(s), disorder(s), condition(s), sickness(es), syndrome(s), or cancer(s), and any symptoms, conditions, or any other information, related or associated with same, which was detected in the DNA information of the individual's or the patient's family member(s), parent(s), sibling(s), child or children, or any person(s) having a blood relationship or bloodline relationship with the individual or the patient.

At step 1103, the central processing computer 10, or the CPU 10A, can also process the information regarding the individual's or the patient's symptoms and/or examination findings or observations in conjunction with any data and/or information contained in the genetic profile report or data file in order to ascertain if the symptoms and/or examination findings or observations, which were entered by the provider at step 1101, match or coincide with, any of the symptoms, conditions, or any other information, associated with each detected disease, disorder, condition, sickness, syndrome, or cancer.

At step 1104, the central processing computer 10 can also generate a diagnostic report which can include a diagnosis of the individual's or the patient's condition as well as any other data and/or information regarding each detected presence or absence of the gene, genes, or genetic marker(s) or indicator(s), and any corresponding disease(s), disorder(s), condition(s), sickness(es), syndrome(s), or cancer(s), associated with same, along with any corresponding symptoms, conditions, or any other information, associated with same. The diagnostic report can also include the genetic profile report or data file and/or any data and/or information which is or which can be contained in the genetic profile report or data file. The diagnostic report, which is generated at step 1104, can include a single diagnosis and/or a list of possible diagnoses, along with their respective probabilities of accurateness, which may pertain to the individual's or the patient's condition.

At step 1105, the central processing computer 10 can then generate a treatment report which can or which will outline and/or prescribe a treatment(s) for the single diagnosis and/or a treatment(s) for each of the diagnoses in list of possible diagnoses. At step 1105, the central processing computer 10 can also generate a treatment plan for the diagnosis or for each diagnosis in the list of diagnoses. In a preferred embodiment, the central processing computer 10, or the CPU 10A, when generating the treatment report and the treatment plan, or each treatment report or each treatment plan, can also process any information regarding or contained in same in conjunction with information regarding any possible drug interactions and/or treatment interactions, and/or individual or patient allergies, as well as any treatments, medications, therapies, or tests, or any other activities, which might prove to be harmful to the individual or the patient. In a preferred embodiment, the treatment report and/or the treatment plan can also contain, for each course of treatment associated with each treatment plan, an estimate of the total cost for or corresponding to same.

In a preferred embodiment, the treatment report and/or the treatment plan can include information regarding a plan of treatment, including, but not limited to, any and/or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan, which are or might be called for by a respective treatment report or treatment plan, along with the costs or prices of each and the total cost or price of the treatment or treatment plan.

For example, for a given course of treatment associated with a treatment plan, the treatment report and/or the treatment plan can contain an estimate of the cost or price associated with any and/or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan.

In a preferred embodiment, as well as in any and/or all of the embodiments described herein, any of the herein-described healthcare providers, providers, hospitals, healthcare facilities, therapists, pharmaceutical companies, laboratories, testing services, genetic testing services, any providers of any goods, products, or services, and/or any intermediaries of any kind or type, pharmaceutical companies, laboratories or testing entities or services, genetic testing services, and/or any other providers of goods, products, and/or services, and/or any other intermediaries, can access the central processing computer 10 at any time using his, her, or its, respective provider communication device 20 or intermediary communication device 50, and can transmit or upload to the central processing computer 10 his, her, or its, respective pricing schedules or price lists for the various services, goods, and/or products, that he, she, or it, provides. The pricing schedules or prices lists can be stored in the database 10H of the central processing computer 10 and can be utilized in estimating the costs of any of the treatment plans generated by the apparatus 100 and method of the present invention.

In a preferred embodiment, once a treatment plan has been configured, the total estimated cost or price of all costs for any and or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan can be calculated in order to provide an estimated cost of the treatment plan. In a preferred embodiment, any pricing schedules or price lists can also be updated or changed at any time.

In a preferred embodiment, the treatment report and/or the treatment plan can also include or contain the genetic profile report or data file and/or any data and/or information which is or which can be contained in the genetic profile report or data file.

In a preferred embodiment, the treatment report and/or the treatment plan can also include estimated costs of a treatment plan for and/or involving different providers within a same geographical locale or location. In a preferred embodiment, the treatment report and/or the treatment plan can also include estimated costs of a treatment plan for and/or in a number of different locales which can be domestic or foreign. For example, for an individual or patient living in and/or expecting to be treated in the New York City metropolitan area, the treatment plan can, for example, include estimates of the costs of the treatment plan in the New York City metropolitan area, as well as in a number of other locations across the United States, such as, for example, but not limited to, Philadelphia, Pa., Los Angeles, Calif., Miami, Fla., Boston, Mass., Seattle, Wash., or any other location or locale in the Untied States which may be deemed to be a location or locale where expertise exists for implementing and/or executing the treatment plan.

In another preferred embodiment, the treatment report and/or the treatment plan can also include estimated costs of a treatment plan for and/or in a number of locations or locales in foreign countries or abroad. For example, for an individual or patient living in and/or expecting to be treated in the New York City metropolitan area, the treatment plan can, for example, include, but not be limited to having. estimates of the costs of the treatment plan if treatment were to occur in London, England, Rome, Italy, Lisbon, Portugal, Ottawa, Canada, Rio De Janeiro, Brazil, or in any other location or locale outside the United States, which may be deemed to be a location or locale where expertise exists for implementing and/or executing the treatment plan.

By providing cost estimates associated with the costs of a treatment plan, the individual or the patient, his or her caregiver, his or her provider(s), and/or his or her insurer or payer, can utilize same to make informed decisions regarding treatment. Providing estimates associated with the costs of a treatment plan can also lend itself for use in managing healthcare costs and in making decisions regarding cost planning, cost analysis, cost containment, and/or cost optimization.

In another preferred embodiment, the treatment report and/or the treatment plan, or each treatment report or treatment plan corresponding to each possible diagnosis, can also contain or include information regarding, and/or a link(s) or a hyperlink(s) to, a provider communication device 20 of each of the individual's or the patient's healthcare providers or doctors and/or to healthcare providers or doctors identified as being able to treat the individual or the patient, so that the individual or the patient, or a caregiver, can contact or communicate with a respective healthcare provider or doctor, or so that the individual or the patient, or a caregiver, can schedule an appointment with the healthcare provider or doctor via the central processing computer 10 or otherwise, or so that the individual or the patient can utilize the information or the link(s) or hyperlink(s) for any other appropriate reason.

In another preferred embodiment, the treatment report and/or the treatment plan, or each treatment report or treatment plan corresponding to each possible diagnosis, can also contain or include information regarding, and/or a link(s) or a hyperlink(s), to an insurer communication device 30 of each insurer or payer of the individual or patient so that the individual or the patient, or a caregiver, can contact or communicate with a respective healthcare insurer or payer, so that the individual or the patient can submit an insurance claim to the insurer or payer via the central processing computer 10 or otherwise, so that the individual or the patient can submit a pre-authorization request to the insurer or payer, or so that the individual or the patient can utilize the information or the link(s) or hyperlink(s) for any other appropriate reason.

In another preferred embodiment, the treatment report and/or the treatment plan, or each treatment report or treatment plan corresponding to each possible diagnosis, can also contain or include information regarding, and/or a link(s) or a hyperlink(s), to the central processing computer 10 and/or to the healthcare records computer 60 so that the individual or the patient can access his or her electronic healthcare record(s) or any portion of same. In another preferred embodiment, the treatment report and/or the treatment plan, can also contain or include information regarding, and/or a link(s) or a hyperlink(s), to the insurance exchange computer 70 so that the individual or the patient can access the insurance exchange computer 70 in order file a healthcare insurance claim, check on the status of a healthcare insurance claim, or purchase a healthcare or other insurance policy.

In another preferred embodiment, the treatment report and/or the treatment plan, or each treatment report or treatment plan corresponding to each possible diagnosis, can also contain or include information regarding, and/or a link(s) or a hyperlink(s), to a social networking computer 80 and/or to any social networking web site or web pages, and/or to or for any social networking members, support groups, social networking support group members, on-line seminars, social networking lectures, classes, or seminars, social networking sponsored lectures, classes, or seminars, social networking discussions, question and answer sessions, or informational or other forums, or any other social networking or social networking sponsored activities or events, forums, chat room discussions, or any other information providing sources, with which or with whom the individual or the patient may engage. The providing of the social networking information to the individual or the patient can serve to allow the individual or the patient to learn more about a diagnosis, a treatment, or a treatment plan, or to interact with others who have been diagnosed with the same or a similar ailment, illness, sickness, or condition, or to interact with others who may be undergoing the same or a similar treatment, or who may be following a same or a similar treatment plan.

In another preferred embodiment, the treatment report and/or the treatment plan, or each treatment report or treatment plan corresponding to each possible diagnosis, can also contain or include information regarding, and/or a link(s) or a hyperlink(s), to a media computer 90 so that the individual or the patient can access news articles or other information regarding his or her diagnosis and/or treatment plan.

In a preferred embodiment, any of the herein-described diagnostic reports, treatment reports, or treatment plans, can also include or can contain data and/or information stored in the individual's or the patient's electronic healthcare record, a link(s) or a hyperlink(s) to data and/or information stored in the individual's or the patient's electronic healthcare record, any notes, comments, or messages, entered by the individual or the patient, or by a caregiver, or by a provider, into the individual's or the patient's electronic healthcare record, and/or any link(s) or hyperlink(s) to any notes, comments, or messages, entered by the individual or the patient, or by a caregiver, or by a provider, into the individual's or the patient's electronic healthcare record.

At step 1106, the central processing computer 10 will transmit the diagnostic report and/or the treatment report and/or the treatment plan(s) for the diagnosis or for each of the possible diagnoses to the provider's provider communication device 20, at which point the provider, or the healthcare provider or medical doctor, can obtain the diagnosis or list of possible diagnoses and the corresponding treatment report(s) or treatment plan(s) for same. The provider, or the healthcare provider or medical doctor, can then review the diagnostic report and/or the treatment report(s) and/or the treatment plan(s), and choose, select, or decide upon, a final diagnosis and/or a prescribed treatment plan to administer to the individual or the patient.

At step 1107, the provider, or the healthcare provider or medical doctor, will transmit the final diagnosis and the prescribed treatment or prescribed treatment plan, including the prescribed treatment and/or the treatment plan corresponding to same, to the central processing computer 10. In another preferred embodiment, at step 1107, the provider, or the healthcare provider or medical doctor, or any other provider using the apparatus 100, can also generate and/or transmit a prescription or an electronic prescription for a medication, a medicine, or a drug, or for a procedure, a test, an analysis, an analysis work-up, blood work, a DNA test, a DNA analysis, a genetic material test, a genetic material analysis, a treatment, or a therapy, or can generate and/or transmit a referral to another provider, for submission or transmission to the respective pharmacy or other provider, and for storage in the individual's, the patient's electronic healthcare record or electronic healthcare file.

In another preferred embodiment, the final diagnosis, along with the prescribed treatment plan, and the diagnostic report, the treatment report, and/or the treatment plan, generated for and corresponding to same, and/or the genetic profile report or data file, can also be transmitted by the central processing computer 10, at step 1107, to the provider communication device 20 associated with or used by the provider for the provider's records, to a provider communication device 20 associated with or used by another provider of the individual or the patient, to a payer or insurer communication device 30 associated with or used by the insurer or payer of the individual or the patient, to the user communication device 40 associated with or used by the individual or the patient, or a caregiver, or to an intermediary communication device 50 associated with or used by a third party or an intermediary.

In a preferred embodiment, the central processing computer 10 can transmit the final diagnosis along with the prescribed treatment plan, and the diagnostic report, the treatment report, and/or the treatment plan, generated for and corresponding to same, and/or the genetic profile report or data file, to a respective provider communication device 20, to a respective insurer or payer communication device 30, to a respective user communication device 40, or to a respective intermediary communication device 50, either directly, such as via any suitable electronic or other transmission, or indirectly, such as via an e-mail server in the case when the final diagnosis and/or the prescribed treatment plan, and the diagnostic report, the treatment report, and/or the treatment plan, generated for and corresponding to same, can be included in, or can be attached to, an e-mail message or a text message, or any other electronic communication or transmission.

In a preferred embodiment, the final diagnosis along with the prescribed treatment plan, and the diagnostic report, the treatment report, and/or the treatment plan, generated for and corresponding to same, or a respective copy of same, and/or the genetic profile report or data file, can be data-stamped and/or time-stamped.

In a preferred embodiment, the final diagnosis along with the prescribed treatment plan, and the diagnostic report, the treatment report, and/or the treatment plan, generated for and corresponding to same, or a respective copy of same, and/or the genetic profile report or data file, can also be stored by and/or in the database 20H of the respective provider communication device(s) 20, in the database 30H of respective insurer or payer communication device(s) 30, in the database 40H of the respective user communication device(s) 40, in the database 50H of the respective intermediary communication device(s) 50, in the database 60H the healthcare records computer 60, and/or in the database 70H of the insurance exchange computer 70.

In a preferred embodiment, once the central processing computer 10 has received the final diagnosis and the prescribed treatment or prescribed treatment plan from the provider communication device 20, at step 1107, the central processing computer 10, and/or the CPU 10A, can be automatically programmed to generate and transmit reminder messages to the provider and/or to the individual or the patient, or to a caregiver, and/or to any of other providers, or insurers, or intermediaries, so as to ensure that the prescribed treatment plan is followed until a new prescribed treatment plan is received by the central processing computer 10. In this regard, the central processing computer 10, or the CPU 10A, can be programmed so as to become automatically programmed with or by the prescribed treatment plan, upon the receipt of the prescribed treatment plan, so as to follow and/or to monitor the prescribed treatment plan. In this regard, in the preferred embodiment, the central processing computer 10, or the CPU 10A, can be programmed to automatically generate a respective alert message(s), reminder message(s), or any other type or kind of message(s), and to transmit same to the user communication device 40 of or associated with the individual or the patient, or a caregiver, to the provider communication device 20 of or associated with the provider or any provider involved in the prescribed treatment plan, or to any other provider of the individual or the patient, to the insurer communication device 30 of or associated with an insurer or payer of the individual or the patient, or to an intermediary communication device 50 of or associated with an intermediary involved in the prescribed treatment plan.

After the central processing computer 10, or the CPU 10A, has been programmed with the prescribed treatment plan, the central processing computer 10, or the CPU 10A, will automatically generate and/or transmit to a respective communication device of or associated with the individual, the patient, or a caregiver of same, and/or to any of the providers, insurers, or intermediaries, involved in the prescribed treatment plan, any and/or all applicable appointment scheduling and/or reminder messages, testing scheduling and/or reminder messages, procedure scheduling and/or reminder messages, surgical or other treatment administration scheduling and/or reminder messages, therapy scheduling and/or reminder messages, prescriptions for drugs or mediations and/or for testing and/or genetic testing, scheduling and/or reminder messages, prescription refill or reorder scheduling and/or reminder messages, messages reminding the individual or the patient to take a drug or medication at a scheduled time interval, and/or follow-up office visit or doctor visit reminder messages, and/or any other message(s), alert message(s), or reminder message(s), deemed needed or desired for ensuring that the prescribed treatment plan is followed.

In a preferred embodiment, any message(s) described herein can contain a link or a hyperlink to a respective party so as to facilitate communication with same. As and for some examples, a reminder message sent to inform or remind the individual or the patient to schedule an appointment with a provider can contain a link to the provider's appointment schedule so that the individual or the patient can, via the central processing computer 10, easily make the appointment directly from, and using information contained in the message, or a reminder message for the individual or the patient to undergo a test or a procedure can contain a link to the facility where the test or the procedure is to be undertaken or performed, or a reminder message for a provider to refill a prescription medication can contain a link to the individual's or the patient's pharmacy, or a prescription for a genetic test to be performed on the individual's or the patient's DNA can contain a link to a genetic testing service or laboratory and/or to the individual's or the patient's electronic medical record to which the genetic test results and/or analysis can be transmitted, and the list of examples can go on and on.

In a preferred embodiment, the final diagnosis along with the prescribed treatment plan, and the diagnostic report, the treatment report, and/or the treatment plan, generated for and corresponding to same, and/or the genetic profile report or data file, or a respective copy of same, can also be transmitted to and/or stored by or in the individual's or the patient's electronic healthcare record in the database 10H of the central processing computer 10, in the database 20H in the provider communication device 20, in the database 30H of the payer communication device 30, in the database 40H of the user communication device 40, or in the individual's, the patient's, or the caregiver's, electronic healthcare record in the database 60H of the healthcare records computer 60, or in the database 70H of the insurance exchange computer 70.

In another preferred embodiment, the final diagnosis along with the prescribed treatment plan, and the diagnostic report, the treatment report, and/or the treatment plan, generated for and corresponding to same, and/or the genetic profile report or data file, can also contain individual-specific or patient-specific educational information or individual-specific or patient-specific instructional information, or a link(s) or a hyperlink(s) to same, regarding the diagnosis, the treatment, or the treatment plan, or information relating thereto, so as to provide educational information or instructional information to the individual or the patient. The individual or the patient, or a caregiver, can thereafter access or obtain the educational information or instructional information via the apparatus 100 and method of the apparatus 100 of the present invention. In this manner, the apparatus 100 and method of the present invention can provide individual-specific or patient-specific educational information or individual-specific or patient-specific instructional information regarding the diagnosis, the treatment, or the treatment plan.

In another preferred embodiment, the apparatus 100 or the central processing computer 10 can be programmed to identify the individual-specific or patient-specific educational information or individual-specific or patient-specific instructional information regarding the diagnosis, the treatment, or the treatment plan, and/or any information, link(s), or hyperlink(s) relating thereto or pertaining thereto.

At step 1108, the central processing computer 10, or the CPU 10A, will then update the individual's or the patient's electronic healthcare record in the database 10H so as to include all of the data and information described as being processed and/or generated by the central processing computer 10, or the CPU 10A, including, but not limited to the individual's or the patient's symptoms or examination findings or any observations, the genetic profile report or data file, the final diagnosis, the prescribed treatment plan, the diagnostic report(s), the treatment report(s), and/or the treatment plan(s) described as being generated herein, and/or any data and/or information contained in or regarding the final diagnosis along with the prescribed treatment plan, and the diagnostic report(s), the treatment report(s), and/or the treatment plan(s), generated for and/or corresponding to same.

Thereafter, at step 1109, the central processing computer 10, or the CPU 10A, will generate an insurance claim form or a request for payment form (hereinafter “claim form”) which can meet the formal claim submission requirements of the individual's or the patient's insurer, insurance company, or payer. In a preferred embodiment, the claim form can include or can contain any data and/or information which is stored in individual's or the patient's electronic healthcare record, a link(s) or a hyperlink(s) to the individual's or the patient's electronic healthcare record, a link(s) or a hyperlink(s) to any data and/or information stored in the individual's or the patient's electronic healthcare record, any notes, comments, or messages, entered by the individual, the patient, or a caregiver, or a provider, into the individual's or the patient's electronic healthcare record, and/or any link(s) or hyperlink(s) to any notes, comments, or messages, entered by the individual, the patient, or a caregiver, or a provider, into the individual's or the patient's electronic healthcare record. In this regard, in a preferred embodiment, any data and/or information contained or included in the individual's or the patient's electronic healthcare record can be readily available to and/or can be readily accessible to or by any insurer or payer, or any employee or agent of same, or by any other user, person, or entity, who or which reviews the claim form or is to review the claim form.

In a preferred embodiment, the claim form can also contain or include, or contain a link(s) or a hyperlink(s) to the genetic profile report or data file, the final diagnosis, the prescribed treatment plan, the diagnostic report(s), the treatment report(s), and/or the treatment plan(s) described as being generated herein, and/or any data and/or information contained in or regarding the final diagnosis along with the prescribed treatment plan, and the diagnostic report(s), the treatment report(s), and/or the treatment plan(s), generated for and/or corresponding to same.

At step 1110, the claim form can be automatically transmitted or submitted by or from the central processing computer 10 to the respective insurer or payer communication device 30 of the respective insurer or payer of the individual or the patient. In another preferred embodiment, the claim form, or a copy of same, can also be transmitted by the central processing computer 10, at step 1110, to the provider, to the individual or the patient, or to a third party or intermediary, by transmitting the claim form, or a copy of same, and/or any of the herein-described included or attached information, to a respective provider communication device 20 associated with or used by the provider or any other provider of the individual or patient, to a respective user communication device 40 associated with or used by the individual or the patient, or to a respective intermediary communication device 50 associated with or used by an intermediary or third party, either directly, such as via any suitable electronic or other transmission, or indirectly, such as via an e-mail server in the case when the copy of the claim form is included in, or is attached to, an e-mail message or a text message.

The claim form, or a copy of same, can also be stored by and/or in the respective provider communication device 20, the respective user communication device 40, or the respective intermediary communication device 50. The claim form, or a copy of same, can also be transmitted to and/or stored by and/or in the healthcare records computer 60 and/or by and/or in the insurance exchange computer 70.

At step 1110, the claim form, or a copy of same, and/or any and/or all pertinent information regarding the claim form, the claim submission, the date and/or the time of same, the individual, the patient, the provider visit, and/or any diagnoses and/or treatments considered, the final diagnosis and/or the prescribed treatment, any diagnostic report(s), treatment report(s), and/or treatment plan(s), and/or the genetic profile report or data file, can also be stored and the individual's or the patient's electronic healthcare record in the database 10H of the central processing computer 10, and/or can be transmitted to and/or stored in the user communication device 40 where it can be stored in the individual's or the patient's electronic healthcare record in the database 40H of same, and/or can be transmitted to and/or stored in healthcare records computer 60 where it can be stored in the individual's or the patient's electronic healthcare record in the database 60H of same, and/or can be transmitted to and/or stored in database 70H of the insurance exchange computer 70. Any data and/or information contained in the individual's or the patient's electronic healthcare record in the database 10H of the central processing computer 10, in the database 40H of the user or patient communication device 40, and/or in the database 60H of the healthcare records computer 60 can then be automatically updated and can be available for the individual's or the patient's, next office visit, treatment and/or diagnosis.

In another preferred embodiment, the apparatus 100 or the central processing computer 10 can be programmed to identify the individual-specific or patient-specific educational information or individual-specific or patient-specific instructional information regarding the diagnosis, the treatment, the treatment plan, and/or the genetic profile report or file, and/or any information, link(s), or hyperlink(s) relating thereto or pertaining thereto.

In another preferred embodiment, the claim form or the claim submission can be date-stamped and/or time-stamped so that the claim processing corresponding to same can be tracked or monitored so as to facilitate audits of the insurer or payer or insurance company in order to ascertain if the insurer or payer or insurance company is properly and/or efficiently handling a claim or claims for the individual or patient and/or if the insurer or payer or insurance company is in compliance with any laws, rules, or regulations, governing claims processing and/or handling. Information regarding the date stamped and/or time stamped claim forms or claims, including the insurer's or the payer's, or the insurance company's, processing or handling of same, and the response or reply to same, can also be stored in the individual's or the patient's electronic healthcare record in the database 10H of the central processing computer 10, and/or in the database 10H of the central processing computer 10, and can be accessed and/or obtained by any authorized user or entity. In this manner, the apparatus 100 of the present invention can also be used in order to ascertain information regarding the processing and/or handling of claims or claim forms by a respective insurer or payer or insurance company for any individual or patient, or for any group or groups of individuals or patients.

The operation of the apparatus 100 will then cease at step 1111.

It is important to note that, notwithstanding or in spite of the ceasing of the operation of the apparatus 100 at step 1111, the central processing computer 10, or the CPU 10A, will continue to operate, as programmed at step 1107, and until or unless otherwise reprogrammed, in order to generate and transmit the herein-described reminder messages to the provider and/or to the individual or the patient, or to a caregiver, as described herein, so as to ensure that the prescribed treatment plan is followed until a new prescribed treatment plan is received by the central processing computer 10. In this regard, the central processing computer 10, or the CPU 10A, will continue to automatically generate a respective alert message(s), reminder message(s), or any other type or kind of message(s), and to transmit same to the user communication device 40 of or associated with the individual or the patient, or a caregiver, to the provider communication device 20 of or associated with the provider or any provider involved in the prescribed treatment plan, or to any other provider of the individual or the patient, to the insurer communication device 30 of or associated with an insurer or payer of the individual or the patient, or to an intermediary communication device 50 of or associated with an intermediary involved in the prescribed treatment plan.

In this regard, the central processing computer 10, or the CPU 10A, will continue to automatically generate and/or transmit to a respective communication device of or associated with the individual, the patient, or a caregiver of same, and/or to any other providers, or insurers, or intermediaries, involved in the prescribed treatment plan, any and/or all applicable appointment scheduling and/or reminder messages, testing scheduling and/or reminder messages, procedure scheduling and/or reminder messages, surgical or other treatment administration scheduling and/or reminder messages, therapy scheduling and/or reminder messages, prescriptions for drugs or mediations and/or for testing and/or genetic testing, scheduling and/or reminder messages, prescription refill or reorder scheduling and/or reminder messages, messages reminding the individual or the patient to take a drug or medication at a scheduled time interval, and/or follow-up office visit or doctor visit reminder messages, and/or any other message(s), alert message(s), or reminder message(s), deemed needed or desired for ensuring that the prescribed treatment plan is followed.

In another preferred embodiment, the claim form transmitted to the insurer or payer computer 30 can have attached thereto, or can include, a link(s) or a hyperlink(s) to the individual's or the patient's electronic healthcare record, and/or any notes, comments, or messages, entered by an the individual or the patient, a caregiver, or the provider, into the electronic healthcare record. In another preferred embodiment, the claim form transmitted to the insurer or payer computer 30 can also have attached thereto, or can include, or can include a link(s) or a hyperlink(s) to, the individual's or the patient's genetic information or the genetic-related information or the genetic profile report or file which was used in performing the diagnosis, as well as any x-ray, x-rays, lab result or lab results, MRI image, MRI images, CAT scan image, PET scan image, provider notes, individual, patient, or caregiver, records or information, individual, patient, or caregiver, provided information, and/or any other information which can be obtained by or with any healthcare, medical, or dental, equipment or device, or any other information which may be requested of, or obtained from, a provider or which may be used by an insurer or payer or insurance company in processing, investigating, or evaluating, a claim submission.

In this regard, the claim form can also, for example, contain or include, or can have attached thereto, or can contain a link or links to or a hyperlink or hyperlinks to, the individual's or the patient's genetic information or the genetic-related information or genetic profile report(s) or file(s) which was used in performing the diagnosis and/or any digital representation of same, a digital or electronic copy of an x-ray or copies of x-rays, an MRI image or MRI images, a CAT scan image or CAT scan images, a PET scan image or images, a copy of any other type of image obtained from any type of healthcare equipment or device, a test result or test results, a blood pressure reading or blood pressure readings, a heart pulse rate or reading, a note or notes regarding the individual, the patient, or the caregiver, a photograph or photographs of the individual, the patient, or the caregiver, a photograph or photographs of an accident scene, information regarding a vital sign or vital signs, or any other information which may be requested of, or obtained from, a provider, or information which may be requested of, or obtained from, the individual, the patient, or the caregiver, or which may be used by a insurer or payer or insurance company in processing, investigating, or evaluating, a claim form or a claim submission or a request for payment.

In another preferred embodiment of the embodiment of FIGS. 11A and 11B, or any and/or all the herein-described embodiments, the apparatus 100 or the central processing computer 10 can provide information regarding ICD, ICD-10, ICD-9, or other, codes, diagnostic codes, symptom codes, treatment codes, billings codes, or any other codes or information useful in entering or recording individual or patient information into a electronic healthcare record or an electronic healthcare file of the individual or the patient. In this manner, the apparatus 100 of the present invention can provide any user, individual, patient, provider, insurer or payer, or intermediary, or any other individual or person, using the apparatus 100 of the present invention, with accurate and current data or information so as to ensure that the information described herein as being stored in the electronic healthcare records or the electronic healthcare files of individuals or the patients, records or files of providers, insurer or payers, third parties, or intermediaries, or any claim forms, request for payments, insurance claims, prescriptions, referrals, or any other information, described herein as being processed, generated, or stored, by the apparatus 100 of the present invention, is accurate, correct, and up-to-date with current standards in the healthcare field or any related fields.

In another preferred embodiment of the embodiment of FIGS. 11A and 11B, any healthcare provider of the individual, the patient, or any insurer or payer of the individual or the patient, or the individual or the patient, or a caregiver, can program the central processing computer 10, or the CPU 10A, to generate a reminder message or reminder messages, at any desired or at selected times or time intervals, for follow-up care, preventative care, and/or to remind the individual, the patient, or a caregiver, to follow certain procedures and instructions for his or her care and/or well being. The central processing computer 10 can transmit the reminder message or reminder messages to the user communication device 40. The reminder messages can be sent on an on-going basis, as desired, to provide the individual, the patient, or a caregiver, with these reminders.

In another preferred embodiment, as well as in any and/or all of the embodiments described herein, the central processing computer 10, or the CPU 10A, in addition to generating any of the herein-described diagnostic reports, treatment reports, or treatment plans, can also generate a wellness report, an exercise report, a fitness report, a nutritional report, a diet report, a rehabilitation report, a therapy report, and/or any other report containing wellness information, exercise information, fitness information, suggested exercises and/or suggested fitness routines, nutritional information, diets, rehabilitation exercises or activities, and/or therapy information. The respective wellness report, exercise report, fitness report, nutritional report, diet report, rehabilitation report, therapy report, and/or any other report, can be generated using data and/or information contained in the individual's or the patient's electronic healthcare record or electronic healthcare file, and/or by using any information regarding any examination findings, procedure findings, symptoms, diagnoses, possible diagnoses, treatments, treatment plans, genetic information or genetic-related information or a genetic profile report or file, or any other information used in generating any of the herein-described diagnostic reports, treatment reports, or treatment plans. The respective wellness report, exercise report, fitness report, nutritional report, diet report, rehabilitation report, therapy report, and/or any other report, can also be generated using data and/or information provided by any individual, the patient, or a caregiver, by any provider, by any insurer or payer, or by any intermediary or third party.

The respective wellness report, exercise report, fitness report, nutritional report, diet report, rehabilitation report, therapy report, and/or any other report, can also be generated in connection with the generation of any diagnostic report, treatment report, or treatment plan. In a preferred embodiment, any herein-described final diagnosis and/or prescribed treatment plan, or any diagnostic reports, treatment reports, or treatment plans, or genetic profile report or file, can include or contain the respective wellness report, exercise report, fitness report, nutritional report, diet report, rehabilitation report, therapy report, and/or any other report, or can include or contain a link(s) or a hyperlink(s) to the respective wellness report, exercise report, fitness report, nutritional report, diet report, rehabilitation report, therapy report, and/or any other report. Any and/or all of the respective wellness reports, exercise reports, fitness reports, nutritional reports, diet reports, rehabilitation reports, therapy reports, and/or any other reports, can be stored in the individual's or the patient's electronic healthcare record of electronic healthcare file. Any herein-described final diagnosis and/or prescribed treatment plan or any of the herein-described diagnostic reports, treatment reports, or treatment plans, genetic profile reports or files, wellness reports, exercise reports, fitness reports, nutritional reports, diet reports, rehabilitation reports, therapy reports, and/or any other reports, can also contain or include a link(s) or hyperlink(s) to a respective individual's or patient's electronic healthcare record or electronic healthcare file, and any of the herein-described electronic healthcare records or electronic healthcare files of a respective individual or patient can contain or include a link(s) or hyperlink(s) to a respective final diagnosis or prescribed treatment plan, diagnostic report, treatment report, or treatment plan, genetic profile report or file, wellness report, exercise report, fitness report, nutritional report, diet report, rehabilitation report, therapy report, and/or any other report.

In another preferred embodiment, any individual, patient, or caregiver, or a provider, insurer or payer, or any intermediary or third party, can also access the central processing computer 10 with a respective communication device 40, 20, 30, or 50 and can request that a respective wellness report, exercise report, fitness report, nutritional report, diet report, rehabilitation report, therapy report, and/or any other report, be generated for the individual or the patient. Thereafter, the central processing computer 10, or the CPU 10A, can generate the respective wellness report, exercise report, fitness report, nutritional report, diet report, rehabilitation report, therapy report, and/or any other report, transmit same to the respective communication device 40, 20, 30, or 50 of the requesting individual, patient, or caregiver, or a provider, insurer or payer, or any intermediary or third party, and/or store same in the electronic healthcare record or the electronic healthcare file of the individual or the patient.

In another preferred embodiment, any of the herein-described diagnostic reports, treatment reports, treatment plans, wellness reports, exercise reports, fitness reports, nutritional reports, diet reports, rehabilitation reports, therapy reports, and/or any other reports, can also include or can contain data and/or information regarding suggested or recommended providers, healthcare facilities, treatment facilities or centers, suggested appointments with providers, lifestyle suggestions, wellness or fitness suggestions, exercise routines or suggestions, diet suggestions, and/or a link(s) or hyperlink(s) to any of the above data and/or information.

In any and/or all of the embodiments described herein, the central processing computer 10, or the CPU 10A, in performing any processing of individual or patient information, diagnosis information, and/or treatment information, described herein, can perform such processing in conjunction with drug and/or other treatment interaction information and/or individual or patient allergy information so as to provide an added safeguard in the diagnosis and treatment planning processes. Any and/or all processing described herein is also performed in conjunction with each individual's or patient's electronic healthcare record and any and/or all data and/or information contained or stored therein, healthcare or medical history, genetic information or genetic-related information, genetic profile reports or files, family history information, allergic conditions information, and/or with any other information deemed important and/or essential in the individual's healthcare diagnoses and/or treatments.

In another preferred embodiment, the apparatus 100 and method of the present invention can be utilized in order to process genetic information or genetic-related information, which can be obtained from an individual or patient at anytime during the lifetime of the individual or the patient, whether it be at or shortly after birth, at any age or point during or in the individual's or the patient's lifetime, or prior to the birth of the individual or patient, or from his or her fetus and/or while in utero, or from an embryo prior to implantation. The genetic information or genetic-related information obtained can be analyzed and can be utilized in order to generate or provide an initial genetic diagnostic report or plan or a baseline genetic diagnostic report or plan and/or an initial treatment report or plan or a baseline treatment report or plan for the individual or patient. The initial genetic diagnostic report or plan or the baseline genetic diagnostic report or plan and/or the initial treatment report or plan or the baseline treatment report or plan can be utilized for, among other things, managing and/or monitoring the individual's or the patient's healthcare, scheduling healthcare and/or healthcare-related examinations, tests, procedures, surgeries, and/or in designing and/or in implementing treatment plans, and/or in administering treatments, in evaluating treatments, and/or in designing or implementing dietary, fitness, exercise, and/or wellness, routines, and/or in evaluating and/or in comparing diagnostic reports, treatment reports, or treatment plans, and/or genetic information or genetic-related information, which can be obtained in or during the individual's or the patient's lifetime.

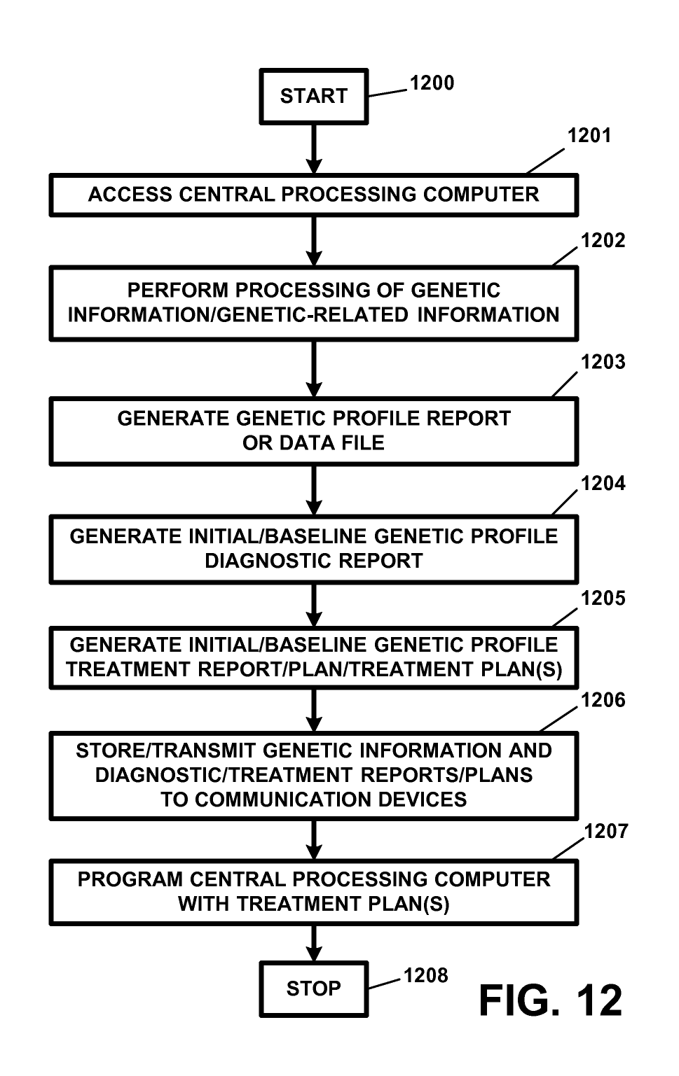

FIG. 12 illustrates another preferred embodiment method of utilizing the apparatus 100 of the present invention, in flow diagram form. While the method of FIG. 12 is described in connection testing and/or analyzing an individual's or a patient's genetic information or genetic-related information obtained from the individual's or the patient's DNA, it is important to note that the method of FIG. 12 can also be utilized to test and/or analyze genetic information or genetic-related information obtained from any other genetic material of the individual or the patient, including, but not limited to, the individual's or the patient's RNA, chromosomes, genes, or plasmids, or any other material containing genetic information or genetic matter or heritable biological information. Further, while the method of FIG. 12 is described in connection with testing and/or analyzing an individual's or a patient's genetic information or genetic-related information obtained from the individual's or the patient's DNA at birth, it is important to note that the method of FIG. 12 can also be utilized in a same, a similar, and/or an analogous, manner for testing and/or for analyzing an individual's or a patient's genetic information or genetic-related information obtained from the individual's or the patient's DNA at any time during the lifetime of the individual or the patient. In another preferred embodiment, the method of FIG. 12 can also be utilized in a same, a similar, and/or an analogous, manner for testing and/or analyzing the genetic information or genetic-related information obtained from the DNA of a fetus while in utero or for testing and/or analyzing the genetic information or genetic-related information obtained from the DNA of an embryo at any time.

In a preferred embodiment, an electronic healthcare record can be created or established for the individual or the patient with the central processing computer 10, with the healthcare records computer 60, and/or with the apparatus 100, at birth. The individual's or the patient's electronic healthcare record can contain any data and/or information regarding or pertaining to the individual or the patient, including, but not limited to, any of the data and/or information described herein as being stored and/or maintained in the database 10H. The individual's or the patient's electronic healthcare record can also contain any data and/or information regarding or pertaining to the parents of the individual or the patient, including, but not limited to, any of the data and/or information described herein as being stored and/or maintained in the database 10H. In the preferred embodiment, genetic information or genetic-related information obtained from the individual's or the patient's DNA can also be stored in the individual's or the patient's electronic healthcare record.

In a preferred embodiment, the genetic information or genetic-related information regarding the individual's or the patient's DNA can be prepared and stored in digital form and/or as a digital representation of same, and can either be sent directly to the central processing computer 10, such as from a provider communication device 20 associated with or used by the genetic testing laboratory or service which performed the testing and/or the analysis of the DNA, for entry into the individual's or the patient's electronic healthcare record, or the genetic information or genetic-related information regarding the individual's or the patient's DNA can be transmitted, sent, or otherwise provided, in digital form and/or as a digital representation of same, to an operator of the central processing computer 10, to a healthcare provider of the individual or the patient, to any intermediary or authorized third party, or to any other authorized individual or entity, who or which, in the case of an operator of the central processing computer 10, can enter same into the central processing computer 10 via a user input device 10D, or in the case of a healthcare provider, an intermediary, or any other third party individual or entity, can enter same into and can transmit same from a respective provider communication device 20 or from an intermediary communication device 50 to the central processing computer 10. Genetic information or genetic-related information regarding the individual's or the patient's family member(s), parent(s), sibling(s), child or children, or any person(s) having a blood relationship or bloodline relationship with the individual, can also be provided and stored in the electronic medical record of the individual or the patient.

Once the genetic information or the genetic-related information is stored in the individual's or the patient's electronic healthcare record in the database 10H of the central processing computer 10, the method of the embodiment of FIG. 12 can be performed.

With reference to FIG. 12, the operation of the apparatus 100 will commence at step 1200. At step 1201, in a preferred embodiment, a healthcare provider of the individual or the patient can access the central processing computer 10 via his, her, or its, provider communication device 20. In another preferred embodiment, any authorized intermediary can also, at step 1201, access the central processing computer 10 via his, her, or its, intermediary communication device 50. In another preferred embodiment, any authorized user or operator of the central processing computer 10 can activate and/or operate the central processing computer 10 via the user input device 10D.

At step 1202, the central processing computer 10 will process the data and/or information contained in the individual's or the patient's genetic information and/or genetic-related information obtained from the individual's or the patient's DNA. If available and if deemed necessary or helpful, the central processing computer 10 can also process any data and/or information contained in any genetic information or genetic-related information obtained from the DNA of the individual's or the patient's family member(s), parent(s), sibling(s), child or children, or any person(s) having a blood relationship or bloodline relationship with the individual. At step 1202, any genetic information or genetic-related information can also be processed in conjunction with any other information, or any healthcare or medical theories, principles, criteria and/or other healthcare or medical information.

At step 1202, the central processing computer 10, or the CPU 10A, can perform a diagnostic evaluation of the individual or the patient. In a preferred embodiment, at step 1202, the central processing computer 10, or the CPU 10A, can perform a diagnostic evaluation of the individual or the patient by using the genetic information or genetic-related information obtained from the individual's or the patient's DNA or DNA information. At step 1202, the central processing computer 10, or the CPU 10A, can process the individual's or the patient's genetic information or genetic-related information obtained from the individual's or the patient's DNA, or DNA information, in order to ascertain the presence or the absence of a variation(s) or mutation(s), or any carrier status, in, on, or regarding, the individual's or the patient's DNA. At step 1202, the central processing computer 10, or the CPU 10A, can also process the genetic information or the genetic-related information, obtained from DNA of the individual's or the patient's family member(s), parent(s), sibling(s), child or children, or any person(s) having a blood relationship or bloodline relationship with the individual or the patient, if same is available, in order to also ascertain the presence or the absence of a variation(s) or mutation(s), or any carrier status, in, on, or regarding same.

At step 1202, the central processing computer 10, or the CPU 10A, can also process the individual's or the patient's genetic information or genetic-related information obtained from the individual's or the patient's DNA, or DNA information, in order to ascertain the presence or the absence of any gene, genes, or genetic marker(s) or indicator(s), or any variation(s) or mutation(s) of same, or any carrier status, in or regarding, the individual's or the patient's DNA. At step 1202, the central processing computer 10, or the CPU 10A, can also process the genetic information or genetic-related information obtained from DNA of the individual's or the patient's family member(s), parent(s), sibling(s), child or children, or any person(s) having a blood relationship or bloodline relationship with the individual or the patient, in order to ascertain the presence or the absence of any gene, genes, or genetic marker(s) or indicator(s), or any variation(s) or mutation(s) of same, or any carrier status, in or regarding, the DNA of the individual's or the patient's family member(s), parent(s), sibling(s), child or children, or any person(s) having a blood relationship or bloodline relationship with the individual or the patient.

At step 1202, the central processing computer 10, or the CPU 10A, can also process the individual's or the patient's genetic information or genetic-related information obtained from the individual's or the patient's DNA, or DNA information, in order to ascertain the presence or the absence of a gene or genes, or genetic marker(s) or indicator(s), which presence or absence is or may be medically or scientifically believed to cause, to be the cause of, or to be associated with, a disease, a disorder, a condition, a sickness, a syndrome, or a cancer, and/or to ascertain the presence or the absence of a gene or genes, or genetic marker(s) or indicator(s), which can or may be associated with a statistical or a statistically increased probability or risk of developing or getting a disease, a disorder, a condition, a sickness, a syndrome, or a cancer.

At step 1202, the central processing computer 10, or the CPU 10A, can also process the genetic information or genetic-related information obtained from DNA, or DNA information, of the individual's or the patient's family member(s), parent(s), sibling(s), child or children, or any person(s) having a blood relationship or bloodline relationship with the individual or the patient, in order to ascertain the presence or the absence of a gene or genes, or genetic marker(s) or indicator(s), which presence or absence is or may be medically or scientifically believed to cause, to be the cause of, or to be associated with, a disease, a disorder, a condition, a sickness, a syndrome, or a cancer, and/or to ascertain the presence or the absence of a gene or genes, or genetic marker(s) or indicators(s), which can or which may be associated with a statistical or a statistically increased probability or risk of developing or getting a disease, a disorder, a condition, a sickness, a syndrome, or a cancer.

At step 1202, the central processing computer 10, or the CPU 10A, can also ascertain, for each occurrence of a detected presence or absence of the gene, genes, or genetic marker(s) or indicator(s), in the individual's or the patient's genetic information or genetic-related information, or DNA information, and/or, if available and if utilized, in the genetic information or genetic-related information, or DNA information, of the individual's or the patient's family member(s), parent(s), sibling(s), child or children, or any person(s) having a blood relationship or bloodline relationship with the individual or the patient, any corresponding disease(s), disorder(s), condition(s), sickness(es), syndrome(s), or cancer(s), and any symptoms, conditions, or any other information, associated with same.

At step 1202, the central processing computer 10, or the CPU 10A, can also detect, identify, or ascertain, any genetic abnormalities present in the individual's or the patient's genetic information or genetic-related information, or DNA information, and/or, if available and if utilized, in the genetic information or genetic-related information, or DNA information, of the individual's or the patient's family member(s), parent(s), sibling(s), child or children, or any person(s) having a blood relationship or bloodline relationship with the individual or the patient, and the central processing computer 10, or the CPU 10A, can process information regarding same so as to compare any disease(s), disorder(s), condition(s), sickness(es), syndrome(s), or cancer(s), associated with same, and any symptoms, conditions, or any other information, associated with same, with or against any symptoms and/or examination findings and/or any observations of or regarding the individual or the patient, if any.

At step 1203, the central processing computer 10, or the CPU 10A, can generate a genetic profile report or data file containing any data and/or information obtained or gathered at steps 1201, 1202, and/or 1203, and/or previously, and/or any data and/or information regarding any and/or each detected presence or absence of any gene, genes, or genetic marker(s) or indicator(s), and any data and/or information regarding any corresponding disease(s), disorder(s), condition(s), sickness(es), syndrome(s), or cancer(s), and any symptoms, conditions, or any other information, related or associated with same, which was detected in the individual's or the patient's genetic information or genetic-related information, or DNA information, and/or, if utilized, any data and/or information regarding any and/or each detected presence or absence of any gene, genes, or genetic marker(s) or indicator(s), and any data and/or information regarding any corresponding disease(s), disorder(s), condition(s), sickness(es), syndrome(s), or cancer(s), and any symptoms, conditions, or any other information, related or associated with same, which was detected in the DNA information of the individual's or the patient's family member(s), parent(s), sibling(s), child or children, or any person(s) having a blood relationship or bloodline relationship with the individual or the patient. In this regard, at step 1203, the central processing computer 10 can generate a genetic profile report or data file containing data and/or information regarding each detected presence or absence of the gene, genes, or a genetic marker(s) or indicator(s), ascertain the corresponding disease(s), disorder(s), condition(s), sickness(es), syndrome(s), or cancer(s), the symptoms, conditions, or any other information associated with same, which was detected in the individual's or the patient's DNA information and/or, if utilized, in the DNA information of the individual's or the patient's family member(s), parent(s), sibling(s), child or children, or any person(s) having a blood relationship or bloodline relationship with the individual or the patient.

At step 1203, in a situation where the individual or the patient is or may exhibiting symptoms and/or examination findings or observations at the time the genetic information or the genetic-related information is stored in the database 10H of the central processing computer 10, the central processing computer 10, or the CPU 10A, can also process the information regarding the individual's or the patient's symptoms and/or examination findings or observations, if any, in conjunction with any data and/or information contained in the genetic profile report or data file in order to ascertain if the symptoms and/or examination findings or observations match or coincide with, any of the symptoms, conditions, or any other information, associated with each detected disease, disorder, condition, sickness, syndrome, or cancer. In this regard, the central processing computer 10, or the CPU 10A, can also process the information regarding the individual's or the patient's symptoms and/or examination findings or observations in conjunction with processing the genetic information or genetic-related information and/or any data and/or information contained in the genetic profile report or data file in order to ascertain if the symptoms and/or examination findings or observations match or coincide with any of the symptoms, conditions, or any other information, associated with each detected disease, disorder, condition, sickness, syndrome, or cancer.

At step 1204, the central processing computer 10 can generate an initial or baseline genetic profile diagnostic report which can include information regarding any detected presence or absence of any gene, genes, or genetic marker(s) or indicator(s), the presence or absence of which correspond to any disease(s), disorder(s), condition(s), sickness(es), syndrome(s), or cancer(s), and/or any other information associated with same. The initial or baseline genetic profile diagnostic report can also include any other data and/or information which is or which can be contained in the genetic profile report or data file. At step 1205, the central processing computer 10 can then generate, if needed, an initial or baseline genetic profile treatment report or plan which can contain a treatment plan(s) for each disease(s), disorder(s), condition(s), sickness(es), syndrome(s), or cancer(s), identified in the initial or baseline genetic profile diagnostic report. In a preferred embodiment, the initial or baseline genetic profile treatment report or plan can contain data and/or information regarding an estimated cost of treatment for each disease(s), disorder(s), condition(s), sickness(es), syndrome(s), or cancer(s), identified in the initial or baseline genetic profile diagnostic report.

In a preferred embodiment, the initial or baseline genetic profile treatment report or plan and/or the treatment plan can include information regarding a plan of treatment, including, but not limited to, any and/or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan, which are or might be called for by a respective treatment report or plan or treatment plan, along with the costs or prices of each and the total cost or price of the treatment or treatment plan.

For example, for a given course of treatment associated with a treatment plan, the initial or baseline genetic profile treatment report or plan and/or the treatment plan can contain an estimate of the cost or price associated with any and/or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan.

In a preferred embodiment, as well as in any and/or all of the embodiments described herein, any of the herein-described healthcare providers, providers, hospitals, healthcare facilities, therapists, pharmaceutical companies, laboratories, testing services, genetic testing services, any providers of any goods, products, or services, and/or any intermediaries of any kind or type, pharmaceutical companies, laboratories or testing entities or services, genetic testing services, and/or any other providers of goods, products, and/or services, and/or any other intermediaries, can access the central processing computer 10 at any time using his, her, or its, respective provider communication device 20 or intermediary communication device 50, and can transmit or upload to the central processing computer 10 his, her, or its, respective pricing schedules or price lists for the various services, goods, and/or products, that he, she, or it, provides. The pricing schedules or prices lists can be stored in the database 10H of the central processing computer 10 and can be utilized in estimating the costs of any of the treatment plans generated by the apparatus 100 and method of the present invention.

In a preferred embodiment, once a treatment plan has been configured, the total estimated cost or price of all costs for any and or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan can be calculated in order to provide an estimated cost of the treatment plan. In a preferred embodiment, any pricing schedules or price lists can also be updated or changed at any time.

In a preferred embodiment, the initial or baseline genetic profile treatment report or plan and/or the treatment plan can also include or contain the genetic profile report or data file and/or any data and/or information which is or which can be contained in the genetic profile report or data file.

In a preferred embodiment, the initial or baseline genetic profile treatment report or plan and/or the treatment plan can also include estimated costs of a treatment plan for and/or involving different providers within a same geographical locale or location. In a preferred embodiment, the initial or baseline genetic profile treatment report or plan and/or the treatment plan can also include estimated costs of a treatment plan for and/or in a number of different locales which can be domestic or foreign. For example, for an individual or patient living in and/or expecting to be treated in the New York City metropolitan area, the treatment plan can, for example, include estimates of the costs of the treatment plan in the New York City metropolitan area, as well as in a number of other locations across the United States, such as, for example, but not limited to, Philadelphia, Pa., Los Angeles, Calif., Miami, Fla., Boston, Mass., Seattle, Wash., or any other location or locale in the Untied States which may be deemed to be a location or locale where expertise exists for implementing and/or executing the treatment plan.

In another preferred embodiment, the initial or baseline genetic profile treatment report or plan and/or the treatment plan can also include estimated costs of a treatment plan for and/or in a number of locations or locales in foreign countries or abroad. For example, for an individual or patient living in and/or expecting to be treated in the New York City metropolitan area, the treatment plan can, for example, include, but not be limited to having. estimates of the costs of the treatment plan if treatment were to occur in London, England, Rome, Italy, Lisbon, Portugal, Ottawa, Canada, Rio De Janeiro, Brazil, or in any other location or locale outside the United States, which may be deemed to be a location or locale where expertise exists for implementing and/or executing the treatment plan.

By providing cost estimates associated with the costs of a treatment plan, the individual or the patient, his or her caregiver, his or her provider(s), and/or his or her insurer or payer, can utilize same to make informed decisions regarding treatment. Providing estimates associated with the costs of a treatment plan can also lend itself for use in managing healthcare costs and in making decisions regarding cost planning, cost analysis, cost containment, and/or cost optimization.

In another preferred embodiment, the initial or baseline genetic profile treatment report or plan and/or the treatment plan, or each treatment report or treatment plan corresponding to each possible diagnosis, can also contain or include information regarding, and/or a link(s) or a hyperlink(s) to, a provider communication device 20 of each of the individual's or the patient's healthcare providers or doctors and/or to healthcare providers or doctors identified as being able to treat the individual or the patient, so that the individual or the patient, or a caregiver, can contact or communicate with a respective healthcare provider or doctor, or so that the individual or the patient, or a caregiver, can schedule an appointment with the healthcare provider or doctor via the central processing computer 10 or otherwise, or so that the individual or the patient can utilize the information or the link(s) or hyperlink(s) for any other appropriate reason.

In another preferred embodiment, the initial or baseline genetic profile treatment report or plan and/or the treatment plan, or each treatment report or treatment plan corresponding to each possible diagnosis, can also contain or include information regarding, and/or a link(s) or a hyperlink(s), to an insurer communication device 30 of each insurer or payer of the individual or patient so that the individual or the patient, or a caregiver, can contact or communicate with a respective healthcare insurer or payer, so that the individual or the patient can submit an insurance claim to the insurer or payer via the central processing computer 10 or otherwise, so that the individual or the patient can submit a pre-authorization request to the insurer or payer, or so that the individual or the patient can utilize the information or the link(s) or hyperlink(s) for any other appropriate reason.

In another preferred embodiment, the initial or baseline genetic profile treatment report or plan and/or the treatment plan, or each treatment report or treatment plan corresponding to each possible diagnosis, can also contain or include information regarding, and/or a link(s) or a hyperlink(s), to the central processing computer 10 and/or to the healthcare records computer 60 so that the individual, or the patient, or a caregiver of the individual or the patient, can access the individual's or the patient's electronic healthcare record(s) or any portion of same. In another preferred embodiment, the treatment report and/or the treatment plan, can also contain or include information regarding, and/or a link(s) or a hyperlink(s), to the insurance exchange computer 70 so that the individual or the patient or caregiver of the individual or the patient, can access the insurance exchange computer 70 in order file a healthcare insurance claim, check on the status of a healthcare insurance claim, or purchase a healthcare or other insurance policy.

In another preferred embodiment, the initial or baseline genetic profile treatment report or plan and/or the treatment plan, or each treatment report or treatment plan corresponding to each possible diagnosis, can also contain or include information regarding, and/or a link(s) or a hyperlink(s), to a social networking computer 80 and/or to any social networking web site or web pages, and/or to or for any social networking members, support groups, social networking support group members, on-line seminars, social networking lectures, classes, or seminars, social networking sponsored lectures, classes, or seminars, social networking discussions, question and answer sessions, or informational or other forums, or any other social networking or social networking sponsored activities or events, forums, chat room discussions, or any other information providing sources, with which or with whom the individual or the patient, or a caregiver of the individual or the patient, may engage. The providing of the social networking information to the individual or the patient, or to a caregiver of the individual or the patient, can serve to allow the individual or the patient, or the caregiver, to learn more about a diagnosis, a treatment, or a treatment plan, or to interact with others who have been diagnosed, or are caring for or who have cared for others, with or having the same or a similar ailment, illness, sickness, or condition, or to interact with others who may be undergoing, or who may be caring for or who have cared for others with or having had, the same or a similar treatment, or who may be following a same or a similar treatment plan.

In another preferred embodiment, the initial or baseline genetic profile treatment report or plan and/or the treatment plan, or each treatment report or treatment plan corresponding to each possible diagnosis, can also contain or include information regarding, and/or a link(s) or a hyperlink(s), to a media computer 90 so that the individual or the patient, or a caregiver of the individual or the patient, can access news articles or other information regarding his or her diagnosis and/or treatment plan.

In a preferred embodiment, the initial or baseline genetic profile treatment report or plan can also contain any data, information, link(s), and/or hyperlink(s), described herein as being included in the treatment report or treatment plan of the embodiment of FIGS. 11A and 11B.

At step 1206, the central processing computer 10 can store each of the individual's or the patient's genetic information or genetic-related information which was processed at step 1202, the genetic profile report or data file which was generated at step 1203, the initial or baseline genetic profile diagnostic report which was generated at step 1204, and the initial or baseline genetic profile treatment report or plan and any treatment plan(s) which were generated at step 1205, in the electronic healthcare record of the individual or patient in the database 10H.

At step 1206, the central processing computer 10 can also transmit each of the individual's or the patient's genetic information or genetic-related information which was processed at step 1202, the genetic profile report or data file which was generated at step 1203, the initial or baseline genetic profile diagnostic report which was generated at step 1204, and the initial or baseline genetic profile treatment report or plan and any treatment plan(s) which were generated at step 1205, to the provider communication device 20 associated with or used by the healthcare provider, to the provider communication device 20 associated with or used by each of the healthcare providers of the individual or patient, to the insurer communication device 30 associated with or used by each insurer or payer of the individual or patient, and to each user communication device 40 associated with or used by the individual or the patient or by a caregiver of the individual or the patient, to the healthcare records computer 60. At step 1206, the central processing computer 10 can also transmit each of the individual's or the patient's genetic information or genetic-related information which was processed at step 1202, the genetic profile report or data file which was generated at step 1203, the initial or baseline genetic profile diagnostic report which was generated at step 1204, and the initial or baseline genetic profile treatment report or plan and any treatment plan(s) which were generated at step 1205, to the healthcare records computer 60 and/or the insurance exchange computer 70.

At step 1206, each provider communication device 20, each insurer communication device 30, and/or each user communication device 40, to which the individual's or the patient's genetic information or genetic-related information, the genetic profile report or data file, the initial or baseline genetic profile diagnostic report, and the initial or baseline genetic profile treatment report or plan and any treatment plan(s), was transmitted can receive and store same in its respective database 20H, 30H, or 40H and/or in an electronic healthcare record for or associated with the individual or the patient stored therein. In a preferred embodiment, each of the individual's or the patient's genetic information or genetic-related information, the genetic profile report or data file, the initial or baseline genetic profile diagnostic report, and the initial or baseline genetic profile treatment report or plan and any treatment plan(s), can, for example, also be transmitted to and/or stored by or in the individual's, the patient's, or the caregiver's, electronic healthcare record in the database 10H of the central processing computer 10, in the database 40H of the user communication device 40, in the individual's, the patient's, or the caregiver's, electronic healthcare record in the database 60H of the healthcare records computer 60, or in the database 70H of the insurance exchange computer 70.

In a preferred embodiment, each of the initial or baseline genetic profile diagnostic report and the initial or baseline genetic profile treatment report or plan and any treatment plan(s) can contain any of the data, information, link(s), or hyperlink(s) described herein as being contained in any of the diagnostic reports, treatment reports, or treatment plans, described herein.

At step 1207, once a treatment plan is selected to be followed for each disease, disorder, condition, sickness, syndrome, or cancer, identified in the initial or baseline genetic profile diagnostic report, for the individual or the patient, the central processing computer 10, and/or the CPU 10A, can, for each treatment plan for each disease, disorder, condition, sickness, syndrome, or cancer, identified in the initial or baseline genetic profile diagnostic report, be automatically programmed to generate and transmit reminder messages to the provider and/or to the individual or the patient, or to a caregiver, and/or to any of other providers, or insurers, or intermediaries, so as to ensure that the treatment plan is followed for each disease, disorder, condition, sickness, syndrome, or cancer, identified in the initial or baseline genetic profile diagnostic report, until a new prescribed treatment plan for each disease, disorder, condition, sickness, syndrome, or cancer, identified in the initial or baseline genetic profile diagnostic report, is received by the central processing computer 10. In this regard, the central processing computer 10, or the CPU 10A, can be programmed so as to become automatically programmed with or by the treatment plan for each disease, disorder, condition, sickness, syndrome, or cancer, identified in the initial or baseline genetic profile diagnostic report, upon the receipt or selection of the respective treatment plan, so as to follow and/or to monitor the treatment plan. In this regard, in the preferred embodiment, the central processing computer 10, or the CPU 10A, for each treatment plan, can be programmed to automatically generate a respective alert message(s), reminder message(s), or any other type or kind of message(s), and to transmit same to the user communication device 40 of or associated with the individual or the patient, or a caregiver, to the provider communication device 20 of or associated with the provider or any provider involved in the prescribed treatment plan, or to any other provider of the individual or the patient, to the insurer communication device 30 of or associated with an insurer or payer of the individual or the patient, or to an intermediary communication device 50 of or associated with an intermediary involved in the prescribed treatment plan.

After the central processing computer 10, or the CPU 10A, has been programmed with the treatment plan(s), the central processing computer 10, or the CPU 10A, will, for each treatment plan, automatically generate and/or transmit to a respective communication device of or associated with the individual, the patient, or a caregiver of same, and/or to any of the providers, insurers, or intermediaries, involved in each treatment plan, any and/or all applicable appointment scheduling and/or reminder messages, testing scheduling and/or reminder messages, procedure scheduling and/or reminder messages, surgical or other treatment administration scheduling and/or reminder messages, therapy scheduling and/or reminder messages, prescriptions for drugs or mediations and/or for testing and/or genetic testing, scheduling and/or reminder messages, prescription refill or reorder scheduling and/or reminder messages, messages reminding the individual or the patient to take a drug or medication at a scheduled time interval, and/or follow-up office visit or doctor visit reminder messages, and/or any other message(s), alert message(s), or reminder message(s), deemed needed or desired for ensuring that the respective treatment plan, for each disease, disorder, condition, sickness, syndrome, or cancer, identified in the initial or baseline genetic profile diagnostic report, is followed.

In a preferred embodiment, any message(s) described herein can contain a link or a hyperlink to a respective party so as to facilitate communication with same. As and for some examples, a reminder message sent to inform or remind the individual or the patient, or a caregiver, to schedule an appointment with a provider can contain a link to the provider's appointment schedule so that the individual or the patient, or a caregiver, can, via the central processing computer 10, easily make the appointment directly from, and using information contained in the message, or a reminder message for the individual or the patient to undergo a test or a procedure can contain a link to the facility where the test or the procedure is to be undertaken or performed, or a reminder message for a provider to refill a prescription medication can contain a link to the individual's or the patient's pharmacy, or a prescription for a genetic test to be performed on the individual's or the patient's DNA can contain a link to a genetic testing service or laboratory and/or to the individual's or the patient's electronic medical record to which the genetic test results and/or analysis can be transmitted, and the list of examples can go on and on.

Thereafter, the operation of the apparatus 100 will cease at step 1208.

Although described as being utilized to process the genetic information or genetic-related information obtained from DNA, or DNA information, and to perform the herein-described functionality for an individual or a patient at birth, the embodiment of FIG. 12 can also be utilized in a same, a similar, and/or an analogous, manner in order to process the genetic information or genetic-related information obtained from DNA, or DNA information, and to perform the herein-described functionality for an individual or patient at any time or point in the individual's or the patient's lifetime. The embodiment of FIG. 12 can also be utilized in a same, a similar, and/or an analogous, manner in order to process the genetic information or genetic-related information obtained from DNA, or DNA information, and to perform the herein-described functionality for a fetus at any time during a pregnancy and/or or for an embryo at any appropriate time.

In another preferred embodiment, the apparatus 100 and method of the present invention can also be utilized for allowing a genetic testing provider, laboratory, or service, to provide or to transmit genetic information test results or generic-related information test results either directly or indirectly to a computer or a computer system, such as, for example, the central processing computer 10 for inclusion in and/or for storage in an electronic medical record of an individual or a patient and diagnostic and/or treatment information processing. The apparatus 100 of the present invention can then be utilized in order to process the genetic information or the genetic-related information and can generate or can provide a genetic diagnostic report or plan and/or a genetic treatment report or plan corresponding thereto for the individual or the patient.

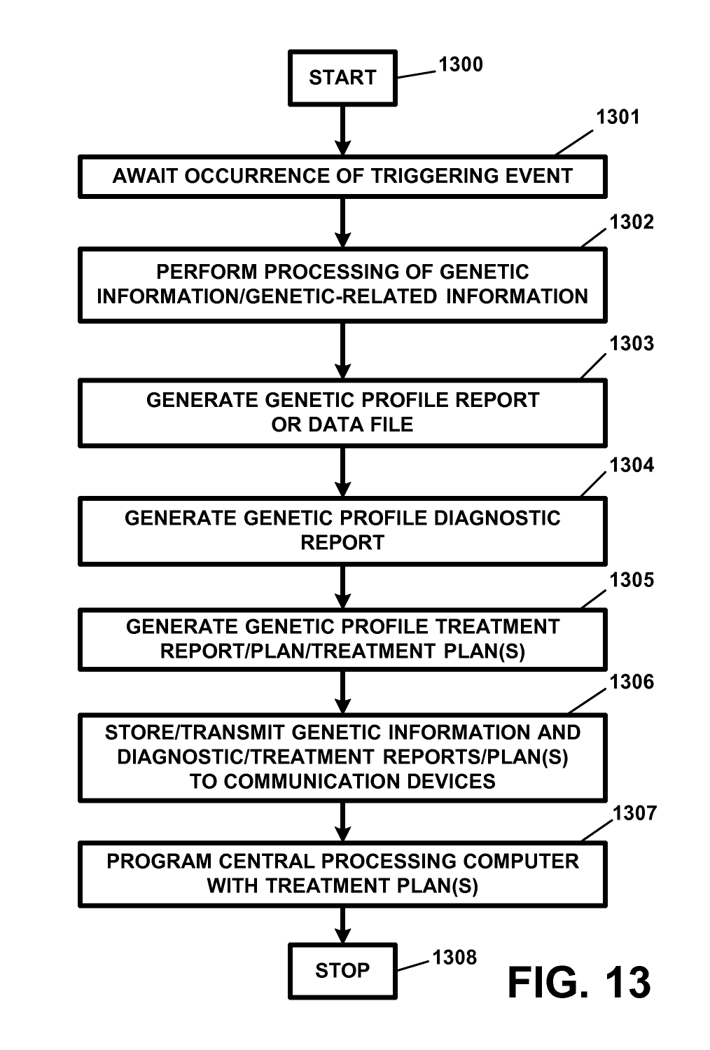

FIG. 13 illustrates another preferred embodiment method of utilizing the apparatus 100 of the present invention, in flow diagram form. While the method of FIG. 13 is described in connection with a testing and/or an analyzing of an individual's or a patient's genetic information or genetic-related information obtained from the individual's of the patient's DNA, or DNA information, it is important to note that the method of FIG. 13 can also be utilized to test and/or to analyze any other genetic information or genetic-related information obtained from the individual's RNA, chromosomes, genes, or plasmids, or any other material or genetic material containing genetic information or heritable biological information.

With reference to FIG. 13, the operation of the apparatus 100 will commence at step 1300. At step 1301, the apparatus 100 will await the occurrence of a “triggering event”, which “triggering event” can be the receipt by the central processing computer 10 of the individual's or the patient's genetic information and/or genetic-related information from a genetic testing laboratory or service and/or the entry of same into the individual's or the patient's electronic healthcare record in the database 10H of the central processing computer 10.

In a preferred embodiment, the genetic information or genetic-related information regarding the individual's or the patient's DNA can be prepared and stored in digital form or as a digital representation of same and can either be sent directly to the central processing computer 10, such as by being transmitted from a provider communication device 20 associated with or used by the genetic testing laboratory or service which performed the testing and/or analysis of the individual's or the patient's genetic information or genetic-related information obtained from the individual's of the patient's DNA, for entry into the individual's or the patient's electronic healthcare record in the database 10H of the central processing computer 10, or the genetic information or genetic-related information regarding the individual's or the patient's DNA can be transmitted or sent in digital form or as a digital representation of same to an operator of the central processing computer 10, to a healthcare provider of the individual or the patient, to any intermediary or an authorized third party, or to any other authorized individual or entity, who or which, in the case of an operator of the central processing computer 10, can enter same into the individual's or the patient's electronic healthcare record in the database 10H of the central processing computer 10 via a user input device 10D or, in the case of a healthcare provider, an intermediary, or any other third party individual or entity, can enter same into and transmit same from a respective provider communication device 20 or intermediary communication device 50 to the central processing computer 10 for entry into the individual's or the patient's electronic healthcare record in the database 10H of same. Genetic information or genetic-related information regarding the individual's or the patient's family member(s), parent(s), sibling(s), child or children, or any person(s) having a blood relationship or bloodline relationship with the individual, can also be provided and entered and/or stored in the electronic medical record of the individual or the patient.

At step 1302, the central processing computer 10 will process the data and/or information contained in the individual's or the patient's genetic information and/or genetic-related information obtained from the individual's or the patient's DNA. If available and if deemed necessary or helpful, the central processing computer 10 can also process any data and/or information contained in any genetic information or genetic-related information obtained from the DNA of the individual's or the patient's family member(s), parent(s), sibling(s), child or children, or any person(s) having a blood relationship or bloodline relationship with the individual. At step 1302, any genetic information or genetic-related information can also be processed in conjunction with any other information, or any healthcare or medical theories, principles, criteria and/or other healthcare or medical information.

At step 1302, the central processing computer 10, or the CPU 10A, can perform a diagnostic evaluation of the individual or the patient. In a preferred embodiment, at step 1302, the central processing computer 10, or the CPU 10A, can perform a diagnostic evaluation of the individual or the patient by using the genetic information or genetic-related information obtained from the individual's or the patient's DNA or DNA information. At step 1302, the central processing computer 10, or the CPU 10A, can process the individual's or the patient's genetic information or genetic-related information obtained from the individual's or the patient's DNA, or DNA information, in order to ascertain the presence or the absence of a variation(s) or mutation(s), or any carrier status, in, on, or regarding, the individual's or the patient's DNA. At step 1302, the central processing computer 10, or the CPU 10A, can also process the genetic information or the genetic-related information, obtained from DNA of the individual's or the patient's family member(s), parent(s), sibling(s), child or children, or any person(s) having a blood relationship or bloodline relationship with the individual or the patient, if same is available, in order to also ascertain the presence or the absence of a variation(s) or mutation(s), or any carrier status, in, on, or regarding same.

At step 1302, the central processing computer 10, or the CPU 10A, can also process the individual's or the patient's genetic information or genetic-related information obtained from the individual's or the patient's DNA, or DNA information, in order to ascertain the presence or the absence of any gene, genes, or genetic marker(s) or indicator(s), or any variation(s) or mutation(s) of same, or any carrier status, in or regarding, the individual's or the patient's DNA. At step 1302, the central processing computer 10, or the CPU 10A, can also process the genetic information or genetic-related information obtained from DNA of the individual's or the patient's family member(s), parent(s), sibling(s), child or children, or any person(s) having a blood relationship or bloodline relationship with the individual or the patient, in order to ascertain the presence or the absence of any gene, genes, or genetic marker(s) or indicator(s), or any variation(s) or mutation(s) of same, or any carrier status, in or regarding, the DNA of the individual's or the patient's family member(s), parent(s), sibling(s), child or children, or any person(s) having a blood relationship or bloodline relationship with the individual or the patient.

At step 1302, the central processing computer 10, or the CPU 10A, can also process the individual's or the patient's genetic information or genetic-related information obtained from the individual's or the patient's DNA, or DNA information, in order to ascertain the presence or the absence of a gene or genes, or genetic marker(s) or indicator(s), which presence or absence is or may be medically or scientifically believed to cause, to be the cause of, or to be associated with, a disease, a disorder, a condition, a sickness, a syndrome, or a cancer, and/or to ascertain the presence or the absence of a gene or genes, or genetic marker(s) or indicator(s), which can or may be associated with a statistical or a statistically increased probability or risk of developing or getting a disease, a disorder, a condition, a sickness, a syndrome, or a cancer.

At step 1302, the central processing computer 10, or the CPU 10A, can also process the genetic information or genetic-related information obtained from the DNA, or DNA information, of the individual's or the patient's family member(s), parent(s), sibling(s), child or children, or any person(s) having a blood relationship or bloodline relationship with the individual or the patient, in order to ascertain the presence or the absence of a gene or genes, or genetic marker(s) or indicator(s), which presence or absence is or may be medically or scientifically believed to cause, to be the cause of, or to be associated with, a disease, a disorder, a condition, a sickness, a syndrome, or a cancer, and/or to ascertain the presence or the absence of a gene or genes, or genetic marker(s) or indicators(s), which can or which may be associated with a statistical or a statistically increased probability or risk of developing or getting a disease, a disorder, a condition, a sickness, a syndrome, or a cancer.

At step 1302, the central processing computer 10, or the CPU 10A, can also ascertain, for each occurrence of a detected presence or absence of the gene, genes, or genetic marker(s) or indicator(s), in the individual's or the patient's genetic information or genetic-related information, or DNA information, and/or, if available and if utilized, in the genetic information or genetic-related information, or DNA information, of the individual's or the patient's family member(s), parent(s), sibling(s), child or children, or any person(s) having a blood relationship or bloodline relationship with the individual or the patient, any corresponding disease(s), disorder(s), condition(s), sickness(es), syndrome(s), or cancer(s), and any symptoms, conditions, or any other information, associated with same.

At step 1302, the central processing computer 10, or the CPU 10A, can also detect, identify, or ascertain, any genetic abnormalities present in the individual's or the patient's genetic information or genetic-related information, or DNA information, and/or, if available and if utilized, in the genetic information or genetic-related information, or DNA information, of the individual's or the patient's family member(s), parent(s), sibling(s), child or children, or any person(s) having a blood relationship or bloodline relationship with the individual or the patient, and the central processing computer 10, or the CPU 10A, can process information regarding same so as to compare any disease(s), disorder(s), condition(s), sickness(es), syndrome(s), or cancer(s), associated with same, and any symptoms, conditions, or any other information, associated with same, with or against any symptoms and/or examination findings and/or any observations of or regarding the individual or the patient, if any.

At step 1303, the central processing computer 10, or the CPU 10A, can generate a genetic profile report or data file containing any data and/or information obtained or gathered at steps 1301, 1302, and/or 1303, and/or previously, and/or any data and/or information regarding any and/or each detected presence or absence of any gene, genes, or genetic marker(s) or indicator(s), and any data and/or information regarding any corresponding disease(s), disorder(s), condition(s), sickness(es), syndrome(s), or cancer(s), and any symptoms, conditions, or any other information, related or associated with same, which was detected in the individual's or the patient's genetic information or genetic-related information, or DNA information, and/or, if utilized, any data and/or information regarding any and/or each detected presence or absence of any gene, genes, or genetic marker(s) or indicator(s), and any data and/or information regarding any corresponding disease(s), disorder(s), condition(s), sickness(es), syndrome(s), or cancer(s), and any symptoms, conditions, or any other information, related or associated with same, which was detected in the DNA information of the individual's or the patient's family member(s), parent(s), sibling(s), child or children, or any person(s) having a blood relationship or bloodline relationship with the individual or the patient. In this regard, at step 1303, the central processing computer 10 can generate a genetic profile report or data file containing data and/or information regarding each detected presence or absence of the gene, genes, or a genetic marker(s) or indicator(s), ascertain the corresponding disease(s), disorder(s), condition(s), sickness(es), syndrome(s), or cancer(s), the symptoms, conditions, or any other information associated with same, which was detected in the individual's or the patient's DNA information and/or, if utilized, in the DNA information of the individual's or the patient's family member(s), parent(s), sibling(s), child or children, or any person(s) having a blood relationship or bloodline relationship with the individual or the patient.

At step 1303, in a situation where the individual or the patient is or may exhibiting symptoms and/or examination findings or observations at the time the genetic information or the genetic-related information is stored in the database 10H of the central processing computer 10, the central processing computer 10, or the CPU 10A, can also process the information regarding the individual's or the patient's symptoms and/or examination findings or observations, if any, in conjunction with any data and/or information contained in the genetic profile report or data file in order to ascertain if the symptoms and/or examination findings or observations match or coincide with, any of the symptoms, conditions, or any other information, associated with each detected disease, disorder, condition, sickness, syndrome, or cancer. In this regard, the central processing computer 10, or the CPU 10A, can also process the information regarding the individual's or the patient's symptoms and/or examination findings or observations in conjunction with processing the genetic information or genetic-related information and/or any data and/or information contained in the genetic profile report or data file in order to ascertain if the symptoms and/or examination findings or observations match or coincide with any of the symptoms, conditions, or any other information, associated with each detected disease, disorder, condition, sickness, syndrome, or cancer.

At step 1304, the central processing computer 10 can generate a genetic profile diagnostic report which can include information regarding any detected presence or absence of any gene, genes, or genetic marker(s) or indicator(s), the presence or absence of which correspond to any disease(s), disorder(s), condition(s), sickness(es), syndrome(s), or cancer(s), and/or any other information associated with same. The genetic profile diagnostic report can also include any other data and/or information which is or which can be contained in the genetic profile report or data file. At step 1305, the central processing computer 10 can then generate, if needed, a genetic profile treatment report or plan which can contain a treatment plan(s) for each disease(s), disorder(s), condition(s), sickness(es), syndrome(s), or cancer(s), identified in the genetic profile diagnostic report. In a preferred embodiment, the genetic profile treatment report or plan can contain data and/or information regarding an estimated cost of treatment for each disease(s), disorder(s), condition(s), sickness(es), syndrome(s), or cancer(s), identified in the genetic profile diagnostic report.

In a preferred embodiment, the genetic profile treatment report or plan and/or the treatment plan can include information regarding a plan of treatment, including, but not limited to, any and/or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan, which are or might be called for by a respective treatment report or plan or treatment plan, along with the costs or prices of each and the total cost or price of the treatment or treatment plan.

For example, for a given course of treatment associated with a treatment plan, the genetic treatment report or plan and/or the treatment plan can contain an estimate of the cost or price associated with any and/or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan.

In a preferred embodiment, as well as in any and/or all of the embodiments described herein, any of the herein-described healthcare providers, providers, hospitals, healthcare facilities, therapists, pharmaceutical companies, laboratories, testing services, genetic testing services, any providers of any goods, products, or services, and/or any intermediaries of any kind or type, pharmaceutical companies, laboratories or testing entities or services, genetic testing services, and/or any other providers of goods, products, and/or services, and/or any other intermediaries, can access the central processing computer 10 at any time using his, her, or its, respective provider communication device 20 or intermediary communication device 50, and can transmit or upload to the central processing computer 10 his, her, or its, respective pricing schedules or price lists for the various services, goods, and/or products, that he, she, or it, provides. The pricing schedules or prices lists can be stored in the database 10H of the central processing computer 10 and can be utilized in estimating the costs of any of the treatment plans generated by the apparatus 100 and method of the present invention.

In a preferred embodiment, once a treatment plan has been configured, the total estimated cost or price of all costs for any and or all doctor visits, office visits, provider visits, hospital stays or stays in healthcare facilities or rehabilitative facilities, tests, testing, procedures, treatments, surgeries, consultations, therapy sessions, and/or rehabilitation sessions, and/or or any medications, drugs, alternative medicine treatments or products, goods, or services, and/or any other goods, products, or services, and/or any other healthcare or other services or goods, which may be prescribed, needed, or deemed desirable, for that treatment plan can be calculated in order to provide an estimated cost of the treatment plan. In a preferred embodiment, any pricing schedules or price lists can also be updated or changed at any time.

In a preferred embodiment, the genetic profile treatment report or plan and/or the treatment plan can also include or contain the genetic profile report or data file and/or any data and/or information which is or which can be contained in the genetic profile report or data file.

In a preferred embodiment, the genetic profile treatment report or plan and/or the treatment plan can also include estimated costs of a treatment plan for and/or involving different providers within a same geographical locale or location. In a preferred embodiment, the genetic profile treatment report or plan and/or the treatment plan can also include estimated costs of a treatment plan for and/or in a number of different locales which can be domestic or foreign. For example, for an individual or patient living in and/or expecting to be treated in the New York City metropolitan area, the treatment plan can, for example, include estimates of the costs of the treatment plan in the New York City metropolitan area, as well as in a number of other locations across the United States, such as, for example, but not limited to, Philadelphia, Pa., Los Angeles, Calif., Miami, Fla., Boston, Mass., Seattle, Wash., or any other location or locale in the Untied States which may be deemed to be a location or locale where expertise exists for implementing and/or executing the treatment plan.

In another preferred embodiment, the genetic profile treatment report or plan and/or the treatment plan can also include estimated costs of a treatment plan for and/or in a number of locations or locales in foreign countries or abroad. For example, for an individual or patient living in and/or expecting to be treated in the New York City metropolitan area, the treatment plan can, for example, include, but not be limited to having. estimates of the costs of the treatment plan if treatment were to occur in London, England, Rome, Italy, Lisbon, Portugal, Ottawa, Canada, Rio De Janeiro, Brazil, or in any other location or locale outside the United States, which may be deemed to be a location or locale where expertise exists for implementing and/or executing the treatment plan.

By providing cost estimates associated with the costs of a treatment plan, the individual or the patient, his or her caregiver, his or her provider(s), and/or his or her insurer or payer, can utilize same to make informed decisions regarding treatment. Providing estimates associated with the costs of a treatment plan can also lend itself for use in managing healthcare costs and in making decisions regarding cost planning, cost analysis, cost containment, and/or cost optimization.

In another preferred embodiment, the genetic profile treatment report or plan and/or the treatment plan, or each treatment report or treatment plan corresponding to each possible diagnosis, can also contain or include information regarding, and/or a link(s) or a hyperlink(s) to, a provider communication device 20 of each of the individual's or the patient's healthcare providers or doctors and/or to healthcare providers or doctors identified as being able to treat the individual or the patient, so that the individual or the patient, or a caregiver, can contact or communicate with a respective healthcare provider or doctor, or so that the individual or the patient, or a caregiver, can schedule an appointment with the healthcare provider or doctor via the central processing computer 10 or otherwise, or so that the individual or the patient can utilize the information or the link(s) or hyperlink(s) for any other appropriate reason.

In another preferred embodiment, the genetic profile treatment report or plan and/or the treatment plan, or each treatment report or treatment plan corresponding to each possible diagnosis, can also contain or include information regarding, and/or a link(s) or a hyperlink(s), to an insurer communication device 30 of each insurer or payer of the individual or patient so that the individual or the patient, or a caregiver, can contact or communicate with a respective healthcare insurer or payer, so that the individual or the patient can submit an insurance claim to the insurer or payer via the central processing computer 10 or otherwise, so that the individual or the patient can submit a pre-authorization request to the insurer or payer, or so that the individual or the patient can utilize the information or the link(s) or hyperlink(s) for any other appropriate reason.

In another preferred embodiment, the genetic profile treatment report or plan and/or the treatment plan, or each treatment report or treatment plan corresponding to each possible diagnosis, can also contain or include information regarding, and/or a link(s) or a hyperlink(s), to the central processing computer 10 and/or to the healthcare records computer 60 so that the individual, or the patient, or a caregiver of the individual or the patient, can access the individual's or the patient's electronic healthcare record(s) or any portion of same. In another preferred embodiment, the genetic profile treatment report or plan and/or the treatment plan, can also contain or include information regarding, and/or a link(s) or a hyperlink(s), to the insurance exchange computer 70 so that the individual or the patient or caregiver of the individual or the patient, can access the insurance exchange computer 70 in order file a healthcare insurance claim, check on the status of a healthcare insurance claim, or purchase a healthcare or other insurance policy.

In another preferred embodiment, the genetic profile treatment report or plan and/or the treatment plan, or each treatment report or treatment plan corresponding to each possible diagnosis, can also contain or include information regarding, and/or a link(s) or a hyperlink(s), to a social networking computer 80 and/or to any social networking web site or web pages, and/or to or for any social networking members, support groups, social networking support group members, on-line seminars, social networking lectures, classes, or seminars, social networking sponsored lectures, classes, or seminars, social networking discussions, question and answer sessions, or informational or other forums, or any other social networking or social networking sponsored activities or events, forums, chat room discussions, or any other information providing sources, with which or with whom the individual or the patient, or a caregiver of the individual or the patient, may engage. The providing of the social networking information to the individual or the patient, or to a caregiver of the individual or the patient, can serve to allow the individual or the patient, or the caregiver, to learn more about a diagnosis, a treatment, or a treatment plan, or to interact with others who have been diagnosed, or are caring for or who have cared for others, with or having the same or a similar ailment, illness, sickness, or condition, or to interact with others who may be undergoing, or who may be caring for or who have cared for others with or having had, the same or a similar treatment, or who may be following a same or a similar treatment plan.

In another preferred embodiment, the genetic profile treatment report or plan and/or the treatment plan, or each treatment report or treatment plan corresponding to each possible diagnosis, can also contain or include information regarding, and/or a link(s) or a hyperlink(s), to a media computer 90 so that the individual or the patient, or a caregiver of the individual or the patient, can access news articles or other information regarding his or her diagnosis and/or treatment plan.

In a preferred embodiment, the genetic profile treatment report or plan can also contain any data, information, link(s), and/or hyperlink(s), described herein as being included in the treatment report or treatment plan of the embodiment of FIGS. 11A and 11B.

At step 1306, the central processing computer 10 can store each of the individual's or the patient's genetic information or genetic-related information which was processed at step 1302, the genetic profile report or data file which was generated at step 1303, the genetic profile diagnostic report which was generated at step 1304, and the genetic profile treatment report or plan and any treatment plan(s) which were generated at step 1305, in the electronic healthcare record of the individual or patient in the database 10H.

At step 1306, the central processing computer 10 can also transmit each of the individual's or the patient's genetic information or genetic-related information which was processed at step 1302, the genetic profile report or data file which was generated at step 1303, the genetic profile diagnostic report which was generated at step 1304, and the genetic profile treatment report or plan and any treatment plan(s) which were generated at step 1305, to the provider communication device 20 associated with or used by the healthcare provider, to the provider communication device 20 associated with or used by each of the healthcare providers of the individual or patient, to the insurer communication device 30 associated with or used by each insurer or payer of the individual or patient, and to each user communication device 40 associated with or used by the individual or the patient or by a caregiver of the individual or the patient, to the healthcare records computer 60. At step 1306, the central processing computer 10 can also transmit each of the individual's or the patient's genetic information or genetic-related information which was processed at step 1302, the genetic profile report or data file which was generated at step 1303, the genetic profile diagnostic report which was generated at step 1304, and the genetic profile treatment report or plan and any treatment plan(s) which were generated at step 1305, to the healthcare records computer 60 and/or the insurance exchange computer 70.

At step 1306, each provider communication device 20, each insurer communication device 30, and/or each user communication device 40, to which the individual's or the patient's genetic information or genetic-related information, the genetic profile report or data file, the genetic profile diagnostic report, and the genetic profile treatment report or plan and any treatment plan(s), was transmitted can receive and store same in its respective database 20H, 30H, or 40H and/or in an electronic healthcare record for or associated with the individual or the patient stored therein. In a preferred embodiment, each of the individual's or the patient's genetic information or genetic-related information, the genetic profile report or data file, the genetic profile diagnostic report, and the genetic profile treatment report or plan and any treatment plan(s), can, for example, also be transmitted to and/or stored by or in the individual's, the patient's, or the caregiver's, electronic healthcare record in the database 10H of the central processing computer 10, in the database 40H of the user communication device 40, in the individual's, the patient's, or the caregiver's, electronic healthcare record in the database 60H of the healthcare records computer 60, or in the database 70H of the insurance exchange computer 70.

In a preferred embodiment, each of genetic profile diagnostic report and the genetic profile treatment report or plan and any treatment plan(s) can contain any of the data, information, link(s), or hyperlink(s) described herein as being contained in any of the diagnostic reports, treatment reports, or treatment plans, described herein.

At step 1307, once a treatment plan is selected to be followed for each disease, disorder, condition, sickness, syndrome, or cancer, identified in the genetic profile diagnostic report, for the individual or the patient, the central processing computer 10, and/or the CPU 10A, can, for each treatment plan for each disease, disorder, condition, sickness, syndrome, or cancer, identified in the genetic profile diagnostic report, be automatically programmed to generate and transmit reminder messages to the provider and/or to the individual or the patient, or to a caregiver, and/or to any of other providers, or insurers, or intermediaries, so as to ensure that the treatment plan is followed for each disease, disorder, condition, sickness, syndrome, or cancer, identified in the genetic profile diagnostic report, until a new prescribed treatment plan for each disease, disorder, condition, sickness, syndrome, or cancer, identified in the genetic profile diagnostic report, is received by the central processing computer 10. In this regard, the central processing computer 10, or the CPU 10A, can be programmed so as to become automatically programmed with or by the treatment plan for each disease, disorder, condition, sickness, syndrome, or cancer, identified in the genetic profile diagnostic report, upon the receipt or selection of the respective treatment plan, so as to follow and/or to monitor the treatment plan. In this regard, in the preferred embodiment, the central processing computer 10, or the CPU 10A, for each treatment plan, can be programmed to automatically generate a respective alert message(s), reminder message(s), or any other type or kind of message(s), and to transmit same to the user communication device 40 of or associated with the individual or the patient, or a caregiver, to the provider communication device 20 of or associated with the provider or any provider involved in the prescribed treatment plan, or to any other provider of the individual or the patient, to the insurer communication device 30 of or associated with an insurer or payer of the individual or the patient, or to an intermediary communication device 50 of or associated with an intermediary involved in the prescribed treatment plan.

After the central processing computer 10, or the CPU 10A, has been programmed with the treatment plan(s), the central processing computer 10, or the CPU 10A, will, for each treatment plan, automatically generate and/or transmit to a respective communication device of or associated with the individual, the patient, or a caregiver of same, and/or to any of the providers, insurers, or intermediaries, involved in each treatment plan, any and/or all applicable appointment scheduling and/or reminder messages, testing scheduling and/or reminder messages, procedure scheduling and/or reminder messages, surgical or other treatment administration scheduling and/or reminder messages, therapy scheduling and/or reminder messages, prescriptions for drugs or mediations and/or for testing and/or genetic testing, scheduling and/or reminder messages, prescription refill or reorder scheduling and/or reminder messages, messages reminding the individual or the patient to take a drug or medication at a scheduled time interval, and/or follow-up office visit or doctor visit reminder messages, and/or any other message(s), alert message(s), or reminder message(s), deemed needed or desired for ensuring that the respective treatment plan, for each disease, disorder, condition, sickness, syndrome, or cancer, identified in the genetic profile diagnostic report, is followed.

In a preferred embodiment, any message(s) described herein can contain a link or a hyperlink to a respective party so as to facilitate communication with same. As and for some examples, a reminder message sent to inform or remind the individual or the patient, or a caregiver, to schedule an appointment with a provider can contain a link to the provider's appointment schedule so that the individual or the patient, or a caregiver, can, via the central processing computer 10, easily make the appointment directly from, and using information contained in the message, or a reminder message for the individual or the patient to undergo a test or a procedure can contain a link to the facility where the test or the procedure is to be undertaken or performed, or a reminder message for a provider to refill a prescription medication can contain a link to the individual's or the patient's pharmacy, or a prescription for a genetic test to be performed on the individual's or the patient's DNA can contain a link to a genetic testing service or laboratory and/or to the individual's or the patient's electronic medical record to which the genetic test results and/or analysis can be transmitted, and the list of examples can go on and on.

Thereafter, the operation of the apparatus 100 will cease at step 1308.

In another preferred embodiment, as well as any and/or all of the embodiments described herein, any final diagnosis information or prescribed treatment plan information, or any genetic profile reports or plans, diagnostic reports, treatment reports, treatment plans, initial or baseline genetic profile diagnostic reports, initial or baseline genetic profile treatment reports or plans, genetic profile diagnostic reports, or genetic profile treatment reports or plans, or any other reports, messages, or plans, described as being generated by and/or provided by the central processing computer 10, and/or by the apparatus 100 and method of the present invention, can also contain or can include an advertisement or advertisements or marketing material or marketing information for or regarding any goods, products, or services, including, but not limited to, any healthcare, healthcare-related, fitness, wellness, nutritional, and/or any other goods, products, or services.

In another preferred embodiment, as well an in any and/or all of the embodiments described herein, the central processing computer 10 can be programmed to identify, and to include, in any final diagnosis information or prescribed treatment plan information, or any genetic profile reports or plans, diagnostic reports, treatment reports, treatment plans, initial or baseline genetic profile diagnostic reports, initial or baseline genetic profile treatment reports or plans, genetic profile diagnostic reports, or genetic profile treatment reports or plans, or any other reports, messages, or plans, described as being generated by and/or provided by the central processing computer 10, and/or by the apparatus 100 and method of the present invention, any information regarding an insurance policy, product, or service, and/or an insurance exchange computer(s) 70 from which same may be purchased or subscribed to which may be of interest to, or which could be helpful or beneficial to the individual or the patient based on a final diagnosis a diagnosis, a possible diagnosis, a prescribed treatment, or a prescribed treatment plan, or a drug or medication, a therapy, or a procedure, identified in the respective final diagnosis information or prescribed treatment plan information, or any genetic profile report or plan, diagnostic report, treatment report, treatment plan, initial or baseline genetic profile diagnostic report, initial or baseline genetic profile treatment report or plan, genetic profile diagnostic report, or genetic profile treatment report or plan, or any other report, message, or plan, and can include information or a link, links, or a hyperlink or hyperlinks, to the insurance exchange computer(s) 70.

In another preferred embodiment, as well an in any and/or all of the embodiments described herein, the central processing computer 10 can be programmed to identify, and to include, in any final diagnosis information or prescribed treatment plan information, or any genetic profile reports or plans, diagnostic reports, treatment reports, treatment plans, initial or baseline genetic profile diagnostic reports, initial or baseline genetic profile treatment reports or plans, genetic profile diagnostic reports, or genetic profile treatment reports or plans, or any other reports, messages, or plans, described as being generated by and/or provided by the central processing computer 10, and/or by the apparatus 100 and method of the present invention, any information regarding a social network computer(s) 80 containing information or links to social networking support groups or social networking-based groups or information sources which may be of interest to, or which could be helpful or beneficial to, the individual or the patient based on a diagnosis, a possible diagnosis, a prescribed treatment, or a prescribed treatment, or a drug or medication, a therapy, or a procedure, identified in a respective identified in the respective final diagnosis information or prescribed treatment plan information, or any genetic profile report or plan, diagnostic report, treatment report, treatment plan, initial or baseline genetic profile diagnostic report, initial or baseline genetic profile treatment report or plan, genetic profile diagnostic report, or genetic profile treatment report or plan, or any other report, message, or plan, and can include information or a link, links, or a hyperlink or hyperlinks, to the a social network, a social network computer(s) 80, a social networking web site or support group, a social networking blog, chat room, or discussion group, or any other social networking information.

In another preferred embodiment, as well an in any and/or all of the embodiments described herein, the central processing computer 10 can be programmed to identify, and to include in any final diagnosis information or prescribed treatment plan information, or any genetic profile reports or plans, diagnostic reports, treatment reports, treatment plans, initial or baseline genetic profile diagnostic reports, initial or baseline genetic profile treatment reports or plans, genetic profile diagnostic reports, or genetic profile treatment reports or plans, or any other reports, messages, or plans, described as being generated by and/or provided by the central processing computer 10, and/or by the apparatus 100 and method of the present invention, information regarding a media computer 90 or a media source which can provide information which may be of interest to, or which could be helpful or beneficial to, the individual or the patient based on a diagnosis, a possible diagnosis, a prescribed treatment, or a prescribed treatment, or a drug or a medication, a therapy, or a procedure, identified in a respective final diagnosis, a prescribed treatment plan, a genetic profile report or file, a diagnostic report, a treatment report, and/or a treatment plan, a initial or baseline genetic profile diagnostic report, a initial or baseline genetic profile treatment report or plan, or any other herein-described report, message, or file, described herein as being generated by the central processing computer 10, and can include information or a link, links, or a hyperlink or hyperlinks, to the media computer(s) 90.

In another embodiment, as well as any and/or all of the embodiments described herein, any or the messages, reports, or other information, or any other communication(s) or transmission(s) described herein, which can be provided by the apparatus 100 of the present invention and/or by the central processing computer 10 to an individual or a patient, to a provider, to an insurer or payer, or to an intermediary, can also contain information such as advertisement(s) or marketing materials for a healthcare product(s) or service(s), an advertisement(s) or marketing materials for a health, wellness, or exercise, product(s) or service(s), or a news report or other information, pertinent to the individual or patient, or pertinent to or relating to the individual's or patient's condition or symptoms, if any, any examination finding(s), any information contained in the any diagnostic report and/or in the any treatment report or treatment plan, or in any final diagnosis and/or prescribed treatment. In a preferred embodiment, the central processing computer 10, in response to a request by a provider, an individual, a patient, a caregiver, an insurer or payer, or an intermediary, can also process information in order to request or create a subscription for the individual or the patient so that the individual or the patient can receive future information, by mail, by e-mail, by text message, or otherwise, regarding a news report or other data or information which would be of interest to the individual or the patient or pertinent to the individual's or patient's condition.

In a preferred embodiment, the individual or the patient can also be provided with information regarding news or other information regarding an individual's or patient's health condition, symptoms, diagnosis, or treatment, can also be disseminated to the individual or patient on a regular and/or on an on-going basis. In this regard, news or information, which may be pertinent, relevant, or otherwise helpful, for allowing an individual or a patient to understand a diagnosis, a treatment plan or regimen, a condition, or an illness, or which can help the individual or the patient to take corrective or preventive action or measures regarding a condition or an illness, can be provided to the individual or the patient, or can be transmitted to the individual's user communication device 40, at the provider's direction or discretion, on a one-time basis, on a regular on on-going basis, or when the news or information becomes available, or otherwise.

In another preferred embodiment, as well as any and/or all of the embodiments described herein, any final diagnosis information or prescribed treatment plan information, or any genetic profile reports or plans, diagnostic reports, treatment reports, treatment plans, initial or baseline genetic profile diagnostic reports, initial or baseline genetic profile treatment reports or plans, genetic profile diagnostic reports, or genetic profile treatment reports or plans, or any other reports, messages, or plans, described as being generated by and/or provided by the central processing computer 10, and/or by the apparatus 100 and method of the present invention, can include, contain, or be accompanied by, medical information, textbook materials, laboratory materials, reference materials, video clips of any pertinent information, audio clips of any pertinent information, hyperlinks to informational sources, information regarding providers and/or facilities for obtaining treatment and/or therapy, provider and/or facility contact information, and/or any other pertinent and/or relevant information.

In another preferred embodiment, as well as any and/or all of the embodiments described herein, any final diagnosis information or prescribed treatment plan information, or any genetic profile reports or plans, diagnostic reports, treatment reports, treatment plans, initial or baseline genetic profile diagnostic reports, initial or baseline genetic profile treatment reports or plans, genetic profile diagnostic reports, or genetic profile treatment reports or plans, or any other reports, messages, or plans, described as being generated by and/or provided by the central processing computer 10, and/or by the apparatus 100 and method of the present invention, can include, contain, or be accompanied by, by health and/or wellness information which can include suggestions for health and/or wellness foods, goods, products, and/or services, and can include, contain, or be accompanied by, health and/or fitness information, diets, nutritional information, and/or any other information which may be of assistance to the individual or the patient and/or provider, warnings regarding misdiagnoses, warnings about treatments, information about experimental treatments, statistical and/or otherwise, regarding diagnoses, misdiagnoses, treatment successes, and/or treatment failures, and/or information regarding alternate medicine such as treatments regarding herbal remedies and/or treatments, meditation, self-healing, faith healing, yoga, tai chi, exercise therapy, and/or other therapies and/or therapy types.

In any and/or all of the embodiments described herein, any and/or all of the any electronic healthcare records, electronic medical records, electronic dental records, electronic pharmacy records, electronic behavioral health records, utilized in connection with the apparatus 100 can contain a link(s) or a hyperlink(s) to any of the herein-described healthcare records computers 60, insurance exchange computers 70, social networking computers 80, and/or the media computers 90. In any and/or all of the embodiments described herein, any user, individual, patient, or caregiver, can use his or her user communication device 40 to access any healthcare records computer 60 via his or her electronic healthcare record(s), electronic medical record(s), electronic dental record(s), electronic pharmacy record(s), or electronic behavioral health record(s) for any reason and/or purpose.

In any and/or all of the embodiments described herein, any user, individual, patient, or caregiver, can use his or her user communication device 40 to access any insurance exchange computers 70 via his or her electronic healthcare record(s), electronic medical record(s), electronic dental record(s), electronic pharmacy record(s), or electronic behavioral health record(s) in order to purchase an insurance policy, program, or service for any healthcare insurance, life insurance, disability insurance, automobile insurance, property insurance, liability insurance, or any other kind or type of insurance, to submit insurance claims or payment requests pursuant to any healthcare insurance, life insurance, disability insurance, automobile insurance, property insurance, liability insurance, or any other kind or type of insurance, or to check on the status of any insurance claims or payment requests.

In any and/or all of the embodiments described herein, any user, individual, patient, or caregiver, can use his or her user communication device 40 to access any social networking computers 80 via his or her electronic healthcare record(s), electronic medical record(s), electronic dental record(s), electronic pharmacy record(s), or electronic behavioral health record(s), in order to engage or participate in any social networking activity, support groups, on-line chats or discussions, seminars, or any other activity which one can engage in on, in, or via a social network.

In any and/or all of the embodiments described herein, the apparatus 100 and method of the present invention can also be utilized as a clearinghouse for facilitating the offering, selling, buying, trading, and/or other commerce and/or transactions, involving healthcare and/or healthcare-related services, products and/or goods.

In another preferred embodiment, the apparatus 100 and method of the present invention can also be utilized to implement a centralized genetic information or DNA database which can be utilized to aid in identifying and/or in locating, in tracking the movement and/or the migration of, and/or in aiding in the health and well-being of, any individuals registered with the central processing computer 10, and/or in monitoring the movement of individuals who may have been inflicted with, or who may be susceptible to a disease(s), disorder(s), condition(s), sickness(es), syndrome(s), or cancer(s).

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. A computer-implemented method, comprising:
processing, with a processing device or with a computer, genetic information or genetic-related information regarding an individual, wherein the genetic information or genetic-related information regarding an individual is obtained from or derived from genetic material of the individual;
determining or ascertaining information regarding the genetic information or genetic-related information regarding an individual, with the processing device or with the computer, wherein the information regarding the genetic information or genetic-related information includes information regarding the presence or the absence of a variation or mutation, or any carrier status, in, on, or regarding, the individual's genetic information or genetic-related information or genetic material, information regarding the presence or the absence of any gene, genetic marker, or indicator, or any variation or mutation of same, or any carrier status, in or regarding, the genetic information or genetic-related information or genetic material, information regarding the presence or the absence of a gene, genetic marker, or indicator, which presence or absence is or may be medically or scientifically believed to cause, to be the cause of, or to be associated with, a disease, a disorder, a condition, a sickness, a syndrome, or a cancer, or which can be associated with a statistical or a statistically increased probability or risk of developing or getting a disease, a disorder, a condition, a sickness, a syndrome, or a cancer, or information regarding any genetic abnormality present in the genetic information or genetic-related information;
generating, with the processing device or with the computer, a genetic profile report or data file for the individual, wherein the genetic profile report or data file contains information regarding the information regarding the genetic information or genetic-related information regarding an individual;
generating, with the processing device or with the computer, a diagnostic report using the information contained in the genetic profile report or data file, wherein the diagnostic report contains information regarding a diagnosis or a possible diagnosis for the individual based on information contained in the genetic profile report or data file;
generating, with the processing device or with the computer, a treatment report using information contained in the diagnostic report, wherein the treatment report contains information regarding a treatment for the individual corresponding to the diagnosis or the possible diagnosis;
generating, with the processing device or with the computer, a treatment plan for the individual using information contained in the treatment report, wherein the treatment plan contains information regarding a treatment for or corresponding to the diagnosis or the possible diagnosis; and
transmitting, with or from a transmitter or with or from the processing device or the computer, the genetic profile report or data file, the diagnostic report, the treatment report, or the treatment plan, to a communication device of, associated with, or used by, a healthcare provider of the individual.

2. The computer-implemented method of claim 1, further comprising:
processing genetic information or genetic-related information regarding a family member of, a parent of, a sibling of, a child of, or any person having a blood relationship or bloodline relationship with, the individual.

3. The computer-implemented method of claim 1, further comprising:
processing information regarding a symptom, an examination finding, or an observation, of or regarding the individual using information contained in the genetic profile report or data file.

4. The computer-implemented method of claim 1, further comprising:
transmitting the genetic profile report or data file, the diagnostic report, the treatment report, or the treatment plan, to a second communication device, wherein the second communication device is associated with or used by the individual, an insurer or payer of the individual, a second healthcare provider, or an intermediary.

5. The computer-implemented method of claim 1, wherein the treatment plan contains information regarding, or a link or a hyperlink to, a healthcare records computer.

6. The computer-implemented method of claim 1, wherein the treatment plan contains information regarding, or a link or a hyperlink to, an insurance exchange computer.

7. The computer-implemented method of claim 1, wherein the treatment plan contains information regarding, or a link or a hyperlink to, a social networking computer.

8. The computer-implemented method of claim 1, wherein the treatment plan contains information regarding, or a link or a hyperlink to, a media computer.

9. The computer-implemented method of claim 1, further comprising:
programming the processing device or the computer to automatically generate and transmit a message, an alert, or a reminder message, to the individual, the healthcare provider, a second healthcare provider, or an insurer or payer, pursuant to the treatment plan.

10. The computer-implemented method of claim 1, further comprising:
processing information for facilitating an offering, a selling, a buying, a trading, or a transaction, regarding or involving a healthcare good, product, or service.

11. The computer-implemented method of claim 1, further comprising:
processing information regarding the purchase of a healthcare insurance policy, a disability insurance policy, or a life insurance policy.

12. The computer-implemented method of claim 1, further comprising:
storing the genetic profile report or data file, the diagnostic report, the treatment report, or the treatment plan, in an electronic healthcare record of or associated with the individual.

13. The computer-implemented method of claim 1, wherein the communication device is a cellular telephone, a smart phone, or a personal digital assistant.

14. The computer-implemented method of claim 4, wherein the second communication device is a cellular telephone, a smart phone, or a personal digital assistant.

15. The computer-implemented method of claim 1, wherein the genetic profile report or data file is generated shortly after the birth of the individual.

16. The computer-implemented method of claim 1, further comprising:
automatically receiving the genetic information or genetic-related information with or using a receiver associated with the processing device or the computer.

17. The computer-implemented method of claim 1, wherein the genetic material or the genetic information or genetic-related information is, or is obtained from, DNA, RNA, a chromosome, a gene, a protein, or an enzyme.

18. The computer-implemented method of claim 1, wherein the treatment plan contains information regarding a cost of implementing the treatment plan.

19. An apparatus, comprising:
a processing device or a computer for processing genetic information or genetic-related information regarding an individual, wherein the genetic information or genetic-related information regarding an individual is obtained from or derived from genetic material of the individual, wherein the processing device or the computer determines or ascertains information regarding the genetic information or genetic-related information regarding an individual, wherein the information regarding the genetic information or genetic-related information includes information regarding the presence or the absence of a variation or mutation, or any carrier status, in, on, or regarding, the individual's genetic information or genetic-related information or genetic material, information regarding the presence or the absence of any gene, genetic marker, or indicator, or any variation or mutation of same, or any carrier status, in or regarding, the genetic information or genetic-related information or genetic material, information regarding the presence or the absence of a gene, a genetic marker, or an indicator, which presence or absence is or may be medically or scientifically believed to cause, to be the cause of, or to be associated with, a disease, a disorder, a condition, a sickness, a syndrome, or a cancer, or which can be associated with a statistical or a statistically increased probability or risk of developing or getting a disease, a disorder, a condition, a sickness, a syndrome, or a cancer, or information regarding any genetic abnormality present in the genetic information or genetic-related information, wherein the processing device or the computer generates a genetic profile report or data file for the individual, wherein the genetic profile report or data file contains information regarding the information regarding the genetic information or genetic-related information regarding an individual, and further wherein the processing device or the computer generates a diagnostic report using the information contained in the genetic profile report or data file, wherein the diagnostic report contains information regarding a diagnosis or a possible diagnosis for the individual based on information contained in the genetic profile report or data file, and further wherein the processing device or the computer generates a treatment report using information contained in the diagnostic report, wherein the treatment report contains information regarding a treatment for the individual corresponding to the diagnosis or the possible diagnosis, or the processing device or the computer generates a treatment plan for the individual, wherein the treatment plan contains information regarding a treatment for or corresponding to the diagnosis or the possible diagnosis; and
a transmitter, wherein the transmitter is associated with or connected with the processing device or the computer, wherein the transmitter transmits the genetic profile report or data file, the diagnostic report, the treatment report, or the treatment plan, to a communication device of or associated with a healthcare provider of the individual or the individual.

20. The apparatus of claim 19, wherein the apparatus processes genetic information or genetic-related information regarding a family member of, a parent of, a sibling of, a child of, or any person having a blood relationship or bloodline relationship with, the individual.
